(19) United States
(12) Patent Application Publication
(10) Pub. No.: US 2026/0347734 A1
(43) Pub. Date: Nov. 5, 2026

(54) BEER-FLAVORED BEVERAGE

(71) Applicant: SUNTORY HOLDINGS LIMITED, Osaka-shi, Osaka (JP)

(72) Inventors: Jun Yomo, Mishima-gun (JP); Yuichi Kato, Fuchu-shi (JP); Taichi Maruhashi, Fuchu-shi (JP)

(73) Assignee: SUNTORY HOLDINGS LIMITED, Osaka-shi, Osaka (JP)

(21) Appl. No.: 19/487,133

(22) PCT Filed: Jun. 19, 2024
(86) PCT No.: PCT/JP2024/022149

§ 371 Date: Nov. 24, 2025

(30) Foreign Application Priority Data
Jun. 19, 2023 (JP) 2023-100223
Jun. 19, 2023 (JP) 2023-100225
Jun. 19, 2023 (JP) 2023-100227

(51) Int. Cl. C12C 11/00; C12C 1/16; C12C 7/04

(52) U.S. Cl. CPC C12C 11/003; C12C 1/16; C12C 7/042

(57) ABSTRACT

There has been demand for a beer-flavored beverage having a good aroma and imparting little excessive irritation caused by an alcohol. Further, there has been demand for a beer-flavored beverage that can also impart mild sourness while having a clean taste.

### TECHNICAL FIELD

The present invention relates to a beer-taste beverage.

### BACKGROUND ART

There have been known methods and apparatus to mix malt-based stock solution, carbonated water and the like and thus producing beer beverages.

For example, Patent Literature 1 discloses a method for producing a beer beverage and an appliance for dispensing the beer beverage, in which a malt-based fermented beverage concentrate and a carbonated liquid diluent are mixed to produce a malt based fermented beverage.

### CITATION LIST

### Patent Literature

Patent Literature 1: WO 2018/100071

### SUMMARY OF INVENTION

### Technical Problem

A beer-taste stock solution intended to be diluted, such as the malt-based stock solution in Patent Literature 1, is designed to have a higher alcohol strength as compared with a normal beer-taste beverage. In recent years, there has been an increasing demand for drinking such a stock solution having a high alcohol strength without diluting the stock solution.

Under such circumstances, beer-taste beverages having a high alcohol strength and easy to drink have been required.

In addition, the inventors of the present invention have encountered a problem that when such a stock solution having a high alcohol strength is directly provided for drinking, an unsuitable flavor as excessive sensation of irritation from alcohol tends to remain.

Under such circumstances, beer-taste beverages having less excessive sensation of irritation from alcohol and having good aroma richness have also been required.

Further, the inventors of the present invention have encountered a problem that a sweet aroma unsuitable for beer-taste beverages is easily felt when the stock solution having a high alcohol strength is directly provided for drinking.

Under such circumstances, beer-taste beverages having a clean taste and also having mild sourness have been demanded.

### Solution to Problem

The present invention includes the following aspects.

[1]

A beer-taste beverage having an alcohol strength of 8.00 (v/v) % or more.

[2]

The beer-taste beverage according to [1], wherein
the alcohol strength is 8.00 (v/v) % or more;
an isoamyl alcohol content is 110 ppm by mass or more; and
the beer-taste beverage satisfies Formula (1):

X1/Y1≥2.00: Formula (1)
wherein X1 represents the isoamyl alcohol content (unit: ppm by mass), and Y1 represents an ethyl acetate content (unit: ppm by mass).
   [3]

The beer-taste beverage according to [1], wherein
the alcohol strength is 8.00 (v/v) % or more;
a succinic acid content is 110 ppm by mass or more and 1100 ppm by mass or less; and
the beer-taste beverage satisfies Formula (1A):

X1/Y1≥0.25: Formula (1A)
wherein X1 represents the succinic acid content (unit: ppm by mass), and Y1 represents an acetic acid content (unit: ppm by mass).
   [4]

The beer-taste beverage according to [1], wherein
the alcohol strength is 10.0 (v/v) % or more;
an ethyl acetate content is 50 ppm by mass or more; and
an isoamyl acetate content is 3 ppm by mass or more.
   [5]

The beer-taste beverage according to [1], wherein
the alcohol strength is 12.0 (v/v) % or more; and
an ethyl acetate content is 50 ppm by mass or more.
   [6]

The beer-taste beverage according to [2], wherein the isoamyl alcohol content is 1000 ppm by mass or less.

[7]

The beer-taste beverage according to [2], further containing one or more compounds selected from the group consisting of n-propanol, isobutanol, and phenethyl alcohol.

[8]

The beer-taste beverage according to [2], further containing one or more compounds selected from the group consisting of isoamyl acetate, ethyl caproate, and ethyl octanoate.

[9]

The beer-taste beverage according to [2], the beer-taste beverage satisfying Formula (2):

X/Y>3.00: Formula (2)
wherein X represents a total content (unit: ppm by mass) of a compound of Group X, and Y represents a total content (unit: ppm by mass) of a compound of Group Y:
Group X: one or more selected from the group consisting of isoamyl alcohol, n-propanol, isobutanol, and phenethyl alcohol; and
Group Y: one or more selected from the group consisting of ethyl acetate, isoamyl acetate, ethyl caproate, and ethyl octanoate.
   [10]

The beer-taste beverage according to [2], the beer-taste beverage satisfying Formula (3):

X2/Y1>0.65: Formula (3)
wherein X2 represents an n-propanol content (unit: ppm by mass), and Y1 represents the ethyl acetate content (unit: ppm by mass).
   [11]

The beer-taste beverage according to [2], the beer-taste beverage satisfying Formula (4):

X3/Y1>0.65: Formula (4)
wherein X3 represents an isobutanol content (unit: ppm by mass), and Y1 represents the ethyl acetate content (unit: ppm by mass).
   [12]

The beer-taste beverage according to [2], the beer-taste beverage satisfying Formula (5):

X4/Y1>0.30: Formula(5)
wherein X4 represents a phenethyl alcohol content (unit: ppm by mass), and Y1 represents the ethyl acetate content (unit: ppm by mass).
   [13]

The beer-taste beverage according to [3], wherein an isoamyl alcohol content is 10 ppm by mass or more and 1000 ppm by mass or less.

[14]

The beer-taste beverage according to [3], the beer-taste beverage satisfying Formula (1B):

X2/Y1>0.32:Formula(1B)
wherein X2 represents a citric acid content (unit: ppm by mass), and Y1 represents the acetic acid content (unit: ppm by mass).
   [15]

The beer-taste beverage according to [3], the beer-taste beverage satisfying Formula (2A):

X1/Z≥0.50 :Formula (2A)

wherein X1 represents the succinic acid content (unit: ppm by mass), and Z represents an isoamyl alcohol content (unit: ppm by mass).
[16]

The beer-taste beverage according to [3], the beer-taste beverage satisfying Formula (2B):

X2/Z≥0.78 :Formula (2B)
wherein X2 represents a citric acid content (unit: ppm by mass), and Z represents an isoamyl alcohol content (unit: ppm by mass).
   [17]

The beer-taste beverage according to [3], the beer-taste beverage satisfying Formula (3):

Y1/Z≥0.66 :Formula (3)
wherein Y1 represents the acetic acid content (unit: ppm by mass), and Z represents an isoamyl alcohol content (unit: ppm by mass).
   [18]

The beer-taste beverage according to [3], the beer-taste beverage satisfying Formula (4):

X/Y1>1.25 :Formula (4)
wherein X represents a total content (unit: ppm by mass) of one or more acidulants selected from the group consisting of phosphoric acid, citric acid, and succinic acid, and Y1 represents the acetic acid content (unit: ppm by mass).
   [19]

The beer-taste beverage according to [4] or [5], wherein an n-propanol content is 55 ppm by mass or more.

[20]

The beer-taste beverage according to [4] or [5], wherein the ethyl acetate content is 60 ppm by mass or more.

[21]

The beer-taste beverage according to [4] or [5], wherein an isoamyl alcohol content is from 110 to 1000 ppm by mass.

[22]

The beer-taste beverage according to [4] or [5], the beer-taste beverage satisfying Formula (1):

X/Y>3.00 :Formula (1)
wherein X represents a total content (unit: ppm by mass) of a compound of Group X, and Y represents a total content (unit: ppm by mass) of a compound of Group Y:
Group X: one or more selected from the group consisting of isoamyl alcohol, n-propanol, isobutanol, and phenethyl alcohol; and
Group Y: one or more selected from the group consisting of ethyl acetate, isoamyl acetate, ethyl caproate, and ethyl octanoate.
   [23]

The beer-taste beverage according to [4] or [5], wherein the alcohol strength is 50.00 (v/v) % or less.

[24]

The beer-taste beverage according to [4] or [5], wherein a malt proportion is 50 mass % of more.

[25]

The beer-taste beverage according to [4] or [5], the beer-taste beverage being a fermented beverage.

[26]

The beer-taste beverage according to [25], the beer-taste beverage being a top-fermented beer-taste beverage.

[27]

The beer-taste beverage according to any one of [1] to [3], wherein the alcohol strength is 50.00 (v/v) % or less.

[28]

The beer-taste beverage according to any one of [1] to [3], wherein a malt proportion is 50 mass % or more.

[29]

The beer-taste beverage according to any one of [1] to [3], the beer-taste beverage being a fermented beverage.

[30]

The beer-taste beverage according to [29], the beer-taste beverage being a top-fermented beer-taste beverage.

[31]

A beer-taste stock solution having an alcohol strength of 8.00 (v/v) % or more.

The beer-taste stock solution according to [31], wherein
the alcohol strength is 8.00 (v/v) % or more; and
an isoamyl alcohol content is 110 ppm by mass or more,
the beer-taste beverage satisfies Formula (1):

X1/Y1≥2.00 :Formula (1)
wherein X1 represents the isoamyl alcohol content (unit: ppm by mass), and Y1 represents an ethyl acetate content (unit: ppm by mass).
   [33]

The beer-taste stock solution according to [31], wherein
the alcohol strength is 8.00 (v/v) % or more; and
a succinic acid content is 110 ppm by mass or more and 1100 ppm by mass or less,
the beer-taste beverage satisfies Formula (1A):

X1/Y1≥0.25 :Formula (1A)
wherein X1 represents the succinic acid content (unit: ppm by mass), and Y1 represents an acetic acid content (unit: ppm by mass).
   [33]

The beer-taste stock solution according to [31], wherein
the alcohol strength is 10.0 (v/v) % or more;
an ethyl acetate content is 50 ppm by mass or more; and
an isoamyl acetate content is 3 ppm by mass or more.
   [35]

The beer-taste stock solution according to [31], wherein
the alcohol strength is 12.0 (v/v) % or more; and
an ethyl acetate content is 50 ppm by mass or more.
   [36]

The beer-taste stock solution according to any one of to [35], the beer-taste stock solution being a stock solution for two-fold to ten-fold dilution.

[37]

A beer-taste beverage produced by mixing an edible aqueous solution with the beer-taste stock solution described in any one of to [35].

[38]

A method for producing a beer-taste beverage, the method including mixing an edible aqueous solution with the beer-taste stock solution described in any one of to [35].

### [Corresponding to JP 2023-100223]

In addition, in an aspect of the present invention, as a result of intensive studies by the inventors of the present invention, it has been found that the above problems are solved by adjusting the isoamyl alcohol content and a content ratio between isoamyl alcohol and ethyl acetate to predetermined ranges, and thus, the present invention has been completed.

That is, the present invention includes the following aspects.

### [A1]

A beer-taste beverage having:
an alcohol strength of 8.00 (v/v) % or more; and
an isoamyl alcohol content of 110 ppm by mass or more,
the beer-taste beverage satisfying Formula (1):

X1/Y1≥2.00 :Formula (1)
wherein X1 represents the isoamyl alcohol content (unit: ppm by mass), and Y1 represents an ethyl acetate content (unit: ppm by mass).

### [A2]

The beer-taste beverage according to [A1], wherein the alcohol strength is 50.00 (v/v) % or less.

### [A3]

The beer-taste beverage according to [A1] or [A2], wherein the isoamyl alcohol content is 1000 ppm by mass or less.

### [A4]

The beer-taste beverage according to any one of [A1] to [A3], further containing one or more compounds selected from the group consisting of n-propanol, isobutanol, and phenethyl alcohol.

### [A5]

The beer-taste beverage according to any one of [A1] to [A4], further containing one or more compounds selected from the group consisting of isoamyl acetate, ethyl caproate, and ethyl octanoate.

### [A6]

The beer-taste beverage according to any one of [A1] to [A5], the beer-taste beverage satisfying Formula (2):

X/Y>3.00 :Formula (2)
wherein X represents a total content (unit: ppm by mass) of a compound of Group X, and Y represents a total content (unit: ppm by mass) of a compound of Group Y:
Group X: one or more selected from the group consisting of isoamyl alcohol, n-propanol, isobutanol, and phenethyl alcohol; and
Group Y: one or more selected from the group consisting of ethyl acetate, isoamyl acetate, ethyl caproate, and ethyl octanoate.

### [A7]

The beer-taste beverage according to any one of [A1] to [A6], the beer-taste beverage satisfying Formula (3):

X2/Y1>0.65 :Formula (3)
wherein X2 represents an n-propanol content (unit: ppm by mass), and Y1 represents the ethyl acetate content (unit: ppm by mass).

### [A8]

The beer-taste beverage according to any one of [A1] to [A7], the beer-taste beverage satisfying Formula (4):

X3/Y1>0.65 :Formula (4)
wherein X3 represents an isobutanol content (unit: ppm by mass), and Y1 represents the ethyl acetate content (unit: ppm by mass).

### [A9]

The beer-taste beverage according to any one of [A1] to [A8], the beer-taste beverage satisfying Formula (5):

X4/Y1>0.30 :Formula (5)
wherein X4 represents a phenethyl alcohol content (unit: ppm by mass), and Y1 represents the ethyl acetate content (unit: ppm by mass).

### [A10]

The beer-taste beverage according to any one of [A1] to [A9], wherein a malt proportion is 50 mass % or more.

### [A11]

The beer-taste beverage according to any one of [A1] to [A10], the beer-taste beverage being a fermented beverage.

### [A12]

The beer-taste beverage according to any one of [A1] to [A11], the beer-taste beverage being a top-fermented beer-taste beverage.

### [A13]

A beer-taste stock solution having:
an alcohol strength of 8.00 (v/v) % or more;
an isoamyl alcohol content of 110 ppm by mass or more; and
the beer-taste beverage satisfying Formula (1):

X1/Y1≥2.00 :Formula (1)
wherein X1 represents the isoamyl alcohol content (unit: ppm by mass), and Y1 represents an ethyl acetate content (unit: ppm by mass).

### [A14]

The beer-taste stock solution according to [A13], the beer-taste beverage being a stock solution for two-fold to ten-fold dilution.

### [A15]

A beer-taste beverage produced by mixing an edible aqueous solution with the beer-taste stock solution described in [A13] or [A14].

### [A16]

A method for producing a beer-taste beverage, the method including mixing an edible aqueous solution with the beer-taste stock solution described in [A13] or [A14].

### [Corresponding to JP 2023-100225]

As a result of intensive studies, the inventors of the present invention have found that the above problems can be solved by adjusting the succinic acid content and a content ratio between succinic acid and acetic acid to predetermined ranges, and thus, the present invention has been completed.

That is, the present invention includes the following aspects.

### [B1]

A beer-taste beverage having:
an alcohol strength of 8.00 (v/v) % or more; and
a succinic acid content of 110 ppm by mass or more and 1100 ppm by mass or less,
the beer-taste beverage satisfying Formula (1A):

X1/Y1≥0.25 :Formula (1A)
wherein X1 represents the succinic acid content (unit: ppm by mass), and Y1 represents an acetic acid content (unit: ppm by mass).

### [B2]

The beer-taste beverage according to [B1], wherein the alcohol strength is 50.00 (v/v) % or less.

### [B3]

The beer-taste beverage according to [B1] or [B2], wherein an isoamyl alcohol content is 10 ppm by mass or more and 1000 ppm by mass or less.

### [B4]

The beer-taste beverage according to any one of [B1] to [B3], the beer-taste beverage satisfying Formula (1B):

X2/Y1>0.32 :Formula (1B)
wherein X2 represents a citric acid content (unit: ppm by mass), and Y1 represents the acetic acid content (unit: ppm by mass).

### [B5]

The beer-taste beverage according to any one of [B1] to [B4], the beer-taste beverage satisfying Formula (2A):

X1/Z≥0.50 :Formula (2A)
wherein X1 represents the succinic acid content (unit: ppm by mass), and Z represents an isoamyl alcohol content (unit: ppm by mass).

### [B6]

The beer-taste beverage according to any one of [B1] to [B5], the beer-taste beverage satisfying Formula (2B):

X2/Z≥0.78 Formula (2B)
wherein X2 represents a citric acid content (unit: ppm by mass), and Z represents an isoamyl alcohol content (unit: ppm by mass).

### [B7]

The beer-taste beverage according to any one of [B1] to [B6], the beer-taste beverage satisfying Formula (3):

Y1/Z≥0.66 :Formula (3)
wherein Y1 represents the acetic acid content (unit: ppm by mass), and Z represents an isoamyl alcohol content (unit: ppm by mass).

### [B8]

The beer-taste beverage according to any one of [B1] to [B7], the beer-taste beverage satisfying Formula (4):

X/Y1>1.25 :Formula (4)
wherein X represents a total content (unit: ppm by mass) of one or more acidulants selected from the group consisting of phosphoric acid, citric acid, and succinic acid, and Y1 represents the acetic acid content (unit: ppm by mass).

### [B9]

The beer-taste beverage according to any one of [B1] to [B8], wherein a malt proportion is 50 mass % or more.

### [B10]

The beer-taste beverage according to any one of [B1] to [B9], the beer-taste beverage being a fermented beverage.

### [B11]

The beer-taste beverage according to any one of [B1] to [B10], the beer-taste beverage being a top-fermented beer-taste beverage.

### [B12]

A beer-taste stock solution having:
an alcohol strength of 8.00 (v/v) % or more; and
a succinic acid content of 110 ppm by mass or more and 1100 ppm by mass or less,
the beer-taste beverage satisfying Formula (1A):

X1/Y1≥0.25 :Formula (1A)
wherein X1 represents the succinic acid content (unit: ppm by mass), and Y1 represents an acetic acid content (unit: ppm by mass).

### [B13]

The beer-taste stock solution according to [B12], the beer-taste beverage being a stock solution for two-fold to ten-fold dilution.

### [B14]

A beer-taste beverage produced by mixing an edible aqueous solution with the beer-taste stock solution described in [B12] or [B13].

### [B15]

A method for producing a beer-taste beverage, the method including mixing an edible aqueous solution with the beer-taste stock solution described in [B12] or [B13].

### [Corresponding to JP 2023-100227]

As a result of intensive studies by the inventors of the present invention, it has been found that the above problems can be solved by adjusting a content of a specific acetic acid-based component to a predetermined range, and thus, the present invention has been completed.

That is, the present invention includes the following aspects.

### [C19]

A beer-taste beverage having:
an alcohol strength of 10.0 (v/v) % or more;
an ethyl acetate content of 50 ppm by mass or more; and
an isoamyl acetate content of 3 ppm by mass or more.

### [C29]

A beer-taste beverage having:
an alcohol strength of 12.0 (v/v) % or more; and
an ethyl acetate content of 50 ppm by mass or more.

### [C3]

The beer-taste beverage according to [C1] or [C2], wherein an n-propanol content is 55 ppm by mass or more.

### [C3]

The beer-taste beverage according to any one of [C1] to [C3], wherein the ethyl acetate content is 60 ppm by mass or more.

### [C5]

The beer-taste beverage according to any one of [C1] to [C4], wherein the alcohol strength is 50.00 (v/v) % or less.

### [C6]

The beer-taste beverage according to any one of [C1] to [C5], wherein an isoamyl alcohol content is from 110 to 1000 ppm by mass.

### [C7]

The beer-taste beverage according to any one of [C1] to [C6], the beer-taste beverage satisfying Formula (1):

X/Y>3.00 :Formula (1)
wherein X represents a total content (unit: ppm by mass) of a compound of Group X, and Y represents a total content (unit: ppm by mass) of a compound of Group Y:

Group X: one or more selected from the group consisting of isoamyl alcohol, n-propanol, isobutanol, and phenethyl alcohol; and

Group Y: one or more selected from the group consisting of ethyl acetate, isoamyl acetate, ethyl caproate, and ethyl octanoate.

### [C8]

The beer-taste beverage according to any one of [C1] to [C7], wherein a malt proportion is 50 mass % or more.

### [C9]

The beer-taste beverage according to any one of [C1] to [C8], the beer-taste beverage being a fermented beverage.

### [C10]

The beer-taste beverage according to any one of [C1] to [C9], the beer-taste beverage being a top-fermented beer-taste beverage.

### [C11]

A beer-taste stock solution having:
an alcohol strength of 10.0 (v/v) % or more;
an ethyl acetate content of 50 ppm by mass or more; and
an isoamyl acetate content of 3 ppm by mass or more.

### [C12]

A beer-taste stock solution having:
an alcohol strength of 12.0 (v/v) % or more; and
an ethyl acetate content of 50 ppm by mass or more.

### [C13]

The beer-taste stock solution according to [C11] or [C12], the beer-taste beverage being a stock solution for two-fold to ten-fold dilution.

### [C14]

A beer-taste beverage produced by mixing an edible aqueous solution with the beer-taste stock solution described in [C11] or [C12].

### [C15]

A method for producing a beer-taste beverage, the method including mixing an edible aqueous solution with the beer-taste stock solution described in [C11] or [C12].

### Advantageous Effects of Invention

According to a preferred aspect of the present invention, there is provided a beer-taste beverage having good aroma richness. In addition, according to a preferred aspect of the present invention, there is provided a beer-taste beverage having a reduced excessive sensation of irritation from alcohol. In addition, according to a preferred aspect of the present invention, there is provided a beer-taste stock solution capable of producing a beer-taste beverage having good aroma richness while being suppressed in an excessive sensation of irritation from alcohol.

According to a preferred aspect of the present invention, there is provided a beer-taste beverage having a clean taste suitable for the beer-taste beverage. In addition, according to a preferred aspect of the present invention, there is provided a beer-taste beverage having mild sourness suitable for the beer-taste beverage. In addition, according to a preferred aspect of the present invention, there is provided a beer-taste stock solution capable of producing a beer-taste beverage having a clean taste and mild sourness.

According to a preferred aspect of the present invention, there is provided a beer-taste beverage having good aroma richness. In addition, according to a preferred aspect of the present invention, there is provided a beer-taste beverage having a reduced excessive sensation of irritation from alcohol. In addition, according to a preferred aspect of the present invention, there is provided a beer-taste stock solution capable of producing a beer-taste beverage having good aroma richness while being suppressed in an excessive sensation of irritation from alcohol.

### DESCRIPTION OF EMBODIMENTS

Hereinafter, the present invention will be described in detail. The following embodiments are illustrative for explaining the present invention and are not intended to limit the present invention only to these embodiments. The present invention can be implemented in various embodiments without departing from the gist of the present invention.

All documents, patent application publications, patent publications, and other patent literatures cited in the present specification are incorporated herein by reference. In addition, the present specification encompasses the contents described in the specification of the Japanese applications (JP 2023-100223, JP 2023-100225, and JP 2023-100227) that are the basis of the priority claim of the present application filed on Jun. 19, 2023.

### 1. Beer-Taste Beverage

The present invention discloses a beer-taste beverage having an alcohol strength of 8.00 (v/v) % or more. Specific aspects of the beer-taste beverage according to the present invention will be described in detail in the following aspects A to C.

### <<Aspect A: Corresponding to JP 2023-100223>>

### A1. Beer-Taste Beverage

As used herein, the term “beer-taste beverage” refers to an alcohol-containing carbonated beverage with a beer-like flavor. That is, unless otherwise specified, the beer-taste beverage as used herein encompasses any carbonated beverage with a flavor of beer.

Therefore, the “beer-taste beverage” includes not only beer, which is a malt-fermented beverage obtained by fermenting malt, hops, and water as raw materials with yeast, and fermented beer-taste beverages, but also a carbonated beverage to which a beer flavoring agent including, for example, esters, higher alcohols, and lactones has been added, and other low-malt beer and effervescent liqueurs classified under the names defined in Japanese Liquor Tax Law.

In addition, the beer-taste beverage according to an aspect of the present invention may be a fermented beer-taste beverage that has undergone a fermentation step using yeast or may be a non-fermented beer-taste beverage that has not undergone the fermentation step.

The fermented beer-taste beverage may be an ale beer-taste beverage brewed through the fermentation step using top-fermenting yeast (e.g., Saccharomyces), a lager beer-taste beverage brewed through the fermentation step using bottom-fermenting yeast (e.g., Saccharomyces), or a pilsner beer-taste beverage, or may be a beer-taste beverage produced by blending these beer-taste beverages. The term “fermentation” as used herein may be alcoholic fermentation that produces alcohol, or may be non-alcoholic fermentation that does not produce alcohol.

In addition, the beer-taste beverage according to an aspect of the present invention may be a malt-containing beer-taste beverage using malt (such as barley malt and wheat malt) as a raw material, or may be a malt-free beer-taste beverage without using malt. Examples of the malt-containing beer-taste beverage include barley malt-containing beer-taste beverages.

In addition, the beer-taste beverage according to an aspect of the present invention may be a cereal grain-containing beer-taste beverage using cereal grain (such as barley and wheat) as a raw material, or may be a cereal grain-free beer-taste beverage without using cereal grain. Examples of the cereal grain-containing beer-taste beverage include barley-containing beer-taste beverages.

The beer-taste beverage according to the present invention is a beer-taste beverage having an alcohol strength of 8.0 (v/v) % or more, having an isoamyl alcohol content of 110 ppm by mass or more, and satisfying Formula (1) shown below.

Formula (1): X1/Y1≥2.00 [wherein, X1 represents the isoamyl alcohol content (unit: ppm by mass), and Y1 represents an ethyl acetate content (unit: ppm by mass).]

When a beer-taste beverage was designed to have a high alcohol strength, a sensation of irritation from alcohol was increased, and the beer-taste beverage tended to have low drinkability. As a result of repeated studies by the inventors of the present invention on such a problem, it has been found that even when the alcohol strength is designed to be as high as 8.0 (v/v) % or more, a rich aroma is firmly felt by adjusting the isoamyl alcohol content and the content ratio between isoamyl alcohol and ethyl acetate to predetermined ranges, and as a result, excessive sensation of irritation caused by the high alcohol strength is less likely to be felt.

The alcohol strength (ethanol content) (v/v) % of the beer-taste beverage according to an aspect of the present invention is 8.0 (v/v) % or more from the viewpoint of producing a beer-taste beverage having moderate sensation of irritation, and the alcohol strength may be 8.5 (v/v) % or more, 9.0 (v/v) % or more, 9.5 (v/v) % or more, 10.0 (v/v) % or more, 10.5 (v/v) % or more, 11.0 (v/v) % or more, 11.5 (v/v) % or more, 12.0 (v/v) % or more, 12.5 (v/v) % or more, 13.0 (v/v) % or more, 13.5 (v/v) % or more, 14.0 (v/v) % or more, 14.5 (v/v) % or more, 15.0 (v/v) % or more, 15.5 (v/v) % or more, 16.0 (v/v) % or more, 16.5 (v/v) % or more, 17.0 (v/v) % or more, 17.5 (v/v) % or more, 18.0 (v/v) % or more, 18.5 (v/v) % or more, 19.0 (v/v) % or more, 19.5 (v/v) % or more, 20.0 (v/v) % or more, 20.5 (v/v) % or more, 21.0 (v/v) % or more, 21.5 (v/v) % or more, 22.0 (v/v) % or more, 22.5 (v/v) % or more, 23.0 (v/v) % or more, 23.5 (v/v) % or more, 24.0 (v/v) % or more, 24.5 (v/v) % or more, or 25.0 (v/v) % or more.

On the other hand, from the viewpoint of producing a beer-taste beverage with less excessive sensation of irritation, the alcohol strength may be 50.0 (v/v) % or less, 45.0 (v/v) % or less, 40.0 (v/v) % or less, 35.0 (v/v) % or less, 30.0 (v/v) % or less, 25.0 (v/v) % or less, 24.5 (v/v) % or less, 24.0 (v/v) % or less, 23.5 (v/v) % or less, 23.0 (v/v) % or less, 22.5 (v/v) % or less, 22.0 (v/v) % or less, 21.5 (v/v) % or less, 21.0 (v/v) % or less, 20.5 (v/v) % or less, or 20.0 (v/v) % or less.

Note that, as used herein, the alcohol strength is indicated as a percentage based on volume/volume ((v/v) %). The alcohol content of the beverage can be measured by any known method, and for example, can be measured according to “8.3 Alcohol” in “Revised BCOJ Beer Analysis Method, revised and enlarged in 2013 (edited by Brewery Convention of Japan, Brewers Association of Japan (Analysis Committee), published by Public Interest Incorporated Foundation. The Brewing Society of Japan).

The adjustment of the alcohol strength can be performed by appropriately setting, for example, the addition of diluent water or carbonated water and the addition amount thereof when added, the type of raw materials (such as cereal grain, malt, corn grits, and sugar solution), the amount of the raw materials, the type of enzyme, the addition amount of the enzyme, the timing for enzyme addition, the amount of time for saccharification in a mashing tank, the amount of time for proteolysis in the mashing tank, the pH in the mashing tank, the pH in a mashing step (wort production step from malt addition to before yeast addition), the addition amount of an acid to be used during the pH adjustment, the timing for the pH adjustment (for example, during mashing, during fermentation, at the time when fermentation is completed, before beverage filtration, and after beverage filtration), the setting temperature and the retention time in each temperature region during wort preparation (including during saccharification), the original extract concentration in a pre-fermentation liquid, the original extract concentration in the fermentation step, fermentation conditions (such as oxygen concentration, aeration conditions, yeast species, the addition amount of yeast, the number of proliferated yeast cells, the timing for yeast removal, the fermentation temperature, the amount of time for fermentation, pressure setting, carbon dioxide concentration, the addition amount of enzyme, the type of enzyme, the timing for enzyme addition), the addition of ethanol, and the addition of ethanol composition (for example, alcohol for raw materials, spirits (distilled liquor) such as shochu, Awamori, whiskey, brandy, vodka, ram, tequila, and gin, and brewed alcohol).

The beer-taste beverage according to an aspect of the present invention may contain, or may not contain, as an alcohol component, spirits (distilled liquor) derived from grains such that the alcohol strength is adjusted to be within the range described above. The beer-taste beverage according to an aspect of the present invention is preferably a beverage containing no spirits from the viewpoint of producing a beer-like, beer-taste beverage having a high-quality taste. That is, it is preferable that the beer-taste beverage according to an aspect of the present invention contains no ethanol solution or ethanol-containing composition as a raw material.

In the beer-taste beverage according to an aspect of the present invention, the isoamyl alcohol content is 110 ppm by mass or more from the viewpoint of improving the rich aroma of the beer-taste beverage. The isoamyl alcohol content is also preferably 120 ppm by mass or more, 130 ppm by mass or more, 140 ppm by mass or more, 150 ppm by mass or more, 155 ppm by mass or more, 160 ppm by mass or more, 170 ppm by mass or more, 180 ppm by mass or more, 190 ppm by mass or more, 200 ppm by mass or more, 210 ppm by mass or more, 220 ppm by mass or more, 230 ppm by mass or more, 240 ppm by mass or more, 250 ppm by mass or more, 260 ppm by mass or more, 270 ppm by mass or more, 280 ppm by mass or more, 285 ppm by mass or more, 290 ppm by mass or more, 300 ppm by mass or more, 310 ppm by mass of more, 320 ppm by mass or more, 330 ppm by mass or more, 340 ppm by mass or more, 350 ppm by mass or more, 360 ppm by mass or more, 370 ppm by mass or more, 380 ppm by mass or more, 390 ppm by mass or more, 400 ppm by mass or more, 410 ppm by mass or more, 420 ppm by mass or more, 430 ppm by mass or more, 440 ppm by mass or more, 450 ppm by mass or more, 460 ppm by mass or more, 470 ppm by mass or more, 480 ppm by mass or more, 490 ppm by mass or more, or 500 ppm by mass or more.

On the other hand, the isoamyl alcohol content may be 1000 ppm by mass or less, 950 ppm by mass or less, 900 ppm by mass or less, 850 ppm by mass or less, 800 ppm by mass or less, 750 ppm by mass or less, 700 ppm by mass or less, 650 ppm by mass or less, 600 ppm by mass or less, 590 ppm by mass or less, 580 ppm by mass or less, 570 ppm by mass or less, 560 ppm by mass or less, 550 ppm by mass or less, 540 ppm by mass or less, 530 ppm by mass of less, 520 ppm by mass or less, 510 ppm by mass or less, 500 ppm by mass or less, 490 ppm by mass or less, 480 ppm by mass or less, 470 ppm by mass or less, 460 ppm by mass or less, 450 ppm by mass or less, 440 ppm by mass or less, 430 ppm by mass or less, 420 ppm by mass or less, 410 ppm by mass or less, 400 ppm by mass or less, 390 ppm by mass or less, 380 ppm by mass or less, 370 ppm by mass or less, 360 ppm by mass or less, 350 ppm by mass or less, 340 ppm by mass or less, 330 ppm by mass or less, 320 ppm by mass or less, 310 ppm by mass or less, or 300 ppm by mass or less, from the viewpoint of producing a beer-taste beverage having less excessive sensation of irritation from alcohol.

Isoamyl alcohol may be contained in the raw material of the beer-taste beverage, may be produced during fermentation based on a substrate contained in the raw material, or may be separately added in the production process (for example, purified isoamyl alcohol).

The adjustment of the isoamyl alcohol content can be performed by appropriately setting, for example, the addition of diluent water or carbonated water and the addition amount thereof when added, the addition of purified isoamyl alcohol, the type of isoamyl alcohol-containing raw materials (such as cereal grain, malt, corn grits, sugar solution, yeast extract, soybean, or pea), the type of raw materials serving as the origin of isoamyl alcohol (such as cereal grain, malt, corn grits, sugar solution, yeast extract, soybean, or pea), the amount of the raw materials, the amount of time for enzyme reaction in the mashing step (wort production step from charging raw materials such as malt to before yeast addition), the pH in the mashing step, the addition amount of an acid used in the pH adjustment, the timing for the pH adjustment (for example, during mashing, during fermentation, at the time when fermentation is completed, prior to beverage filtration, and after beverage filtration), the setting temperature and the retention time in each temperature region during wort preparation (including during saccharification), the original extract concentration in a pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, the fermentation temperature, the amount of time for fermentation, pressure setting, and carbon dioxide concentration), and the addition of spirits or brewed alcohol.

Furthermore, the content of isoamyl alcohol can be measured by headspace gas chromatography equipped with an FID detector in accordance with a method described in the item” 8.22 Low Boiling Point Aroma Components” of Revised BCOJ Beer Analysis Method (Enlarged and Revised Edition of 2013), which is an analysis method defined by Brewery Convention of Japan (BCOJ), Brewers Association of Japan.

The beer-taste beverage according to the present invention is a beer-taste beverage satisfying Formula (1) shown below.

X1/Y1≥2.00 :Formula (1)
[wherein, X1 represents the isoamyl alcohol content (unit: ppm by mass), and Y1 represents an ethyl acetate content (unit: ppm by mass).]

In the beer-taste beverage according to an aspect of the present invention, the ratio (X1/Y1) between the isoamyl alcohol content and the ethyl acetate content in Formula (1) may be 2.10 or more, 2.20 or more, 2.30 or more, 2.40 or more, 2.50 or more, 2.60 or more, 2.65 or more, 2.70 or more, 2.80 or more, 2.90 or more, 3.00 or more, 3.10 or more, 3.20 or more, 3.25 or more, 3.30 or more, 3.40 or more, 3.50 or more, 4.00 or more, 4.10 or more, 4.20 or more, 4.30 or more, 4.40 or more, 4.50 or more, 4.60 or more, 4.70 or more, 4.80 or more, or more, or more, 6.50 or more, 7.00 or more, 7.50 or more, 8.00 or more, 8.50 or more, 9.00 or more, 9.50 or more, or 10.0 or more by mass ratio, from the viewpoint of improving the rich aroma of the beer-taste beverage.

The upper limit value of the content ratio between isoamyl alcohol and ethyl acetate (X1/Y1) is not particularly limited, but it may be, for example, 30.0 or less, 29.0 or less, 28.0 or less, 27.0 or less, 26.0 or less, 25.0 or less, 24.0 or less, 23.0 or less, 22.0 or less, 21.0 or less, or 20.0 or less by mass ratio.

The beer-taste beverage according to an aspect of the present invention may include a compound of Group X and a compound of Group Y as described below.

Group X: one or more selected from the group consisting of isoamyl alcohol, n-propanol, isobutanol, and phenethyl alcohol.

Group Y: one or more selected from the group consisting of ethyl acetate, isoamyl acetate, ethyl caproate, and ethyl octanoate.

The beer-taste beverage according to an aspect of the present invention is a beer-taste beverage satisfying Formula (2) shown below.

X/Y>3.00 :Formula (2)
[In Formula (2), X represents a total content (unit: ppm by mass) of the compound of Group X, and Y represents a total content (unit: ppm by mass) of the compound of Group Y.]

In the beer-taste beverage according to an aspect of the present invention, the ratio (X/Y) between the total content of the compound of Group X and the total content of the compound of Group Y in Formula (2) is preferably 3.10 or more, more than 3.11, 3.15 or more, 3.30 or more, 3.50 or more, 4.00 or more, 4.25 or more, 4.50 or more, 4.55 or more, 5.00 or more, 5.50 or more, 6.00 or more, 6.50 or more, 7.00 or more, more than 7.30, 7.50 or more, 8.00 or more, 8.50 or more, 9.00 or more, 9.50 or more, 10.0 or more, 11.0 or more, 12.0 or more, 13.0 or more, 13.5 or more, 14.0 or more, 15.0 or more, 16.0 or more, 17.0 or more, 17.5 or more, 18.0 or more, 19.0 or more, 20.0 or more, 21.0 or more, 22.0 or more, 23.0 or more, 24.0 or more, 25.0 or more, 26.0 or more, 27.0 or more, 28.0 or more, 29.0 or more, or 30.0 or more by mass ratio, from the viewpoint of improving the rich aroma of the beer-taste beverage.

Furthermore, the upper limit value of the ratio (X/Y) between the total content of the compound of Group X and the total content of the compound of Group Y in Formula (2) is not particularly limited, but it may be, for example, 30.0 or less, 28.0 or less, 26.0 or less, 24.0 or less, 22.0 or less, 20.0 or less, 19.0 or less, 18.0 or less, 17.0 or less, 16.0 or less, 15.0 or less, 14.0 or less, 13.0 or less, 12.0 or less, 11.0 or less, 10.0 or less, or 9.0 or less by mass ratio.

The beer-taste beverage according to an aspect of the present invention is a beer-taste beverage satisfying Formula (3) shown below.

X2/Y1>0.65 :Formula (3)
[In Formula (3), X2 represents an n-propanol content (unit: ppm by mass), and Y1 represents the ethyl acetate content (unit: ppm by mass).]

In the beer-taste beverage according to an aspect of the present invention, the ratio (X2/Y1) between the n-propanol content and the ethyl acetate content in Formula (3) is preferably 0.70 or more, 0.75 or more, 0.80 or more, 0.85 or more, 0.90 or more, 0.95 or more, 1.00 or more, 1.05 or more, 1.10 or more, 1.15 or more, 1.20 or more, 1.25 or more, 1.30 or more, 1.35 or more, 1.40 or more, 1.45 or more, 1.50 or more, 1.60 or more, 1.70 or more, 1.80 or more, 1.90 or more, 2.00 or more, 2.10 or more, 2.20 or more, 2.30 or more, 2.40 or more, 2.50 or more, 2.60 or more, 2.70 or more, 2.80 or more, 2.90 or more, 3.00 or more, 3.50 or more, 4.00 or more, 4.50 or more, or 5.00 or more by mass ratio, from the viewpoint of improving the rich aroma of the beer-taste beverage.

Furthermore, the upper limit value of the ratio (X2/Y1) between the n-propanol content and the ethyl acetate content in Formula (3) is not particularly limited, but it may be, for example, 10.0 or less, 9.00 or less, 8.00 or less, 7.00 or less, 6.00 or less, or 5.00 or less by mass ratio.

The beer-taste beverage according to an aspect of the present invention is a beer-taste beverage satisfying Formula (4) shown below.

X3/Y1>0.65 :Formula (4)

[In Formula (4), X3 represents an isobutanol content (unit: ppm by mass), and Y1 represents the ethyl acetate content (unit: ppm by mass).]

In the beer-taste beverage according to an aspect of the present invention, the ratio (X3/Y1) between the isobutanol content and the ethyl acetate content in Formula (4) is preferably 0.70 or more, 0.75 or more, 0.80 or more, 0.85 or more, 0.90 or more, 0.95 or more, 1.00 or more, 1.05 or more, 1.10 or more, 1.15 or more, 1.20 or more, 1.25 or more, 1.30 or more, 1.35 or more, 1.40 or more, 1.45 or more, 1.50 or more, 1.60 or more, 1.70 or more, 1.80 or more, 1.90 or more, 2.00 or more, 2.10 or more, 2.20 or more, 2.30 or more, 2.40 or more, 2.50 or more, 2.60 or more, 2.70 or more, 2.80 or more, 2.90 or more, 3.00 or more, 3.50 or more, 4.00 or more, 4.50 or more, or 5.00 or more by mass ratio, from the viewpoint of improving the rich aroma of the beer-taste beverage.

Furthermore, the upper limit value of the ratio (X3/Y1) between the isobutanol content and the ethyl acetate content in Formula (4) is not particularly limited, but it may be, for example, 10.0 or less, 9.00 or less, 8.00 or less, 7.00 or less, 6.00 or less, or 5.00 or less by mass ratio.

The beer-taste beverage according to an aspect of the present invention is a beer-taste beverage satisfying Formula (5) shown below.

X4/Y1>0.30 :Formula (5)
[In Formula (5), X4 represents a phenethyl alcohol content (unit: ppm by mass), and Y1 represents the ethyl acetate content (unit: ppm by mass).]

In the beer-taste beverage according to an aspect of the present invention, the ratio (X4/Y1) between the phenethyl alcohol content and the ethyl acetate content in Formula (5) is preferably more than 0.35, 0.40 or more, 0.45 or more, 0.50 or more, 0.55 or more, 0.60 or more, 0.70 or more, 0.75 or more, 0.80 or more, 0.85 or more, 0.90 or more, 0.95 or more, 1.00 or more, 1.05 or more, 1.10 or more 1.15 or more, 1.20 or more, 1.25 or more, 1.30 or more, 1.35 or more, 1.40 or more, 1.45 or more, 1.50 or more, 1.60 or more, 1.70 or more, 1.80 or more, 1.90 or more, 2.00 or more, 2.10 or more, 2.20 or more, 2.30 or more, 2.40 or more, 2.50 or more, 2.60 or more, 2.70 or more, 2.80 or more, 2.90 or more, 3.00 or more, 3.50 or more, 4.00 or more, 4.50 or more, or 5.00 or more by mass ratio, from the viewpoint of improving the rich aroma of the beer-taste beverage.

Furthermore, the upper limit value of the ratio (X4/Y1) between the phenethyl alcohol content and the ethyl acetate content in Formula (5) is not particularly limited, but it may be, for example, 10.0 or less, 9.00 or less, 8.00 or less, 7.00 or less, 6.00 or less, or 5.00 or less by mass ratio.

In the beer-taste beverage according to an aspect of the present invention, the n-propanol content is preferably 10 ppm by mass or more, 20 ppm by mass or more, 30 ppm by mass or more, 40 ppm by mass or more, 50 ppm by mass or more, 55 ppm by mass or more, 60 ppm by mass or more, 65 ppm by mass or more, 70 ppm by mass or more, 75 ppm by mass or more, 80 ppm by mass or more, 85 ppm by mass or more, 90 ppm by mass or more, 95 ppm by mass or more, 100 ppm by mass or more, 110 ppm by mass or more, 120 ppm by mass or more, 130 ppm by mass or more, 140 ppm by mass or more, 150 ppm by mass or more, 160 ppm by mass or more, 170 ppm by mass or more, 180 ppm by mass or more, 190 ppm by mass or more, 200 ppm by mass or more, 250 ppm by mass or more, or 300 ppm by mass or more, from the viewpoint of improving the rich aroma of the beer-taste beverage.

On the other hand, the n-propanol content may be 500 ppm by mass or less, 450 ppm by mass or less, 400 ppm by mass or less, 390 ppm by mass or less, 380 ppm by mass or less, 370 ppm by mass or less, 360 ppm by mass or less, 350 ppm by mass or less, 340 ppm by mass or less, 330 ppm by mass or less, 320 ppm by mass or less, 310 ppm by mass or less, 300 ppm by mass or less, 290 ppm by mass or less, 280 ppm by mass or less, 270 ppm by mass or less, 260 ppm by mass or less, 250 ppm by mass or less, 240 ppm by mass or less, 230 ppm by mass or less, 220 ppm by mass or less, 210 ppm by mass or less, 200 ppm by mass or less, 190 ppm by mass or less, 180 ppm by mass or less, 170 ppm by mass or less, 160 ppm by mass or less, or 150 ppm by mass or less, from the viewpoint of producing a beer-taste beverage having less excessive sensation of irritation from alcohol.

n-propanol may be contained in the raw material of the beer-taste beverage, may be produced during fermentation based on the substrate contained in the raw material, or may be separately added in the production process (for example, purified n-propanol).

The adjustment of the n-propanol content can be performed by appropriately setting, for example, the addition of diluent water or carbonated water and the addition amount thereof when added, the addition of purified n-propanol, the type of n-propanol-containing raw material (such as cereal grain, malt, corn grits, sugar solution, yeast extract, soybean, or pea), the type of raw materials serving as the origin of n-propanol (such as cereal grain, malt, corn grits, sugar solution, yeast extract, soybean, or pea), the amount of the raw materials, the amount of time for enzyme reaction in the mashing step (wort production step from charging raw materials such as malt to before yeast addition), the pH in the mashing step, the addition amount of an acid used in the pH adjustment, the timing for the pH adjustment (for example, during mashing, during fermentation, at the time when fermentation is completed, prior to beverage filtration, and after beverage filtration), the setting temperature and the retention time in each temperature region during wort preparation (including during saccharification), the original extract concentration in a pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, the fermentation temperature, the amount of time for fermentation, pressure setting, and carbon dioxide concentration), and the addition of spirits or brewed alcohol

Furthermore, the n-propanol content can be measured by headspace gas chromatography equipped with an FID detector in accordance with a method described in the item “8.22 Low Boiling Point Aroma Components” of Revised BCOJ Beer Analysis Method (Enlarged and Revised Edition of 2013), which is an analysis method defined by Brewery Convention of Japan (BCOJ), Brewers Association of Japan.

In the beer-taste beverage according to an aspect of the present invention, the isobutanol content is preferably 10 ppm by mass or more, 20 ppm by mass or more, 30 ppm by mass or more, 40 ppm by mass or more, 50 ppm by mass or more, 55 ppm by mass or more, 60 ppm by mass or more, 65 ppm by mass or more, 70 ppm by mass or more, 75 ppm by mass or more, 80 ppm by mass or more, 85 ppm by mass or more, 90 ppm by mass or more, 95 ppm by mass or more, 100 ppm by mass or more, 110 ppm by mass or more, 120 ppm by mass or more, 130 ppm by mass or more, 140 ppm by mass or more, 150 ppm by mass or more, 160 ppm by mass or more, 170 ppm by mass or more, 180 ppm by mass or more, 190 ppm by mass or more, 200 ppm by mass or more, 250 ppm by mass or more, or 300 ppm by mass or more, from the viewpoint of improving the rich aroma of the beer-taste beverage.

On the other hand, the isobutanol content may be 500 ppm by mass or less, 450 ppm by mass or less, 400 ppm by mass or less, 390 ppm by mass or less, 380 ppm by mass or less, 370 ppm by mass or less, 360 ppm by mass or less, 350 ppm by mass or less, 340 ppm by mass or less, 330 ppm by mass or less, 320 ppm by mass or less, 310 ppm by mass or less, 300 ppm by mass or less, 290 ppm by mass or less, 280 ppm by mass or less, 270 ppm by mass or less, 260 ppm by mass or less, 250 ppm by mass or less, 240 ppm by mass or less, 230 ppm by mass or less, 220 ppm by mass or less, 210 ppm by mass or less, 200 ppm by mass or less, 190 ppm by mass or less, 180 ppm by mass or less, 170 ppm by mass or less, 160 ppm by mass or less, or 150 ppm by mass or less, from the viewpoint of producing a beer-taste beverage having less excessive sensation of irritation from alcohol.

Isobutanol may be contained in the raw material of the beer-taste beverage, may be produced during fermentation based on the substrate contained in the raw material, or may be separately added in the production process (for example, purified isobutanol).

The adjustment of the isobutanol content can be performed by appropriately setting, for example, the addition of diluent water or carbonated water and the addition amount thereof when added, the addition of purified isobutanol, the type of isobutanol-containing raw materials (such as cereal grain, malt, corn grits, sugar solution, yeast extract, soybean, or pea), the type of raw materials serving as the origin of isobutanol (such as cereal grain, malt, corn grits, sugar solution, yeast extract, soybean, or pea), the amount of the raw materials, the amount of time for enzyme reaction in the mashing step (wort production step from charging raw materials such as malt to before yeast addition), the pH in the mashing step, the addition amount of an acid used in the pH adjustment, the timing for the pH adjustment (for example, during mashing, during fermentation, at the time when fermentation is completed, prior to beverage filtration, after beverage filtration), the setting temperature and the retention time in each temperature region during wort preparation (including during saccharification), the original extract concentration in a pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, fermentation temperature, the amount of time for fermentation, pressure setting, and carbon dioxide concentration), and the addition of spirits or brewed alcohol.

Furthermore, the isobutanol content can be measured by headspace gas chromatography equipped with an FID detector in accordance with a method described in the item “8.22 Low Boiling Point Aroma Components” of Revised BCOJ Beer Analysis Method (Enlarged and Revised Edition of 2013), which is an analysis method defined by Brewery Convention of Japan (BCOJ), Brewers Association of Japan.

In the beer-taste beverage according to an aspect of the present invention, the phenethyl alcohol content is preferably 10 ppm by mass or more, 15 ppm by mass or more, 20 ppm by mass or more, 25 ppm by mass or more, 30 ppm by mass or more, 35 ppm by mass or more, 40 ppm by mass or more, 45 ppm by mass or more, 50 ppm by mass or more, 55 ppm by mass or more, 60 ppm by mass or more, 65 ppm by mass or more, 70 ppm by mass or more, 75 ppm by mass or more, 80 ppm by mass or more, 85 ppm by mass or more, 90 ppm by mass or more, 95 ppm by mass or more, 100 ppm by mass or more, 110 ppm by mass or more, 120 ppm by mass or more, 130 ppm by mass or more, 140 ppm by mass or more, 150 ppm by mass or more, 160 ppm by mass or more, 170 ppm by mass or more, 180 ppm by mass or more, 190 ppm by mass or more, 200 ppm by mass or more, 250 ppm by mass or more, or 300 ppm by mass or more, from the viewpoint of improving the rich aroma of the beer-taste beverage.

On the other hand, the phenethyl alcohol content is preferably 500 ppm by mass or less, 450 ppm by mass or less, 400 ppm by mass or less, 350 ppm by mass or less, 300 ppm by mass or less, 290 ppm by mass or less, 280 ppm by mass or less, 270 ppm by mass or less, 260 ppm by mass or less, 250 ppm by mass or less, 240 ppm by mass or less, 230 ppm by mass or less, 220 ppm by mass or less, 210 ppm by mass or less, 200 ppm by mass or less, 190 ppm by mass or less, 180 ppm by mass or less, 170 ppm by mass or less, 160 ppm by mass or less, 150 ppm by mass or less, 140 ppm by mass or less, 130 ppm by mass or less, 120 ppm by mass or less, 110 ppm by mass or less, or 100 ppm by mass or less from the viewpoint of producing a beer-taste beverage with less excessive sensation of irritation from alcohol.

Phenethyl alcohol may be contained in the raw material of the beer-taste beverage, may be produced during fermentation based on the substrate contained in the raw material, or may be separately added in the production process (for example, purified phenethyl alcohol).

The adjustment of the phenethyl alcohol content can be performed by appropriately setting, for example, the addition of diluent water or carbonated water and the addition amount thereof when added, the addition of purified phenethyl alcohol, the type of phenethyl alcohol-containing raw material (such as cereal grain, malt, corn grits, sugar solution, yeast extract, soybean, or pea), the type of raw materials serving as the origin of phenethyl alcohol (such as cereal grain, malt, corn grits, sugar solution, yeast extract, soybean, or pea), the amount of the raw materials, the amount of time for enzyme reaction in the mashing step (wort production step from charging raw materials such as malt to before yeast addition), the pH in the mashing step, the addition amount of an acid used in the pH adjustment, the timing for the pH adjustment (for example, during mashing, during fermentation, at the time when fermentation is completed, prior to beverage filtration, after beverage filtration), the setting temperature and the retention time in each temperature region during wort preparation (including during saccharification), the original extract concentration in a pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, fermentation temperature, the amount of time for fermentation, pressure setting, and carbon dioxide concentration), and the addition of spirits or brewed alcohol.

Furthermore, the phenethyl alcohol content can be measured by headspace gas chromatography equipped with an FID detector in accordance with a method described in the item “8.22 Low Boiling Point Aroma Components” of Revised BCOJ Beer Analysis Method (Enlarged and Revised Edition of 2013), which is an analysis method defined by Brewery Convention of Japan (BCOJ), Brewers Association of Japan.

In the beer-taste beverage according to an aspect of the present invention, the ethyl acetate content is 1 ppm by mass or more, 5 ppm by mass or more, 10 ppm by mass or more, 11 ppm by mass or more, 12 ppm by mass or more, 13 ppm by mass or more, 14 ppm by mass or more, 15 ppm by mass or more, 16 ppm by mass or more, 17 ppm by mass or more, 18 ppm by mass or more, 19 ppm by mass or more, 20 ppm by mass or more, 21 ppm by mass or more, 22 ppm by mass or more, 23 ppm by mass or more, 24 ppm by mass or more, 25 ppm by mass or more, 26 ppm by mass or more, 27 ppm by mass or more, 28 ppm by mass or more, 29 ppm by mass or more, 30 ppm by mass or more, 35 ppm by mass or more, 40 ppm by mass or more, 45 ppm by mass or more, 50 ppm by mass or more, 55 ppm by mass or more, 60 ppm by mass or more, 65 ppm by mass or more, 70 ppm by mass or more, 75 ppm by mass or more, 80 ppm by mass or more, 85 ppm by mass or more, 90 ppm by mass or more, 95 ppm by mass or more, or 100 ppm by mass or more, from the viewpoint of improving the rich aroma of the beer-taste beverage.

On the other hand, the ethyl acetate content may be 200 ppm by mass or less, 195 ppm by mass or less, 190 ppm by mass or less, 185 ppm by mass or less, 180 ppm by mass or less, 175 ppm by mass or less, 170 ppm by mass or less, 165 ppm by mass or less, 160 ppm by mass or less, 155 ppm by mass or less, 150 ppm by mass or less, 145 ppm by mass or less, 140 ppm by mass or less, 135 ppm by mass or less, 130 ppm by mass or less, 125 ppm by mass or less, 120 ppm by mass or less, 115 ppm by mass or less, 110 ppm by mass or less, 105 ppm by mass of less, 100 ppm by mass or less, 95 ppm by mass or less, 90 ppm by mass or less, 85 ppm by mass or less, 80 ppm by mass or less, 75 ppm by mass or less, 70 ppm by mass or less, or 65 ppm by mass or less, from the viewpoint of suppressing prominence of an odor unsuitable for richness.

Ethyl acetate may be contained in the raw material of the beer-taste beverage, may be produced during fermentation based on the substrate contained in the raw material, or may be separately added in the production process (for example, purified ethyl acetate).

The adjustment of the ethyl acetate content can be performed by appropriately setting, for example, the addition of diluent water or carbonated water and the addition amount thereof when added, the addition of purified ethyl acetate, the type of ethyl acetate-containing raw materials (such as cereal grain, malt, corn grits, sugar solution, yeast extract, soybean, or pea), the type of raw materials serving as the origin of ethyl acetate (such as cereal grain, malt, corn grits, sugar solution, yeast extract, soybean, or pea), the amount of the raw materials, the amount of time for enzyme reaction in the mashing step (wort production step from charging raw materials such as malt to before yeast addition), the pH in the mashing step, the addition amount of an acid used in the pH adjustment, the timing for the pH adjustment (for example, during mashing, during fermentation, at the time when fermentation is completed, prior to beverage filtration, and after beverage filtration), the setting temperature and the retention time in each temperature region during wort preparation (including during saccharification), the original extract concentration in a pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, fermentation temperature, the amount of time for fermentation, pressure setting, and carbon dioxide concentration), and the addition of spirits or brewed alcohol.

The ethyl acetate content can be measured by a known method using an apparatus such as GC-MS.

In the beer-taste beverage according to an aspect of the present invention, the isoamyl acetate content is 0.1 ppm by mass or more, 0.5 ppm by mass or more, 1.0 ppm by mass or more, 1.1 ppm by mass or more, 1.2 ppm by mass or more, 1.3 ppm by mass or more, 1.4 ppm by mass or more, 1.5 ppm by mass or more, 1.6 ppm by mass or more, 1.7 ppm by mass or more, 1.8 ppm by mass or more, 1.9 ppm by mass or more, 2.0 ppm by mass or more, 2.1 ppm by mass or more, 2.2 ppm by mass or more, 2.3 ppm by mass or more, 2.4 ppm by mass or more, 2.5 ppm by mass or more, 2.6 ppm by mass or more, 2.7 ppm by mass or more, 2.8 ppm by mass or more, 2.9 ppm by mass or more, 3.0 ppm by mass or more, 3.5 ppm by mass or more, 4.0 ppm by mass or more, 4.5 ppm by mass or more, 5.0 ppm by mass or more, 5.5 ppm by mass or more, 6.0 ppm by mass or more, 6.5 ppm by mass or more, 7.0 ppm by mass or more, 7.5 ppm by mass or more, 8.0 ppm by mass or more, 8.5 ppm by mass or more, 9.0 ppm by mass or more, 9.5 ppm by mass or more, or 10 ppm by mass or more, from the viewpoint of improving the rich aroma of the beer-taste beverage.

On the other hand, the isoamyl acetate content may be 20 ppm by mass or less, 19 ppm by mass or less, 18 ppm by mass or less, 17 ppm by mass or less, 16 ppm by mass or less, 15 ppm by mass or less, 14.5 ppm by mass or less, 14 ppm by mass or less, 13.5 ppm by mass or less, 13 ppm by mass or less, 12.5 ppm by mass or less, 12 ppm by mass or less, 11.5 ppm by mass or less, 11 ppm by mass or less, 10.5 ppm by mass or less, 10 ppm by mass or less, 9.5 ppm by mass or less, 9.0 ppm by mass or less, 8.5 ppm by mass or less, 8.0 ppm by mass or less, 7.5 ppm by mass or less, 7.0 ppm by mass or less, 6.5 ppm by mass or less, or 6.0 ppm by mass or less, from the viewpoint of suppressing prominence of an odor unsuitable for richness.

Isoamyl acetate may be contained in the raw material of the beer-taste beverage, may be produced during fermentation based on the substrate contained in the raw material, or may be separately added in the production process (for example, purified isoamyl acetate).

The adjustment of the isoamyl acetate content can be performed by appropriately setting, for example, the addition of diluent water or carbonated water and the addition amount thereof when added, the addition of purified isoamyl acetate, the type of isoamyl acetate-containing raw materials (such as cereal grain, malt, corn grits, sugar solution, yeast extract, soybean, or pea), the type of raw materials serving as the origin of isoamyl acetate (such as cereal grain, malt, corn grits, sugar solution, yeast extract, soybean, or pea), the amount of the raw materials, the amount of time for enzyme reaction in the mashing step (wort production step from charging raw materials such as malt to before yeast addition), the pH in the mashing step, the addition amount of an acid used in the pH adjustment, the timing for the pH adjustment (for example, during mashing, during fermentation, at the time when fermentation is completed, prior to beverage filtration, after beverage filtration), the setting temperature and the retention time in each temperature region during wort preparation (including during saccharification), the original extract concentration in a pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, fermentation temperature, the amount of time for fermentation, pressure setting, and carbon dioxide concentration), and the addition of spirits or brewed alcohol.

The isoamyl acetate content can be measured by a known method using an apparatus such as GC-MS.

In the beer-taste beverage according to an aspect of the present invention, the ethyl caproate content is preferably 100 ppb by mass or more, 110 ppb by mass or more, 120 ppb by mass or more, 130 ppb by mass or more, 140 ppb by mass or more, 150 ppb by mass or more, 160 ppb by mass or more, 170 ppb by mass or more, 180 ppb by mass or more, 190 ppb by mass or more, 200 ppb by mass or more, 210 ppb by mass or more, 220 ppb by mass or more, 230 ppb by mass or more, 240 ppb by mass or more, 250 ppb by mass or more, 260 ppb by mass or more, 270 ppb by mass or more, 280 ppb by mass or more, 290 ppb by mass or more, 300 ppb by mass or more, 310 ppb by mass or more, 320 ppb by mass or more, 330 ppb by mass or more, 340 ppb by mass or more, 350 ppb by mass or more, 360 ppb by mass or more, 370 ppb by mass or more, 380 ppb by mass or more, 390 ppb by mass or more, or 400 ppb by mass or more, from the viewpoint of improving the rich aroma of the beer-taste beverage.

On the other hand, the ethyl caproate content may be 1000 ppb by mass or less, 950 ppb by mass or less, 900 ppb by mass or less, 850 ppb by mass or less, 800 ppb by mass or less, 750 ppb by mass or less, 700 ppb by mass or less, 650 ppb by mass or less, 600 ppb by mass or less, 550 ppb by mass or less, 500 ppb by mass or less, 450 ppb by mass or less, 400 ppb by mass or less, 390 ppb by mass or less, 380 ppb by mass or less, 370 ppb by mass or less, 360 ppb by mass or less, 350 ppb by mass or less, 340 ppb by mass or less, 330 ppb by mass or less, 320 ppb by mass or less, 310 ppb by mass or less, 300 ppb by mass or less, 290 ppb by mass or less, 280 ppb by mass or less, 270 ppb by mass or less, 260 ppb by mass or less, 250 ppb by mass or less, 240 ppb by mass or less, 230 ppb by mass or less, 220 ppb by mass or less, 210 ppb by mass or less, or 200 ppb by mass or less, from the viewpoint of suppressing prominence of an odor unsuitable for richness.

Ethyl caproate may be contained in the raw material of the beer-taste beverage, may be produced during fermentation based on the substrate contained in the raw material, or may be separately added in the production process (for example, purified ethyl caproate).

The adjustment of the ethyl caproate content can be performed by appropriately setting, for example, the addition of diluent water or carbonated water and the addition amount thereof when added, the addition of purified ethyl caproate, the type of ethyl caproate-containing raw material (such as cereal grain, malt, corn grits, sugar solution, yeast extract, soybean, or pea), the type of raw materials serving as the origin of ethyl caproate (such as cereal grain, malt, corn grits, sugar solution, yeast extract, soybean, or pea), the amount of the raw materials, the amount of time for enzyme reaction in the mashing step (wort production step from charging raw materials such as malt to before yeast addition), the pH in the mashing step, the addition amount of an acid used in the pH adjustment, the timing for the pH adjustment (for example, during mashing, during fermentation, at the time when fermentation is completed, prior to beverage filtration, and after beverage filtration), the setting temperature and the retention time in each temperature region during wort preparation (including during saccharification), the original extract concentration in a pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, fermentation temperature, the amount of time for fermentation, pressure setting, and carbon dioxide concentration), and the addition of spirits or brewed alcohol.

The ethyl caproate content can be measured by a known method using an apparatus such as GC-MS.

In the beer-taste beverage according to an aspect of the present invention, the ethyl octanoate content is preferably 100 ppb by mass or more, 150 ppb by mass or more, 200 ppb by mass or more, 210 ppb by mass or more, 220 ppb by mass or more, 230 ppb by mass or more, 240 ppb by mass or more, 250 ppb by mass or more, 260 ppb by mass or more, 270 ppb by mass or more, 280 ppb by mass or more, 290 ppb by mass or more, 300 ppb by mass or more, 310 ppb by mass or more, 320 ppb by mass or more, 330 ppb by mass or more, 340 ppb by mass or more, 350 ppb by mass or more, 360 ppb by mass or more, 370 ppb by mass or more, 380 ppb by mass or more, 390 ppb by mass or more, 400 ppb by mass or more, 410 ppb by mass or more, 420 ppb by mass or more, 430 ppb by mass or more, 440 ppb by mass or more, 450 ppb by mass or more, 460 ppb by mass or more, 470 ppb by mass or more, 480 ppb by mass or more, 490 ppb by mass or more, or 500 ppb by mass or more, from the viewpoint of improving the rich aroma of the beer-taste beverage.

On the other hand, the ethyl octanoate content may be 1000 ppb by mass or less, 950 ppb by mass or less, 900 ppb by mass or less, 850 ppb by mass or less, 800 ppb by mass or less, 750 ppb by mass or less, 700 ppb by mass or less, 650 ppb by mass or less, 600 ppb by mass or less, 590 ppb by mass or less, 580 ppb by mass or less, 570 ppb by mass or less, 560 ppb by mass or less, 550 ppb by mass or less, 540 ppb by mass or less, 530 ppb by mass or less, 520 ppb by mass or less, 510 ppb by mass or less, 500 ppb by mass or less, 490 ppb by mass or less, 480 ppb by mass or less, 470 ppb by mass or less, 460 ppb by mass or less, 450 ppb by mass or less, 440 ppb by mass or less, 430 ppb by mass or less, 420 ppb by mass or less, 410 ppb by mass or less, 400 ppb by mass or less, 390 ppb by mass or less, 380 ppb by mass or less, 370 ppb by mass or less, 360 ppb by mass or less, 350 ppb by mass or less, 340 ppb by mass or less, 330 ppb by mass or less, 320 ppb by mass or less, 310 ppb by mass or less, or 300 ppb by mass or less, from the viewpoint of suppressing prominence of an odor unsuitable for richness.

Ethyl octanoate may be contained in the raw material of the beer-taste beverage, may be produced during fermentation based on the substrate contained in the raw material, or may be separately added in the production process (for example, purified ethyl octanoate).

The adjustment of the ethyl octanoate content can be performed by appropriately setting, for example, the addition of diluent water or carbonated water and the addition amount thereof when added, the addition of purified ethyl octanoate, the type of ethyl octanoate-containing raw material (such as cereal grain, malt, corn grits, sugar solution, yeast extract, soybean, or pea), the type of raw materials serving as the origin of ethyl octanoate (such as cereal grain, malt, corn grits, sugar solution, yeast extract, soybean, or pea), the amount of the raw materials, the amount of time for enzyme reaction in the mashing step (wort production step from charging raw materials such as malt to before yeast addition), the pH in the mashing step, the addition amount of an acid used in the pH adjustment, the timing for the pH adjustment (for example, during mashing, during fermentation, at the time when fermentation is completed, prior to beverage filtration, and after beverage filtration), the setting temperature and the retention time in each temperature region during wort preparation (including during saccharification), the original extract concentration in a pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, fermentation temperature, the amount of time for fermentation, pressure setting, and carbon dioxide concentration), and the addition of spirits or brewed alcohol.

The ethyl octanoate content can be measured by a known method using an apparatus such as GC-MS.

In the beer-taste beverage according to an aspect of the present invention, the ratio (isoamyl alcohol/alcohol strength) between the alcohol strength (unit: (v/v) %) and the isoamyl alcohol content (unit: ppm by mass) is preferably 5.00 or more, 5.25 or more, 5.50 or more, 6.00 or more, 6.25 or more, 6.50 or more, 7.00 or more, 7.50 or more, 8.00 or more, 8.25 or more, 8.50 or more, 9.00 or more, 10.0 or more, 11.0 or more, 12.0 or more, 13.0 or more, 14.0 or more, 15.0 or more, 16.0 or more, 17.0 or more, 18.0 or more, 19.0 or more, 20.0 or more, 25.0 or more, 30.0 or more, 40.0 or more, or 50.0 or more by mass ratio, from the viewpoint of improving the rich aroma and producing a beer-taste beverage in which excessive sensation of irritation from alcohol is unlikely to be felt.

The upper limit value of the ratio is not particularly limited, but it may be, for example, 100 or less, 90.0 or less, 80.0 or less, 70.0 or less, 60.0 or less, or 50.0 or less.

In the beer-taste beverage according to an aspect of the present invention, the ratio (ethyl acetate/alcohol strength) between the alcohol strength (unit: (v/v) %) and the ethyl acetate content (unit: ppm by mass) is preferably 1.00 or more, 1.15 or more, 1.25 or more, 1.50 or more, 1.75 or more, 2.00 or more, 2.25 or more, 2.50 or more, 2.75 or more, 3.00 or more, 3.25 or more, 3.50 or more, 3.75 or more, 4.00 or more, 4.25 or more, 4.50 or more, 4.75 or more, 5.00 or more, 5.50 or more, 6.00 or more, 6.50 or more, 7.00 or more, 7.50 or more, 8.00 or more, 8.50 or more, 9.00 or more, 9.50 or more, or 10.0 or more by mass ratio, from the viewpoint of improving the rich aroma and producing a beer-taste beverage in which excessive sensation of irritation from alcohol is unlikely to be felt.

The upper limit value of the ratio is not particularly limited, but it may be, for example, 50.0 or less, 40.0 or less, 30.0 or less, 25.0 or less, 20.0 or less, 15.0 or less, or 10.0 or less.

The pH of the beer-taste beverage according to an aspect of the present invention is preferably 2.00 or more, 2.20 or more, 2.40 or more, 2.60 or more, 2.80 or more, 3.00 or more, 3.10 or more, 3.20 or more, 3.30 or more, 3.40 or more, 3.50 or more, 3.60 or more, 3.70 or more, 3.80 or more, 3.90 or more, or 4.00 or more, and is preferably 5.40 or less, 5.20 or less, 5.00 or less, 4.95 or less, 4.90 or less, 4.85 or less, 4.80 or less, 4.75 or less, 4.70 or less, 4.65 or less, 4.60 or less, 4.55 or less, 4.50 or less, 4.45 or less, 4.40 or less, 4.35 or less, or 4.30 or less, and can also be 4.00 or less, or less than 4.00, from the viewpoint of improving the flavor.

The adjustment of the pH can be performed by appropriately setting, for example, the addition of diluent water or carbonated water and the addition amount thereof when added, the type of the raw materials (such as cereal grain, malt, corn grits, and sugar solution), the amounts of the raw materials, the type of enzyme, the addition amount of the enzyme, the timing for enzyme addition, the amount of time for saccharification in a mashing tank, the amount of time for proteolysis in the mashing tank, the pH in the mashing tank, the pH in the mashing step (wort production step from charging malt to before yeast addition), the type of the acid (such as lactic acid, phosphoric acid, malic acid, tartaric acid, or citric acid) used in pH adjustment, the addition amount of the acid used in pH adjustment, the timing for the pH adjustment (for example, during mashing, during fermentation, at the time when fermentation is completed, prior to beverage filtration, and after beverage filtration), the setting temperature and the retention time in each temperature region during wort preparation (including during saccharification), the original extract concentration in a pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, fermentation temperature, the amount of time for fermentation, pressure setting, and carbon dioxide concentration), the timing for cooling, the cooling temperature, and the amount of time for cooling.

The beer-taste beverage of an aspect of the present invention is suitable for an aspect of packaging in a container. Examples of the container include bottles, plastic bottles, cans (including bottle cans) or barrels. Examples of the container of a preferred aspect include a reclosable container. Specific examples thereof include reclosable bottles, reclosable plastic bottles, and reclosable cans (e.g., reclosable bottle cans).

### A1.1 Raw Material

In the beer-taste beverage according to an aspect of the present invention, grain is used as a raw material. Examples of the grain used as the raw material include cereal grain, rice (such as white rice and brown rice), corn, kaoliang, potato, legumes (such as soybeans and peas), buckwheat, sorghum, foxtail millet, and Japanese millet.

In the beer-taste beverage according to an aspect of the present invention, cereal grain (including ungerminated cereal grain, malt, and the like) is used as a raw material. The cereal grain used as the raw material refers to cereal grains such as barley, wheat, rye, wild oats, oats, adlay, and common oats, and there is no limitation on the production area and the variety. In the case of producing the beer-taste beverage using malt, malt obtained by germinating and drying the seeds of these cereal grains and removing the roots can be used. In the case of producing the beer-taste beverage substantially free of malt, cereal grain extract obtained by extracting these cereal grains can be used.

In an aspect of the present invention, it is preferable to use barley (including extract from barley such as barley extract) or barley malt. Barley is one of the most commonly used cereal grains as a raw material for Japanese beer-taste beverages. Examples of the barley include two-rowed barley and six-rowed barley, and any of them may be used. The cereal grain or malt (including cereal grain extract and malt extract) may be used alone or in combination of two or more thereof. When colored malt is used, different types of colored malts may be appropriately used in combination, or one colored malt may be used.

The beer-taste beverage according to an aspect of the present invention may be a beverage using hops as a raw material, or may be a beverage not using hops. In addition, a sweetener, a water-soluble dietary fiber, a bittering agent or a bitterness imparting agent, an antioxidant, a flavoring agent, an acidulant, salts may be used.

The malt proportion (proportion of all malt used) of the beer-taste beverage according to an aspect of the present invention may be preferably more than 30 mass %, 35 mass % or more, 40 mass % or more, 45 mass % or more, 50 mass % or more, 51 mass % or more, 52 mass % or more, 54 mass % or more, 55 mass % or more, 56 mass % or more, 57 mass % or more, 58 mass % or more, 59 mass % or more, 60 mass % or more, 61 mass % or more, 62 mass % or more, 63 mass % or more, 64 mass % or more, 65 mass % or more, 66 mass % or more, more than 66 mass %, 66.6 mass % or more, 67 mass % or more, 68 mass % or more, 69 mass % or more, 70 mass % or more, 71 mass % or more, 72 mass % or more, 73 mass % or more, 74 mass % or more, 75 mass % or more, 76 mass % or more, 77 mass % or more, 78 mass % or more, 79 mass % or more, 80 mass % or more, 81 mass % or more, 82 mass % or more, 83 mass % or more, 84 mass % or more, 85 mass % or more, 86 mass % or more, 87 mass % or more, 88 mass % or more, 89 mass % or more, 90 mass % or more, 91 mass % or more, 92 mass % or more, 93 mass % or more, 94 mass % or more, 95 mass % or more, 96 mass % or more, 97 mass % or more, 98 mass % or more, 99 mass % or more, or 100 mass %. By improving the malt proportion, the beer-taste beverage in which a rich taste derived from malt and umami of cereal grain can be more strongly felt can be produced.

On the other hand, the malt proportion of the beer-taste beverage according to an aspect according to the present invention may be less than 100 mass %, 99 mass % or less, 98 mass % or less, 97 mass % or less, 96 mass % or less, 95 mass % or less, 94 mass % or less, 93 mass % or less, 92 mass % or less, 91 mass % or less, 90 mass % or less, 89 mass % or less, 88 mass % or less, 87 mass % or less, 86 mass % or less, 85 mass % or less, 84 mass % or less, 83 mass % or less, 82 mass % or less, 81 mass % or less, 80 mass % or less, 79 mass % or less, 78 mass % or less, 77 mass % or less, 76 mass % or less, 75 mass % or less, 74 mass % or less, 73 mass % or less, 72 mass % or less, 71 mass % or less, 70 mass % or less, 69 mass % or less, 68 mass % or less, 67 mass % or less, less than 67 mass %, 66.6 mass % or less, 66 mass % or less, 65 mass % or less, 64 mass % or less, 63 mass % or less, 62 mass % or less, 61 mass % or less, 60 mass % or less, 59 mass % or less, 58 mass % or less, 57 mass % or less, 56 mass % or less, 55 mass % or less, 54 mass % or less, 53 mass % or less, 52 mass % or less, 51 mass % or less, 50 mass % or less, or less than 50 mass % from the viewpoint of producing a beer-taste beverage less likely to impart an unsuitable sensation of satiety.

As used herein, the term “malt proportion” refers to a value calculated according to the Interpretation Notice on the Liquor Tax Law and the Administrative Ordinance Related to Alcoholic Beverages and the like enforced on Apr. 1, 2018.

When suppressing the malt proportion, it is preferable to increase the amount of a raw material assimilable by yeast (a carbon source and a nitrogen source) other than malt. Examples of the carbon source as the raw material assimilable by yeast include monosaccharides, disaccharides, trisaccharides, and sugar solutions thereof; examples of the nitrogen source as the raw materials assimilable by yeast include yeast extract, soybean protein, malt, soybeans, yeast extract, peas, wheat malt, ungerminated grains, and decomposition products thereof. Examples of the ungerminated grains include ungerminated barley, ungerminated wheat, ungerminated rye, ungerminated wild oats, ungerminated oats, ungerminated adlay, ungerminated common oats, ungerminated rice (such as white rice and brown rice), ungerminated corn, ungerminated kaoliang, ungerminated potato, ungerminated legumes (such as soybeans and peas), ungerminated buckwheat, ungerminated sorghum, ungerminated foxtail millet, and ungerminated Japanese millet. In addition, starch obtained from these grains and extract thereof (extract) may be used.

Examples of the form of the hops used in one aspect of the present invention include pellet hops, powdered hops, and hops extract. The hops used may be a processed hop product, such as isomerized hops or reduced hops.

The addition amount of the hops is appropriately adjusted, and is preferably from 0.0001 to 1 mass % with respect to the total amount of the beverage. In addition, the beer-taste beverage using hops as the raw material is a beverage containing iso-α-acid, which is a component derived from hops.

Examples of the sweetener include commercially available saccharified liquid obtained by decomposing grain-derived starch with an acid, an enzyme or the like, saccharides such as sucrose and commercially available starch syrup, natural sweeteners such as saccharides that contains 3 or more monosaccharide units, sugar alcohols, isomerized sugars and stevia, and artificial sweeteners.

These saccharides may be in the form of a liquid, such as a solution, or a solid, such as a powder.

In addition, there are no particular limitations on the type of grains serving as raw materials for starch, a method for purifying starch, and the process conditions such as hydrolysis with an enzyme or an acid. For example, a saccharide having an increased proportion of maltose may be used, by appropriately setting the conditions for the hydrolysis with an enzyme or an acid. In addition, there can also be used sucrose, fructose, glucose, mannose, arabinose, galactose, xylose, rhamnose, ribose, fucose, lactose, maltose, trehalose, maltotriose, maltotetraose, maltopentaose, isomaltose, isomaltotriose, isomaltotetraose, isomaltopentaose, lactosucrose, 4′-galactosyllactose, 1-kestose, nystose, fructofuranosylnystose, raffinose, stachyose, xylobiose, xylotriose, panose, and solutions (sugar solutions) thereof. Examples of the artificial sweeteners include aspartame, acesulfame potassium (acesulfame K), sucralose, and neotame. These sweeteners may be used alone, or in combination of two or more. As a raw material other than malt, a sugar assimilable by yeast (assimilable sugar) can be further added to increase the alcohol strength.

Examples of the water-soluble dietary fiber include indigestible dextrin, polydextrose, a guar gum decomposition product, pectin, glucomannan, alginic acid, laminarin, fucoidan and carrageenan, and indigestible dextrin or polydextrose is preferable from a point of view of versatility such as stability and safety.

These water-soluble dietary fibers may be used alone, or in combination of two or more.

In the beer-taste beverage, the bitterness is preferably imparted by hops or the like, but the bittering agent or the bitterness imparting agent may be further used.

The bittering agent or the bitterness imparting agent is not particularly limited, and there can be used either of those used as a bitterness imparting agent in normal beers or low-malt beers, and examples thereof include rosemary, lychee, amur cork tree, caraway, juniper berry, sage, salvia rosmarimis, lingzhi mushroom, laurel, lingzhi mushroom, quassin, citrus extract, picrasma wood extract, coffee extract, tea extract, bitter melon extract, lotus embryo extract, candelabra aloe extract, rosemary extract, lychee extract, laurel extract, sage extract, caraway extract, wormwood extract, absinthin, alginic acid, and gallic acid.

These bittering agents or bitterness imparting agents may be used alone, or two or more thereof may be used in combination.

The antioxidant is not particularly limited, and there can be used a substance used as an antioxidant in normal beers or low-malt beers, and examples thereof include ascorbic acid, erythorbic acid, and catechin. One of these antioxidants may be used alone, or two or more thereof may be used in combination.

The flavoring agent is not particularly limited, and a typical beer flavoring agent can be used. The beer flavoring agent is used for imparting a beer-like flavor, and contains a brewing component produced by fermentation. Thus, when the production process of the beer-taste beverage involves alcoholic fermentation, it is not necessary to separately add the beer flavoring agent, but the beer flavoring agent may be added as desired.

Examples of the beer flavoring agent include esters and higher alcohols, and specific examples thereof include isoamyl acetate, ethyl acetate, n-propanol (such as 1-propanol), isobutanol, acetaldehyde, ethyl caproate, ethyl caprylate, isoamyl propionate, linalool, geraniol, citral, 4-vinylguaiacol (4-VG), 4-methyl-3-pentenoic acid, 2-methyl-2-pentenoic acid, 1,4-cineole, 1,8-cineole, 2,3-diethyl-5-methylpyrazine, γ-decanolactone, γ-undecalactone, ethyl hexanoate, ethyl 2-methylbutyrate, ethyl n-butyrate, myrcene, citral, limonene, ethyl maltol, phenylacetic acid, furaneol, furfural, methional, 3-methyl-2-butene-1-thiol, 3-methyl-2-butanethiol, diacetyl, ferulic acid, geranic acid, geranyl acetate, ethyl butyrate, octanoic acid, decanoic acid, 9-decenoic acid, nonanoic acid, tetradecanoic acid, propanoic acid, 2-methylpropanoic acid, γ-butyrolactone, 2-aminoacetophenone, ethyl 3-phenylpropionate, 2-ethyl-4-hydroxy-5-methyl-3 (2H)-furanone, dimethylsulfone, 3-methylcyclopentane-1,2-dione, 2-methylbutanal, 3-methylbutanal, 2-methyltetrahydrofuran-3-one, 2-acetylfuran, 2-methyltetrahydrofuran-3-one, hexanal, hexanol, cis-3-hexenal, 1-octene-3-ol, β-eudesmol, 4-mercapto-4-methylpentane-2-one, β-caryophyllene, β-myrcene, furfuryl alcohol, 2-ethylpyrazine, 2,3-dimethylpyrazine, 2-methylbutyl acetate, isoamyl alcohol, 5-hydroxymethylfurfural, phenylacetaldehyde, 1-phenyl-3-butene-1-one, trans-2-hexenal, nonanal, phenethyl alcohol, nerol, citronellol, methyl p-toluate, 1,2,3,5-tetramethylbenzene, triethyl citrate, tributyl citrate, diethyl tartrate, dibutyl malate, perillaldehyde, methylheptenone, lemon myrtle, and cinnamaldehyde.

One of these beer flavoring agents may be used alone, or two or more thereof may be used in combination.

The acidulant is not particularly limited as long as it is a substance having sourness, and for example, phosphoric acid, citric acid, gluconic acid, tartaric acid, lactic acid, malic acid, phytic acid, acetic acid, succinic acid, glucono-delta-lactone, or salts thereof can be used.

Among these acidulants, phosphoric acid, citric acid, gluconic acid, tartaric acid, lactic acid, malic acid, phytic acid, acetic acid, succinic acid or salts thereof are preferable, phosphoric acid, malic acid, citric acid, lactic acid, tartaric acid, acetic acid, or salts thereof are more preferable, and phosphoric acid, malic acid, citric acid, lactic acid, or salts thereof are particularly preferable.

One of these acidulants may be used alone, or two or more of these acidulants may be used in combination. Note that, the acidulant is not limited to an acidulant approved as food additives, and there may be used an acidulant derived from a raw material such as malt, an acidulant produced by adjustments of various process conditions, an acidulant produced by yeast, and an acidulant to be externally added as an additive, for example.

The content of the acidulant in the beer-taste beverage according to an aspect of the present invention is preferably from 500 to 10000 ppm by mass, more preferably from 1000 to 9000 ppm by mass, still more preferably from 2000 to 8000 ppm by mass.

Examples of the preservative include: benzoic acid; benzoic acid salts such as sodium benzoate; benzoic acid esters such as propyl parahydroxybenzoate and butyl parahydroxybenzoate; and dimethyl dicarbonate. Also, as the preservative, a commercially available preparation, such as Kyohryoku Sanpurezah (Powerful Sanplezer) (a mixture of sodium benzoate and butyl benzoate, available from San-Ei Gen F.F.L, Inc.) may be used. One of these preservatives may be used alone, or two or more of these preservatives may be used in combination.

The blending amount of the preservative in the beer-taste beverage according to an aspect of the present invention is preferably from 5 to 1200 ppm by mass, more preferably from 10 to 1100 ppm by mass, still more preferably from 15 to 1000 ppm by mass, and even more preferably from 20 to 900 ppm by mass.

Examples of the salts include sodium chloride, potassium acid phosphate, calcium acid phosphate, ammonium phosphate, magnesium sulfate, calcium sulfate, potassium metabisulfite, calcium chloride, magnesium chloride, potassium nitrate, ammonium sulfate, potassium chloride, monosodium citrate, disodium citrate, and trisodium citrate.

One of these salts may be used alone, or two or more of these salts may be used in combination.

### A1.2 Carbon Dioxide Gas

The beer-taste beverage according to an aspect of the present invention may contain dissolved carbon dioxide gas, or may not contain dissolved carbon dioxide gas.

As the carbon dioxide gas contained in the beer-taste beverage, the carbon dioxide gas contained in the raw material may be used, or carbon dioxide gas may be dissolved, for example, by mixing carbonated water or by addition of carbon dioxide gas.

The beer-taste beverage according to one aspect of the present invention is produced through the alcoholic fermentation, and hence the carbon dioxide gas generated in this fermentation step can be used directly, but the amount of carbon dioxide gas may be prepared by appropriately adding carbonated water.

When the beer-taste beverage according to an aspect of the present invention contains dissolved carbon dioxide gas, the carbon dioxide gas concentration is preferably 0.30 (w/w) % or more, 0.35 (w/w) % or more, 0.40 (w/w) % or more, 0.42 (w/w) % or more, 0.45 (w/w) % or more, 0.47 (w/w) % or more, 0.50 (w/w) % or more, or 0.52 (w/w) % or more, and the carbon dioxide gas concentration may be 0.80 (w/w) % or less, 0.70 (w/w) % or less, 0.60 (w/w) % or less, 0.57 (w/w) or less, 0.55 (w/w) % or less, 0.54 (w/w) % or less, 0.53 (w/w) % or less, 0.52 (w/w) % or less, 0.51 (w/w) % or less, or 0.50 (w/w) % or less.

When the beer-taste beverage according to an aspect of the present invention is a packaged beverage, the carbon dioxide gas pressure of the packaged beverage may be appropriately adjusted such that the carbon dioxide gas concentration is in the range described above, and the carbon dioxide gas pressure is 5.0 kg/cm² or less, 4.5 kg/cm² or less, or 4.0 kg/cm² or less, and 0.20 kg/cm² or more, 0.50 kg/cm² or more, or 1.0 kg/cm² or more. Any of these upper and lower limits may be combined. For example, the carbon dioxide gas pressure may be 0.20 kg/cm² or more and 5.0 kg/cm² or less, 0.50 kg/cm² or more and 4.5 kg/cm² or less, or 1.0 kg/cm² or more and 4.0 kg/cm² or less.

In the present specification, the gas pressure refers to gas pressure in the container except in special cases.

The pressure can be measured by a method well-known to those skilled in the art, for example, using a method in which a sample adjusted to 20 °C is fixed to a gas internal pressure gauge, the stopcock of the gas internal pressure gauge is opened once to release the gas, the stopcock is closed again, the gas internal pressure gauge is shaken, and a value when the pointer reaches a certain position is read; or using a commercially available gas pressure measuring instrument.

### A1.3 Other Additives

In the beer-taste beverage according to an aspect of the present invention, various additives may be added as necessary to the extent that the effects of the present invention are not compromised.

Examples of such additives include a coloring agent, a foaming agent, a fermentation accelerator, yeast extract, a protein-based substance such as a peptide-containing substance, and a seasoning such as an amino acid.

The coloring agent is used to impart beer-like color to the beverage, and for example, a caramel dye can be used. The foaming agent is used to form beer-like foam in the beverage or to retain the foam in the beverage, and there can be appropriately used, for example, a saponin-based substance extracted from a plant, such as soybean saponin or quillaja saponin; a plant protein such as a protein from corn or soybean; and a peptide-containing substance such as a collagen peptide; yeast extract; and an ingredient derived from milk.

The fermentation accelerator is used for promoting fermentation by yeast, and examples thereof include yeast extract, a bran component from, for example, rice or cereal grain, a vitamin, and a mineral agent. A single type of the fermentation accelerator can be used alone or two or more types of the fermentation accelerators may be used in combination.

### <<Aspect B: Corresponding to JP 2023-100225>>

### B1. Beer-Taste Beverage

As used herein, the term “beer-taste beverage” refers to an alcohol-containing carbonated beverage with a beer-like flavor. That is, unless otherwise specified, the beer-taste beverage as used herein encompasses any carbonated beverage with a flavor of beer.

Therefore, the “beer-taste beverage” includes not only beer, which is a malt-fermented beverage obtained by fermenting malt, hops, and water as raw materials with yeast, and fermented beer-taste beverages, but also a carbonated beverage to which a beer flavoring agent including, for example, esters, higher alcohols, and lactones has been added, and other low-malt beer and effervescent liqueurs classified under the names defined in Japanese Liquor Tax Law.

In addition, the beer-taste beverage according to an aspect of the present invention may be a fermented beer-taste beverage that has undergone a fermentation step using yeast or may be a non-fermented beer-taste beverage that has not undergone the fermentation step.

The fermented beer-taste beverage may be an ale beer-taste beverage brewed through the fermentation step using top-fermenting yeast (e.g., Saccharomyces), a lager beer-taste beverage brewed through the fermentation step using bottom-fermenting yeast (e.g., Saccharomyces), or a pilsner beer-taste beverage, or may be a beer-taste beverage produced by blending these beer-taste beverages. The term “fermentation” as used herein may be alcoholic fermentation that produces alcohol, or may be non-alcoholic fermentation that does not produce alcohol.

In addition, the beer-taste beverage according to an aspect of the present invention may be a malt-containing beer-taste beverage using malt (such as barley malt and wheat malt) as a raw material, or may be a malt-free beer-taste beverage without using malt. Examples of the malt-containing beer-taste beverage include barley malt-containing beer-taste beverages.

In addition, the beer-taste beverage according to an aspect of the present invention may be a cereal grain-containing beer-taste beverage using cereal grain (such as barley and wheat) as a raw material, or may be a cereal grain-free beer-taste beverage without using cereal grain. Examples of the cereal grain-containing beer-taste beverage include barley-containing beer-taste beverages.

The beer-taste beverage according to the present invention is a beer-taste beverage having an alcohol strength of 8.0 (v/v) % or more and a succinic acid content of 110 ppm by mass or more and 1100 ppm by mass or less, and satisfying Formula (1A) shown below.

X1/Y1≥0.25 :Formula (1A)

[In Formula (1A), X1 represents the succinic acid content (unit: ppm by mass), and Y1 represents an acetic acid content (unit: ppm by mass).]

When a beer-taste beverage was designed to have a high alcohol strength, an unsuitable sweet aroma was excessively added, and the beverage tended to have low drinkability. As a result of repeated studies by the inventors of the present invention on such a problem, it has been found that even when the alcohol strength is designed to be as high as 8.0 (v/v) % or more, the clean taste and the mild sourness are firmly felt by adjusting a succinic acid content and a content ratio between succinic acid and acetic acid to predetermined ranges, and thus, an unsuitable sweet aroma caused by the high alcohol strength is hardly felt.

The alcohol strength (ethanol content) (v/v) % of the beer-taste beverage according to an aspect of the present invention is 8.0 (v/v) % or more from the viewpoint of producing a beer-taste beverage having moderate sensation of irritation, and the alcohol strength may be 8.5 (v/v) % or more, 9.0 (v/v) % or more, 9.5 (v/v) % or more, 10.0 (v/v) % or more, 10.5 (v/v) % or more, 11.0 (v/v) % or more, 11.5 (v/v) % or more, 12.0 (v/v) % or more, 12.5 (v/v) % or more, 13.0 (v/v) % or more, 13.5 (v/v) % or more, 14.0 (v/v) % or more, 14.5 (v/v) % or more, 15.0 (v/v) % or more, 15.5 (v/v) % or more, 16.0 (v/v) % or more, 16.5 (v/v) % or more, 17.0 (v/v) % or more, 17.5 (v/v) % or more, 18.0 (v/v) % or more, 18.5 (v/v) % or more, 19.0 (v/v) % or more, 19.5 (v/v) % or more, 20.0 (v/v) % or more, 20.5 (v/v) % or more, 21.0 (v/v) % or more, 21.5 (v/v) % or more, 22.0 (v/v) % or more, 22.5 (v/v) % or more, 23.0 (v/v) % or more, 23.5 (v/v) % or more, 24.0 (v/v) % or more, 24.5 (v/v) % or more, or 25.0 (v/v) % or more.

On the other hand, from the viewpoint of producing a beer-taste beverage with less excessive sensation of irritation, the alcohol strength may be 50.0 (v/v) % or less, 45.0 (v/v) % or less, 40.0 (v/v) % or less, 35.0 (v/v) % or less, 30.0 (v/v) % or less, 25.0 (v/v) % or less, 24.5 (v/v) % or less, 24.0 (v/v) % or less, 23.5 (v/v) % or less, 23.0 (v/v) % or less, 22.5 (v/v) % or less, 22.0 (v/v) % or less, 21.5 (v/v) % or less, 21.0 (v/v) % or less, 20.5 (v/v) % or less, or 20.0 (v/v) % or less.

Note that, as used herein, the alcohol strength is indicated as a percentage based on volume/volume ((v/v) %). The alcohol content of the beverage can be measured by any known method, and for example, can be measured according to “8.3 Alcohol” in “Revised BCOJ Beer Analysis Method, revised and enlarged in 2013 (edited by Brewery Convention of Japan, Brewers Association of Japan (Analysis Committee), published by Public Interest Incorporated Foundation, The Brewing Society of Japan).

The adjustment of the alcohol strength can be performed by appropriately setting, for example, the addition of diluent water or carbonated water and the addition amount thereof when added, the type of raw materials (such as cereal grain, malt, corn grits, and sugar solution), the amount of the raw materials, the type of enzyme, the addition amount of the enzyme, the timing for enzyme addition, the amount of time for saccharification in a mashing tank, the amount of time for proteolysis in the mashing tank, the pH in the mashing tank, the pH in a mashing step (wort production step from malt addition to before yeast addition), the addition amount of an acid to be used during the pH adjustment, the timing for the pH adjustment (for example, during mashing, during fermentation, at the time when fermentation is completed, before beverage filtration, and after beverage filtration), the setting temperature and the retention time in each temperature region during wort preparation (including during saccharification), the original extract concentration in a pre-fermentation liquid, the original extract concentration in the fermentation step, fermentation conditions (such as oxygen concentration, aeration conditions, yeast species, the addition amount of yeast, the number of proliferated yeast cells, the timing for yeast removal, the fermentation temperature, the amount of time for fermentation, pressure setting, carbon dioxide concentration, the addition amount of enzyme, the type of enzyme, the timing for enzyme addition), the addition of ethanol, and the addition of ethanol composition (for example, alcohol for raw materials, spirits (distilled liquor) such as shochu, Awamori, whiskey, brandy, vodka, ram, tequila, and gin, and brewed alcohol).

The beer-taste beverage according to an aspect of the present invention may contain, or may not contain, as an alcohol component, spirits (distilled liquor) derived from grains such that the alcohol strength is adjusted to be within the range described above. The beer-taste beverage according to an aspect of the present invention is preferably a beverage containing no spirits from the viewpoint of producing a beer-like, beer-taste beverage having a high-quality taste. That is, it is preferable that the beer-taste beverage according to an aspect of the present invention contains no ethanol solution or ethanol-containing composition as a raw material.

In the beer-taste beverage according to an aspect of the present invention, the succinic acid content is 110 ppm by mass or more from the viewpoint of improving the clean taste. The content is also preferably 120 ppm by mass or more, 130 ppm by mass or more, 140 ppm by mass or more, 150 ppm by mass or more, 160 ppm by mass or more, 170 ppm by mass or more, 180 ppm by mass or more, 190 ppm by mass or more, 200 ppm by mass or more, 205 ppm by mass or more, 210 ppm by mass or more, 215 ppm by mass or more, 220 ppm by mass or more, 225 ppm by mass or more, 230 ppm by mass or more, 235 ppm by mass or more, 240 ppm by mass or more, 245 ppm by mass or more, 250 ppm by mass or more, 260 ppm by mass or more, 270 ppm by mass or more, 280 ppm by mass or more, 290 ppm by mass or more, 300 ppm by mass or more, 310 ppm by mass or more, 320 ppm by mass or more, 330 ppm by mass or more, 340 ppm by mass or more, 350 ppm by mass or more, 360 ppm by mass or more, 370 ppm by mass or more, 380 ppm by mass or more, 390 ppm by mass or more, 400 ppm by mass or more, 410 ppm by mass or more, 420 ppm by mass or more, 430 ppm by mass or more, 440 ppm by mass or more, 450 ppm by mass or more, 460 ppm by mass or more, 470 ppm by mass or more, 480 ppm by mass or more, 490 ppm by mass or more, or 500 ppm by mass or more.

On the other hand, the succinic acid content is 1100 ppm by mass or less from the view point of producing a beverage in which sourness is not too strong but mild sourness is felt. The content may also be preferably 1090 ppm by mass or less, 1080 ppm by mass or less, 1070 ppm by mass or less, 1060 ppm by mass or less, 1050 ppm by mass or less, 1040 ppm by mass or less, 1030 ppm by mass or less, 1020 ppm by mass or less, 1010 ppm by mass or less, 1000 ppm by mass or less, 950 ppm by mass or less, 900 ppm by mass or less, 850 ppm by mass or less, 800 ppm by mass or less, 750 ppm by mass or less, 700 ppm by mass or less, 650 ppm by mass or less, 600 ppm by mass or less, 590 ppm by mass or less, 580 ppm by mass or less, 570 ppm by mass or less, 560 ppm by mass or less, 550 ppm by mass or less, 540 ppm by mass or less, 530 ppm by mass or less, 520 ppm by mass or less, 510 ppm by mass or less, 500 ppm by mass or less, 450 ppm by mass or less, 400 ppm by mass or less, 350 ppm by mass or less, or 300 ppm by mass or less.

Succinic acid may be contained in the raw material of the beer-taste beverage, may be produced during fermentation based on the substrate contained in the raw material, or may be separately added in the production process (for example, purified succinic acid).

The adjustment of the succinic acid content can be performed by appropriately setting, for example, the addition of diluent water or carbonated water and the addition amount thereof when added, the addition of purified succinic acid, the type of succinic acid-containing raw materials (such as cereal grain, malt, corn grits, sugar solution, yeast extract, soybeans, or peas), the type of raw materials serving as the origin of succinic acid (such as cereal grain, malt, corn grits, sugar solution, yeast extract, soybean, or pea), the amount of the raw materials, the amount of time for enzyme reaction in the mashing step (wort production step from charging raw materials such as malt to before yeast addition), the pH in the mashing step, the addition amount of the acid used in the pH adjustment, the timing for the pH adjustment (for example, during mashing, during fermentation, at the time when fermentation is completed, prior to beverage filtration, and after beverage filtration), the setting temperature and the retention time in each temperature region during wort preparation (including during saccharification), the original extract concentration in the pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, fermentation temperature, the amount of time for fermentation, pressure setting, and carbon dioxide concentration), and the addition of spirits or brewed alcohol. The succinic acid content can be measured by a known method using high performance liquid chromatography (HPLC).

The beer-taste beverage according to the present invention is a beer-taste beverage satisfying Formula (LA) shown below.

X1/Y1≥0.25 :Formula (1A)

[In Formula (1A), X1 represents the succinic acid content (unit: ppm by mass), and Y1 represents the acetic acid content (unit: ppm by mass).]

In the beer-taste beverage according to an aspect of the present invention, the ratio (X1/Y1) between the succinic acid content and the acetic acid content in Formula (1A) is, preferably, by mass ratio, 0.30 or more, 0.35 or more, 0.40 or more, 0.45 or more, 0.50 or more, 0.55 or more, 0.60 or more, 0.62 or more, 0.64 or more, 0.66 or more, 0.68 or more, 0.70 or more, 0.72 or more, 0.74 or more, 0.76 or more, 0.78 or more, 0.80 or more, 0.85 or more, 0.90 or more, 0.95 or more, 1.00 or more, 1.10 or more, 1.20 or more, 1.30 or more, 1.35 or more, 1.40 or more, 1.45 or more, 1.50 or more, 1.55 or more, 1.60 or more, 1.70 or more, 1.80 or more, 1.90 or more, 2.00 or more, 2.05 or more, 2.10 or more, 2.20 or more, 2.30 or more, 2.40 or more, 2.50 or more, 2.60 or more, 2.70 or more, 2.80 or more, 2.90 or more, 3.00 or more, 3.05 or more, 3.10 or more, 3.20 or more, 3.25 or more, 3.30 or more, 3.40 or more, 3.50 or more, 3.55 or more, or 3.60 or more, from the viewpoint of producing a beer-taste beverage having a improved clean taste.

Preferably, the content ratio (X1/Y1) between succinic acid and acetic acid is, for example, 30.0 or less, 25.0 or less, 20.0 or less, 15.0 or less, 10.0 or less, 9.50 or less, 9.00 or less, 8.50 or less, 8.00 or less, 7.50 or less, 7.00 or less, 6.50 or less, 6.00 or less, 5.50 or less, 5.00 or less, 4.50 or less, 4.00 or less, 3.90 or less, 3.80 or less, 3.70 or less, 3.65 or less, 3.60 or less, 3.50 or less, 3.40 or less, 3.30 or less, 3.20 or less, 3.15 or less, 3.10 or less, 3.05 or less, or 3.00 or less by mass ratio from the viewpoint of producing a beer-taste beverage in which mild sourness is moderately felt.

The beer-taste beverage according to an aspect of the present invention is a beer-taste beverage satisfying Formula (1B) shown below.

X2/Y1>0.32 :Formula (1B)

[In Formula (1B), X2 represents a citric acid content (unit: ppm by mass), and Y1 represents the acetic acid content (unit: ppm by mass).]

In the beer-taste beverage according to an aspect of the present invention, the ratio (X2/Y1) between of the citric acid content and the acetic acid content in Formula (1B) is 0.33 or more, 0.35 or more, 0.40 or more, 0.50 or more, 0.60 or more, 0.70 or more, 0.75 or more, 0.80 or more, 0.90 or more, 1.00 or more, 1.05 or more, 1.10 or more, 1.15 or more, 1.20 or more, 1.25 or more, 1.30 or more, 1.35 or more, 1.40 or more, 1.45 or more, 1.50 or more, 1.55 or more, 1.60 or more, 1.65 or more, 1.70 or more, 1.75 or more, 1.80 or more, 1.85 or more, 1.90 or more, 1.95 or more, 2.00 or more, 2.10 or more, 2.20 or more, 2.30 or more, 2.40 or more, 2.50 or more, 2.60 or more, 2.70 or more, 2.80 or more, 2.90 or more, 3.00 or more, 3.10 or more. 3.20 or more, 3.30 or more, 3.40 or more, or 3.50 or more by mass ratio, from the viewpoint of producing a beer-taste beverage having a improved clean taste.

In addition, the content ratio (X2/Y1) between citric acid and acetic acid in Formula (1B) is preferably, for example, 30.0 or less, 20.0 or less, 10.0 or less, 9.00 or less, 8.00 or less, 7.00 or less, 6.00 or less, 5.00 or less, 4.50 or less, 4.00 or less, 3.90 or less, 3.80 or less, 3.70 or less, 3.60 or less, 3.50 or less, 3.40 or less, 3.30 or less, 3.20 or less, 3.10 or less, 3.00 or less, 2.90 or less, 2.80 or less, 2.70 or less, 2.60 or less, 2.50 or less, 2.45 or less, less than 2.40, 2.40 or less, 2.35 or less, 2.30 or less, 2.25 or less, or 2.20 or less by mass ratio from the viewpoint of producing a beer-taste beverage in which mild sourness is moderately felt.

The beer-taste beverage according to an aspect of the present invention is a beer-taste beverage satisfying Formula (1C) shown below.

X3/Y1>0.72 :Formula (1C)

[In Formula (1C), X3 represents a phosphoric acid content (unit: ppm by mass), and Y1 represents the acetic acid content (unit: ppm by mass).]

In the beer-taste beverage according to an aspect of the present invention, the ratio (X3/Y1) between the phosphoric acid content and the acetic acid content in Formula (1C) is 0.75 or more, 0.80 or more, 0.90 or more, 1.00 or more, 1.10 or more, 1.20 or more, 1.30 or more, 1.40 or more, or more, 1.50 or more, 1.60 or more, 1.70 or more, 1.80 or more, 1.90 or more, 2.00 or more, 2.10 or more, 2.20 or more, 2.30 or more, 2.40 or more, 2.50 or more, 2.60 or more, 2.70 or more, 2.80 or more, 2.90 or more, 3.00 or more, 3.10 or more, 3.20 or more, 3.30 or more, 3.40 or more, 3.50 or more, 3.60 or more, 3.70 or more, 3.80 or more, 3.90 or more, 4.00 or more, 4.10 or more, 4.20 or more, 4.30 or more, 4.40 or more, 4.50 or more, 4.60 or more, 4.70 or more, 4.80 or more, 4.90 or more, 5.00 or more, 5.10 or more, 5.20 or more, 5.30 or more, 5.40 or more, 5.50 or more, 5.60 or more, 5.70 or more, 5.80 or more, 5.90 or more, or 6.00 or more by mass ratio, from the viewpoint of producing a beer-taste beverage having an improved clean taste.

The content ratio (X3/Y1) between phosphoric acid and acetic acid in Formula (1C) is, for example, 30.0 or less, 25.0 or less, 20.0 or less, 15.0 or less, 10.0 or less, 9.50 or less, 9.00 or less, 8.50 or less, 8.00 or less, 7.50 or less, 7.00 or less, 6.90 or less, 6.80 or less, 6.70 or less, 6.60 or less, 6.50 or less, 6.40 or less, 6.30 or less, 6.20 or less, 6.10 or less, 6.00 or less, 5.90 or less, 5.80 or less, 5.70 or less, 5.60 or less, 5.55 or less, 5.50 or less, 5.00 or less, or 4.50 or less by mass ratio from the viewpoint of producing a beer-taste beverage in which mild sourness is moderately felt.

The beer-taste beverage according to an aspect of the present invention is a beer-taste beverage satisfying Formula (2A) shown below.

X1/Z≥0.50 :Formula (2A)

[In Formula (2A), X1 represents the succinic acid content (unit: ppm by mass), and Z represents an isoamyl alcohol content (unit: ppm by mass).]

In the beer-taste beverage according to an aspect of the present invention, the ratio (X1/Z) between the succinic acid content and the isoamyl alcohol content in Formula (2A) is more than 0.50, 0.55 or more, 0.60 or more, 0.70 or more, 0.75 or more, 0.80 or more, 0.85 or more, 0.90 or more, 0.95 or more, 1.00 or more, 1.05 or more, 1.10 or more, 1.15 or more, 1.20 or more, 1.25 or more 1.30, or more, 1.35 or more, 1.40 or more, 1.45 or more, 1.50 or more, 1.60 or more, 1.70 or more, 1.80 or more, 1.90 or more, 2.00 or more, 2.10 or more, 2.20 or more, 2.30 or more, 2.40 or more, 2.50 or more, 2.60 or more, 2.70 or more, 2.80 or more, 2.90 or more, 3.00 or more, 3.10 or more, 3.20 or more, 3.30 or more, 3.40 or more, 3.50 or more, 4.00 or more, 4.50 or more, 5.00 or more, 5.50 or more, 6.00 or more, 6.50 or more, 7.00 or more, 7.50 or more, 8.00 or more, 8.50 or more, 9.00 or more, or 10.0 or more by mass ratio, from the viewpoint of producing a beer-taste beverage having an improved clean taste.

The ratio (X1/Z) between the succinic acid content and the isoamyl alcohol content in Formula (2A) is also preferably, for example, 30.0 or less, 20.0 or less, 15.0 or less, 14.0 or less, 13.0 or less, 12.0 or less, less than 12.0, 11.5 or less, 11.0 or less, 10.5 or less, 10.0 or less, 9.00 or less, 8.00 or less, 7.00 or less, 6.00 or less, 5.00 or less, 4.50 or less, 4.00 or less, 3.50 or less, 3.00 or less, 2.50 or less, or 2.00 or less by mass ratio from the viewpoint of producing a beer-taste beverage in which mild sourness is moderately felt.

The beer-taste beverage according to an aspect of the present invention is a beer-taste beverage satisfying Formula (2B) shown below.

X2/Z≥0.78 :Formula (2B)

[In Formula (2B), X2 represents the citric acid content (unit: ppm by mass), and Z represents the isoamyl alcohol content (unit: ppm by mass).]

In the beer-taste beverage according to an aspect of the present invention, the ratio (X2/Z) between the citric acid content and the isoamyl alcohol content in Formula (2B) is more than 0.78, 0.80 or more, 0.90 or more, 1.00 or more, 1.10 or more, 1.20 or more, 1.30 or more, 1.40 or more, 1.50 or more, 1.60 or more, 1.70 or more, 1.80 or more, 1.90 or more, 2.00 or more, 2.10 or more, 2.20 or more, 2.30 or more, or more, 2.40 or more, 2.50 or more, 2.60 or more, 2.70 or more, 2.80 or more, 2.90 or more, 3.00 or more, 3.10 or more, 3.20 or more, 3.30 or more, 3.40 or more, 3.50 or more, 3.60 or more, 3.70 or more, 3.80 or more, 3.90 or more, 4.00 or more, 4.10 or more, 4.20 or more, 4.30 or more, 4.40 or more, 4.50 or more, 4.60 or more, 4.70 or more, 4.80 or more, 4.90 or more, 5.00 or more, 5.50 or more, 6.00 or more, 6.50 or more, 7.00 or more, 7.50 or more, or 8.00 or more by mass ratio, from the viewpoint of producing a beer-taste beverage having an improved clean taste.

The content ratio (X2/Z) between citric acid and isoamyl alcohol in Formula (2B) is, for example, 30.0 or less, 25.0 or less, 20.0 or less, 15.0 or less, 10.0 or less, 9.50 or less, 9.00 or less, 8.50 or less, 8.00 or less, 7.50 or less, 7.00 or less, 6.50 or less, 6.00 or less, 5.50 or less, 5.00 or less, 4.50 or less, 4.00 or less, 3.50 or less, 3.00 or less, 2.50 or less, 2.00 or less, 1.50 or less, or 1.00 or less by mass ratio from the viewpoint of producing a beer-taste beverage in which mild sourness is moderately felt.

The beer-taste beverage according to an aspect of the present invention is a beer-taste beverage satisfying Formula (2C) shown below.

X3/Z≥1.73 :Formula (2C)

[In Formula (2C), X3 represents the phosphoric acid content (unit: ppm by mass), and Z represents the isoamyl alcohol content (unit: ppm by mass).]

In the beer-taste beverage according to an aspect of the present invention, the ratio (X3/Z) between the phosphoric acid content and the isoamyl alcohol content in Formula (2C) is also preferably more than 1.73, 1.75 or more, 1.80 or more, 2.00 or more, 2.20 or more, 2.40 or more, 2.60 or more, 2.80 or more, 3.00 or more, 3.20 or more, 3.40 or more, 3.60 or more, 3.80 or more, 4.00 or more, 4.50 or more, 5.00 or more, 5.50 or more, 6.00 or more, 6.50 or more, 7.00 or more, 7.50 or more, 8.00 or more, 8.50 or more, 9.00 or more, 9.50 or more, 10.0 or more, 11.0 or more, 12.0 or more, 13.0 or more, 14.0 or more, 15.0 or more, 16.0 or more, 17.0 or more, 18.0 or more, 19.0 or more, or 20.0 or more by mass ratio, from the viewpoint of producing a beer-taste beverage having an improved clean taste.

In addition, the content ratio (X3/Z) between phosphoric acid and isoamyl alcohol in Formula (2C) may be, for example, 30.0 or less, 25.0 or less, 20.0 or less, 19.0 or less, 15.0 or less, 12.0 or less, 10.0 or less, 9.00 or less, 8.00 or less, 7.00 or less, 6.50 or less, 6.20 or less, 6.00 or less, 5.50 or less, 5.00 or less, 4.50 or less, 4.00 or less, 3.70 or less, 3.50 or less, or 3.00 or less by mass ratio, from the viewpoint of producing a beer-taste beverage in which mild sourness is moderately felt.

The beer-taste beverage according to an aspect of the present invention is a beer-taste beverage satisfying Formula (3) shown below.

Y1/Z≥0.66 :Formula (3)

[In Formula (3), Y1 represents the acetic acid content (unit: ppm by mass), and Z represents the isoamyl alcohol content (unit: ppm by mass).]

In the beer-taste beverage according to an aspect of the present invention, the ratio (Y1/Z) between the acetic acid content and the isoamyl alcohol content in Formula (3) is more than 0.66, 0.70 or more, 0.80 or more, 0.90 or more, 1.00 or more, 1.05 or more, 1.10 or more, 1.20 or more, 1.30 or more, 1.40 or more, 1.50 or more, 1.60 or more, 1.70 or more, 1.80 or more, 1.90 or more, 2.00 or more, 2.10 or more, 2.20 or more, 2.30 or more, 2.40 or more, 2.50 or more, 2.60 or more, 2.70 or more, 2.80 or more, 2.90 or more, 3.00 or more, 3.10 or more, 3.20 or more, 3.22 or more, 3.25 or more, 3.30 or more, 3.40 or more, or 3.50 or more by mass ratio, from the viewpoint of producing a beer-taste beverage having a good balance between sharp sourness and a rich aroma.

From the same viewpoint as the above, the ratio (Y1/Z) between the acetic acid content and the isoamyl alcohol content in Formula (3) may be preferably, for example, 30.0 or less, 20.0 or less, 15.0 or less, 10.0 or less, 9.00 or less, 8.00 or less, 7.00 or less, 6.00 or less, 5.00 or less, 4.50 or less, 4.00 or less, 3.50 or less, 3.30 or less, 3.00 or less, 2.50 or less, 2.00 or less, 1.50 or less, 1.20 or less, or 1.00 or less by mass ratio.

The beer-taste beverage according to an aspect of the present invention is a beer-taste beverage satisfying Formula (4) shown below.

X/Y1>1.25 :Formula (4)

[In Formula (4), X represents the total content (unit: ppm by mass) of one or more acidulants selected from the group consisting of phosphoric acid, citric acid, and succinic acid, and Y1 represents the acetic acid content (unit: ppm by mass).]

In the beer-taste beverage according to an aspect of the present invention, the ratio (X/Y1) between the total content of one or more acidulants selected from the group consisting of phosphoric acid, citric acid, and succinic acid and the acetic acid content in Formula (4) is preferably 1.30 or more, 1.50 or more, 2.00 or more, 2.50 or more, 3.00 or more, 3.50 or more, 4.00 or more, 4.10 or more, 4.20 or more, 4.30 or more, or more, 4.40 or more, 4.50 or more, 4.60 or more, 4.70 or more, 4.80 or more, 4.90 or more, 5.00 or more, 5.50 or more, 6.00 or more, 6.10 or more, 6.20 or more, 6.30 or more, 6.40 or more, 6.50 or more, 6.60 or more, 6.70 or more, 6.80 or more, 6.90 or more, 7.00 or more, 7.50 or more, 7.60 or more, 7.70 or more, 7.80 or more, 7.90 or more, 8.00 or more, 8.10 or more, 8.20 or more, 8.50 or more, 9.00 or more, 9.50 or more, or 10.0 or more by mass ratio, from the viewpoint of producing a beer-taste beverage having an improved clean taste.

The content ratio (X/Y1) between the total content of one or more acidulants selected from the group consisting of phosphoric acid, citric acid, and succinic acid and the acetic acid content in Formula (4) is preferably, for example, 30.0 or less, 25.0 or less, 20.0 or less, 15.0 or less, 12.0 or less, 11.0 or less, 10.0 or less, 9.50 or less, 9.00 or less, 8.50 or less, 8.00 or less, 7.50 or less, 7.00 or less, 6.90 or less, 6.80 or less, 6.70 or less, 6.60 or less, 6.50 or less, 6.40 or less, 6.30 or less, 6.20 or less, 6.10 or less, 6.00 or less, 5.90 or less, 5.80 or less, 5.70 or less, 5.60 or less, 5.50 or less, or 5.00 or less by mass ratio, from the viewpoint of producing a beer-taste beverage in which mild sourness is moderately felt.

The beer-taste beverage according to an aspect of the present invention is a beer-taste beverage satisfying Formula (5) shown below.

(X1+X2+X3)/Y1>1.25 :Formula (5)

[In Formula (5), X1 represents the phosphoric acid content, X2 represents the citric acid content, X3 represents the succinic acid content (unit: ppm by mass), and Y1 represents the acetic acid content (unit: ppm by mass).]

In the beer-taste beverage according to an aspect of the present invention, the ratio ((X1+X2+X3)/Y1) between the total content of phosphoric acid, citric acid, and succinic acid and the acetic acid content in Formula (5) is preferably 1.30 or more, 1.50 or more, 2.00 or more, 2.50 or more, 3.00 or more, 3.50 or more, 4.00 or more, 4.10 or more, 4.20 or more, 4.30 or more, or more, 4.40 or more, 4.50 or more, 4.60 or more, 4.70 or more, 4.80 or more, 4.90 or more, 5.00 or more, 5.50 or more, 6.00 or more, 6.10 or more, 6.20 or more, 6.30 or more, 6.40 or more, 6.50 or more, 6.60 or more, 6.70 or more, 6.80 or more, 6.90 or more, 7.00 or more, 7.50 or more, 7.60 or more, 7.70 or more, 7.80 or more, 7.90 or more, 8.00 or more, 8.10 or more, 8.20 or more, 8.50 or more, 9.00 or more, 9.50 or more, or 10.0 or more by mass ratio, from the viewpoint of producing a beer-taste beverage having an improved clean taste.

Further, the content ratio ((X1+X2+X3)/Y1) between the total content of phosphoric acid, citric acid, and succinic acid and the acetic acid content in Formula (5) is preferably, for example, 30.0 or less, 25.0 or less, 20.0 or less, 15.0 or less, 12.0 or less, 11.0 or less, 10.0 or less, 9.50 or less, 9.00 or less, 8.50 or less, 8.00 or less, 7.50 or less, 7.00 or less, 6.90 or less, 6.80 or less, 6.70 or less, 6.60 or less, 6.50 or less, 6.40 or less, 6.30 or less, 6.20 or less, 6.10 or less, 6.00 or less, 5.90 or less, 5.80 or less, 5.70 or less, 5.60 or less, 5.50 or less, or 5.00 or less by mass ratio, from the viewpoint of producing a beer-taste beverage in which mild sourness is moderately felt.

In the beer-taste beverage according to an aspect of the present invention, the isoamyl alcohol content is preferably 10 ppm by mass or more, 30 ppm by mass or more, 50 ppm by mass or more, 80 ppm by mass or more, 90 ppm by mass or more, 100 ppm by mass or more, 110 ppm by mass or more, 120 ppm by mass or more, 130 ppm by mass or more, 140 ppm by mass or more, 150 ppm by mass or more, 160 ppm by mass or more, 170 ppm by mass or more, 180 ppm by mass or more, 190 ppm by mass or more, 200 ppm by mass or more, 210 ppm by mass or more, 220 ppm by mass or more, 230 ppm by mass or more, 240 ppm by mass or more, 250 ppm by mass or more, 260 ppm by mass or more, 270 ppm by mass or more, 280 ppm by mass or more, 290 ppm by mass or more, 300 ppm by mass or more, 310 ppm by mass or more, 320 ppm by mass or more, 330 ppm by mass or more, 340 ppm by mass or more, 350 ppm by mass or more, 360 ppm by mass or more, 370 ppm by mass or more, 380 ppm by mass or more, 390 ppm by mass or more, 400 ppm by mass or more, 410 ppm by mass or more, 420 ppm by mass or more, 430 ppm by mass or more, 440 ppm by mass or more, 450 ppm by mass or more, 460 ppm by mass or more, 470 ppm by mass or more, 480 ppm by mass or more, 490 ppm by mass or more, or 500 ppm by mass or more, from the viewpoint of improving the rich aroma of the beer-taste beverage.

On the other hand, the isoamyl alcohol content may be 1000 ppm by mass or less, 950 ppm by mass or less, 900 ppm by mass or less, 850 ppm by mass or less, 800 ppm by mass or less, 750 ppm by mass or less, 700 ppm by mass or less, 650 ppm by mass or less, 600 ppm by mass or less, 590 ppm by mass or less, 580 ppm by mass or less, 570 ppm by mass or less, 560 ppm by mass or less, 550 ppm by mass or less, 540 ppm by mass or less, 530 ppm by mass or less, 520 ppm by mass or less, 510 ppm by mass or less, 500 ppm by mass or less, 490 ppm by mass or less, 480 ppm by mass or less, 470 ppm by mass or less, 460 ppm by mass or less, 450 ppm by mass or less, 440 ppm by mass or less, 430 ppm by mass or less, 420 ppm by mass or less, 410 ppm by mass or less, 400 ppm by mass or less, 390 ppm by mass or less, 380 ppm by mass or less, 370 ppm by mass or less, 360 ppm by mass or less, 350 ppm by mass or less, 340 ppm by mass or less, 330 ppm by mass or less, 320 ppm by mass or less, 310 ppm by mass or less, or 300 ppm by mass or less, from the viewpoint of producing a beer-taste beverage having less excessive sensation of irritation from alcohol.

Isoamyl alcohol may be contained in the raw material of the beer-taste beverage, may be produced during fermentation based on a substrate contained in the raw material, or may be separately added in the production process (for example, purified isoamyl alcohol).

The adjustment of the isoamyl alcohol content can be performed by appropriately setting, for example, the addition of diluent water or carbonated water and the addition amount thereof when added, the addition of purified isoamyl alcohol, the type of isoamyl alcohol-containing raw materials (such as cereal grain, malt, corn grits, sugar solution, yeast extract, soybean, or pea), the type of raw materials serving as the origin of isoamyl alcohol (such as cereal grain, malt, corn grits, sugar solution, yeast extract, soybean, or pea), the amount of the raw materials, the amount of time for enzyme reaction in the mashing step (wort production step from charging raw materials such as malt to before yeast addition), the pH in the mashing step, the addition amount of an acid used in the pH adjustment, the timing for the pH adjustment (for example, during mashing, during fermentation, at the time when fermentation is completed, prior to beverage filtration, and after beverage filtration), the setting temperature and the retention time in each temperature region during wort preparation (including during saccharification), the original extract concentration in a pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, the fermentation temperature, the amount of time for fermentation, pressure setting, and carbon dioxide concentration), and the addition of spirits or brewed alcohol.

Furthermore, the content of isoamyl alcohol can be measured by headspace gas chromatography equipped with an FID detector in accordance with a method described in the item” 8.22 Low Boiling Point Aroma Components” of Revised BCOJ Beer Analysis Method (Enlarged and Revised Edition of 2013), which is an analysis method defined by Brewery Convention of Japan (BCOJ), Brewers Association of Japan.

In the beer-taste beverage according to an aspect of the present invention, the citric acid content may be 100 ppm by mass or more, 150 ppm by mass or more, 200 ppm by mass or more, 250 ppm by mass or more, 300 ppm by mass or more, 310 ppm by mass or more, 320 ppm by mass or more, 325 ppm by mass or more, 330 ppm by mass or more, 340 ppm by mass or more, 350 ppm by mass or more, 360 ppm by mass or more, 370 ppm by mass or more, 380 ppm by mass or more, 385 ppm by mass or more, more than 388 ppm by mass, 390 ppm by mass or more, 400 ppm by mass or more, 410 ppm by mass or more, 420 ppm by mass or more, 430 ppm by mass or more, 440 ppm by mass or more, 450 ppm by mass or more, 460 ppm by mass or more, 470 ppm by mass or more, 480 ppm by mass or more, 490 ppm by mass or more, 500 ppm by mass or more, 510 ppm by mass or more, 520 ppm by mass or more, 530 ppm by mass of more, 540 ppm by mass or more, 550 ppm by mass or more, 560 ppm by mass or more, 570 ppm by mass or more, 580 ppm by mass or more, 590 ppm by mass or more, 600 ppm by mass or more, 610 ppm by mass or more, 620 ppm by mass or more, 630 ppm by mass or more, 640 ppm by mass or more, 650 ppm by mass or more, 660 ppm by mass or more, 670 ppm by mass or more, 680 ppm by mass or more, 690 ppm by mass or more, 700 ppm by mass or more, 710 ppm by mass or more, 720 ppm by mass or more, 730 ppm by mass or more, 740 ppm by mass or more, 750 ppm by mass or more, 760 ppm by mass or more, 770 ppm by mass or more, 780 ppm by mass or more, 790 ppm by mass or more, 800 ppm by mass or more, 850 ppm by mass or more, 900 ppm by mass or more, 950 ppm by mass or more, or 1000 ppm by mass or more, from the viewpoint of improving the clean taste.

On the other hand, from the viewpoint of producing a beer-taste beverage that is not too sour, the citric acid content may be 2000 ppm by mass or less, 1900 ppm by mass or less, 1800 ppm by mass or less, 1700 ppm by mass or less, 1600 ppm by mass or less, 1500 ppm by mass or less, 1400 ppm by mass or less, 1300 ppm by mass or less, 1200 ppm by mass or less, 1100 ppm by mass or less, 1000 ppm by mass or less, 900 ppm by mass or less, 800 ppm by mass or less, 750 ppm by mass or less, 730 ppm by mass or less, 710 ppm by mass or less, 700 ppm by mass or less, 650 ppm by mass or less, 600 ppm by mass or less, 590 ppm by mass or less, 580 ppm by mass or less, 570 ppm by mass or less, 560 ppm by mass or less, 550 ppm by mass or less, 540 ppm by mass or less, 530 ppm by mass or less, 520 ppm by mass or less, 510 ppm by mass or less, 500 ppm by mass or less, 450 ppm by mass or less, or 400 ppm by mass or less.

Citric acid may be contained in the raw material of the beer-taste beverage, may be produced during fermentation based on the substrate contained in the raw material, or may be separately added in the production process (for example, purified citric acid).

The adjustment of the citric acid content can be performed by appropriately setting, for example, the addition of diluent water or carbonated water and the addition amount thereof when added, the addition of purified citric acid, the type of citric acid-containing raw materials (such as cereal grain, malt, corn grits, sugar solution, yeast extract, soybeans, or peas), the type of raw materials serving as the origin of citric acid (such as cereal grain, malt, corn grits, sugar solution, yeast extract, soybean, or pea), the amount of the raw materials, the amount of time for enzyme reaction in the mashing step (wort production step from charging raw materials such as malt to before yeast addition), the pH in the mashing step, the addition amount of the acid used in the pH adjustment, the timing for the pH adjustment (for example, during mashing, during fermentation, at the time when fermentation is completed, prior to beverage filtration, and after beverage filtration), the setting temperature and the retention time in each temperature region during wort preparation (including during saccharification), the original extract concentration in the pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, fermentation temperature, the amount of time for fermentation, pressure setting, and carbon dioxide concentration), and the addition of spirits or brewed alcohol.

Furthermore, the citric acid content can be measured by a known method using high performance liquid chromatography (HPLC).

In the beer-taste beverage according to an aspect of the present invention, the phosphoric acid content may be 100 ppm by mass or more, 200 ppm by mass or more, 300 ppm by mass or more, 400 ppm by mass or more, 500 ppm by mass or more, 600 ppm by mass or more, 650 ppm by mass or more, 700 ppm by mass or more, 750 ppm by mass or more, 800 ppm by mass or more, 810 ppm by mass or more, 820 ppm by mass or more, 830 ppm by mass or more, 840 ppm by mass or more, 850 ppm by mass or more, 860 ppm by mass or more, 870 ppm by mass or more, 880 ppm by mass or more, 890 ppm by mass or more, 900 ppm by mass or more, 910 ppm by mass or more, 920 ppm by mass or more, 930 ppm by mass or more, 940 ppm by mass of more, 950 ppm by mass or more, 960 ppm by mass or more, 970 ppm by mass or more, 980 ppm by mass or more, 990 ppm by mass or more, 1000 ppm by mass or more, 1050 ppm by mass or more, 1100 ppm by mass or more, 1150 ppm by mass or more, 1200 ppm by mass or more, 1250 ppm by mass or more, 1300 ppm by mass or more, 1350 ppm by mass or more, 1400 ppm by mass or more, 1450 ppm by mass or more, 1500 ppm by mass or more, 1600 ppm by mass or more, 1700 ppm by mass or more, 1800 ppm by mass or more, 1850 ppm by mass or more, 1900 ppm by mass or more, 1950 ppm by mass or more, or 2000 ppm by mass or more, from the viewpoint of improving the clean taste.

On the other hand, from the viewpoint of producing a beer-taste beverage that is not too sour, the phosphoric acid content may be 3000 ppm by mass or less, 2700 ppm by mass or less, 2500 ppm by mass or less, 2400 ppm by mass or less, 2300 ppm by mass or less, 2200 ppm by mass or less, 2100 ppm by mass or less, 2000 ppm by mass or less, 1950 ppm by mass or less, 1900 ppm by mass or less, 1850 ppm by mass or less, 1800 ppm by mass or less, 1700 ppm by mass or less, 1600 ppm by mass or less, 1500 ppm by mass or less, 1450 ppm by mass or less, 1400 ppm by mass or less, 1350 ppm by mass or less, 1300 ppm by mass or less, 1250 ppm by mass or less, 1200 ppm by mass or less, 1150 ppm by mass or less, 1100 ppm by mass or less, 1050 ppm by mass or less, 1000 ppm by mass or less, 900 ppm by mass or less, 800 ppm by mass or less, 700 ppm by mass or less, 600 ppm by mass or less, or 500 ppm by mass or less.

Phosphoric acid may be contained in the raw material of the beer-taste beverage, may be produced during fermentation based on the substrate contained in the raw material, or may be separately added in the production process (for example, purified phosphoric acid).

The adjustment of the phosphoric acid content can be performed by appropriately setting, for example, the addition of diluent water or carbonated water and the addition amount thereof when added, the addition of purified phosphoric acid, the type of phosphoric acid-containing raw materials (such as cereal grain, malt, corn grits, sugar solution, yeast extract, soybean, or pea), the type of raw materials serving as the origin of phosphoric acid (such as cereal grain, malt, corn grits, sugar solution, yeast extract, soybeans, or peas), the amount of the raw materials, the amount of time for enzyme reaction in the mashing step (wort production step from charging raw materials such as malt to before yeast addition), the pH in the mashing step, the addition amount of the acid used in the pH adjustment, the timing for the pH adjustment (for example, during mashing, during fermentation, at the time when fermentation is completed, prior to beverage filtration, and after beverage filtration), the setting temperature and the retention time in each temperature region during wort preparation (including during saccharification), the original extract concentration in the pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, fermentation temperature, the amount of time for fermentation, pressure setting, and carbon dioxide concentration), and the addition of spirits or brewed alcohol.

The phosphoric acid content can be measured by a known method using high performance liquid chromatography (HPLC).

In the beer-taste beverage according to an aspect of the present invention, the acetic acid content may be 10 ppm by mass or more, 50 ppm by mass or more, 100 ppm by mass or more, 150 ppm by mass or more, 200 ppm by mass or more, 210 ppm by mass or more, 220 ppm by mass or more, 230 ppm by mass or more, 240 ppm by mass or more, 250 ppm by mass or more, 260 ppm by mass or more, 270 ppm by mass or more, 280 ppm by mass or more, 290 ppm by mass or more, 300 ppm by mass or more, 310 ppm by mass or more, 320 ppm by mass or more, 325 ppm by mass or more, 330 ppm by mass or more, 340 ppm by mass or more, 350 ppm by mass or more, 360 ppm by mass or more, 370 ppm by mass or more, 380 ppm by mass or more, 390 ppm by mass or more, 400 ppm by mass or more, 450 ppm by mass or more, or 500 ppm by mass or more, from the viewpoint of improving the clean taste.

On the other hand, from the viewpoint of producing a beer-taste beverage that is not too sour, the acetic acid content may be 1000 ppm by mass or less, 900 ppm by mass or less, 800 ppm by mass or less, 700 ppm by mass or less, 600 ppm by mass or less, 550 ppm by mass or less, 500 ppm by mass or less, 450 ppm by mass or less, 400 ppm by mass or less, 390 ppm by mass or less, 380 ppm by mass or less, 370 ppm by mass or less, 360 ppm by mass or less, 350 ppm by mass or less, 340 ppm by mass or less, 330 ppm by mass or less, 320 ppm by mass or less, 310 ppm by mass or less, or 300 ppm by mass or less.

Acetic acid may be contained in the raw material of the beer-taste beverage, may be produced during fermentation based on the substrate contained in the raw material, or may be separately added in the production process (for example, purified acetic acid).

The adjustment of the acetic acid content can be performed by appropriately setting, for example, the addition of diluent water or carbonated water and the addition amount thereof when added, the addition of purified acetic acid, the type of acetic acid-containing raw materials (such as cereal grain, malt, corn grits, sugar solution, yeast extract, soybeans, or peas), the type of raw materials serving as the origin of acetic acid (such as cereal grain, malt, corn grits, sugar solution, yeast extract, soybean, or pea), the amount of the raw materials, the amount of time for enzyme reaction in the mashing step (wort production step from charging raw materials such as malt to before yeast addition), the pH in the mashing step, the addition amount of the acid used in the pH adjustment, the timing for the pH adjustment (for example, during mashing, during fermentation, at the time when fermentation is completed, prior to beverage filtration, and after beverage filtration), the setting temperature and the retention time in each temperature region during wort preparation (including during saccharification), the original extract concentration in the pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, fermentation temperature, the amount of time for fermentation, pressure setting, and carbon dioxide concentration), and the addition of spirits or brewed alcohol.

Furthermore, the acetic acid content can be measured by a known method using high performance liquid chromatography (HPLC).

In the beer-taste beverage according to an aspect of the present invention, the ratio (isoamyl alcohol/alcohol strength) between the alcohol strength (unit: (v/v) %) and the isoamyl alcohol content (unit: ppm by mass) is preferably 10.0 or more, 11.0 or more, 12.0 or more, 13.0 or more, 14.0 or more, 15.0 or more, 16.0 or more, 17.0 or more, 18.0 or more, 19.0 or more, 20.0 or more, 25.0 or more, 30.0 or more, 40.0 or more, or 50.0 or more by mass ratio, from the viewpoint of improving the rich aroma and producing a beer-taste beverage in which excessive sensation of irritation from alcohol is unlikely to be felt.

The upper limit value of the ratio is not particularly limited, but the upper limit value may be, for example, 100 or less, 90.0 or less, 80.0 or less, 70.0 or less, 60.0 or less, 50.0 or less, 40.0 or less, 30.0 or less, 25.0 or less, or 20.0 or less.

The pH of the beer-taste beverage according to an aspect of the present invention is preferably 2.00 or more, 2.20 or more, 2.40 or more, 2.60 or more, 2.80 or more, 3.00 or more, 3.10 or more, 3.20 or more, 3.30 or more, 3.40 or more, 3.50 or more, 3.60 or more, 3.70 or more, 3.80 or more, 3.90 or more, or 4.00 or more, and is preferably 5.40 or less, 5.20 or less, 5.00 or less, 4.95 or less, 4.90 or less, 4.85 or less, 4.80 or less, 4.75 or less, 4.70 or less, 4.65 or less, 4.60 or less, 4.55 or less, 4.50 or less, 4.45 or less, 4.40 or less, 4.35 or less, or 4.30 or less, and can also be 4.00 or less, or less than 4.00, from the viewpoint of improving the flavor.

The adjustment of the pH can be performed by appropriately setting, for example, the addition of diluent water or carbonated water and the addition amount thereof when added, the type of the raw materials (such as cereal grain, malt, corn grits, and sugar solution), the amounts of the raw materials, the type of enzyme, the addition amount of the enzyme, the timing for enzyme addition, the amount of time for saccharification in a mashing tank, the amount of time for proteolysis in the mashing tank, the pH in the mashing tank, the pH in the mashing step (wort production step from charging malt to before yeast addition), the type of the acid (such as lactic acid, phosphoric acid, malic acid, tartaric acid, or citric acid) used in pH adjustment, the addition amount of the acid used in pH adjustment, the timing for the pH adjustment (for example, during mashing, during fermentation, at the time when fermentation is completed, prior to beverage filtration, and after beverage filtration), the setting temperature and the retention time in each temperature region during wort preparation (including during saccharification), the original extract concentration in a pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, fermentation temperature, the amount of time for fermentation, pressure setting, and carbon dioxide concentration), the timing for cooling, the cooling temperature, and the amount of time for cooling.

The beer-taste beverage of an aspect of the present invention is suitable for an aspect of packaging in a container. Examples of the container include bottles, plastic bottles, cans (including bottle cans) or barrels. Examples of the container of a preferred aspect include a reclosable container. Specific examples thereof include reclosable bottles, reclosable plastic bottles, and reclosable cans (e.g., reclosable bottle cans).

### B1.1 Raw Material

In the beer-taste beverage according to an aspect of the present invention, grain is used as a raw material. Examples of the grain used as the raw material include cereal grain, rice (such as white rice and brown rice), corn, kaoliang, potato, legumes (such as soybeans and peas), buckwheat, sorghum, foxtail millet, and Japanese millet.

In the beer-taste beverage according to an aspect of the present invention, cereal grain (including ungerminated cereal grain, malt, and the like) is used as a raw material. The cereal grain used as the raw material refers to cereal grains such as barley, wheat, rye, wild oats, oats, adlay, and common oats, and there is no limitation on the production area and the variety. In the case of producing the beer-taste beverage using malt, malt obtained by germinating and drying the seeds of these cereal grains and removing the roots can be used. In the case of producing the beer-taste beverage substantially free of malt, cereal grain extract obtained by extracting these cereal grains can be used.

In an aspect of the present invention, it is preferable to use barley (including extract from barley such as barley extract) or barley malt. Barley is one of the most commonly used cereal grains as a raw material for Japanese beer-taste beverages. Examples of the barley include two-rowed barley and six-rowed barley, and any of them may be used. The cereal grain or malt (including cereal grain extract and malt extract) may be used alone or in combination of two or more thereof. When colored malt is used, different types of colored malts may be appropriately used in combination, or one colored malt may be used.

The beer-taste beverage according to an aspect of the present invention may be a beverage using hops as a raw material, or may be a beverage not using hops. In addition, a sweetener, a water-soluble dietary fiber, a bittering agent or a bitterness imparting agent, an antioxidant, a flavoring agent, an acidulant, salts may be used.

The malt proportion (proportion of all malt used) of the beer-taste beverage according to an aspect of the present invention may be preferably more than 30 mass %, 35 mass % or more, 40 mass % or more, 45 mass % or more, 50 mass % or more, 51 mass % or more, 52 mass % or more, 54 mass % or more, 55 mass % or more, 56 mass % or more, 57 mass % or more, 58 mass % or more, 59 mass % or more, 60 mass % or more, 61 mass % or more, 62 mass % or more, 63 mass % or more, 64 mass % or more, 65 mass % or more, 66 mass % or more, more than 66 mass %, 66.6 mass % or more, 67 mass % or more, 68 mass % or more, 69 mass % or more, 70 mass % or more, 71 mass % or more, 72 mass % or more, 73 mass % or more, 74 mass % or more, 75 mass % or more, 76 mass % or more, 77 mass % or more, 78 mass % or more, 79 mass % or more, 80 mass % or more, 81 mass % or more, 82 mass % or more, 83 mass % or more, 84 mass % or more, 85 mass % or more, 86 mass % of more, 87 mass % or more, 88 mass % or more, 89 mass % or more, 90 mass % or more, 91 mass % or more, 92 mass % or more, 93 mass % or more, 94 mass % or more, 95 mass % or more, 96 mass % or more, 97 mass % or more, 98 mass % or more, 99 mass % or more, or 100 mass %. By improving the malt proportion, the beer-taste beverage in which a rich taste derived from malt and umami of cereal grain can be more strongly felt can be produced.

On the other hand, the malt proportion of the beer-taste beverage according to an aspect according to the present invention may be less than 100 mass %, 99 mass % or less, 98 mass % or less, 97 mass % or less, 96 mass % or less, 95 mass % or less, 94 mass % or less, 93 mass % or less, 92 mass % or less, 91 mass % or less, 90 mass % or less, 89 mass % or less, 88 mass % or less, 87 mass % or less, 86 mass % or less, 85 mass % or less, 84 mass % or less, 83 mass % or less, 82 mass % or less, 81 mass % or less, 80 mass % or less, 79 mass % or less, 78 mass % or less, 77 mass % or less, 76 mass % or less, 75 mass % or less, 74 mass % or less, 73 mass % or less, 72 mass % or less, 71 mass % or less, 70 mass % or less, 69 mass % or less, 68 mass % or less, 67 mass % or less, less than 67 mass %, 66.6 mass % or less, 66 mass % or less, 65 mass % or less, 64 mass % or less, 63 mass % or less, 62 mass % or less, 61 mass % or less, 60 mass % or less, 59 mass % or less, 58 mass % or less, 57 mass % or less, 56 mass % or less, 55 mass % or less, 54 mass % or less, 53 mass % or less, 52 mass % or less, 51 mass % or less, 50 mass % or less, or less than 50 mass % from the viewpoint of producing a beer-taste beverage less likely to impart an unsuitable sensation of satiety.

As used herein, the term “malt proportion” refers to a value calculated according to the Interpretation Notice on the Liquor Tax Law and the Administrative Ordinance Related to Alcoholic Beverages and the like enforced on Apr. 1, 2018.

When suppressing the malt proportion, it is preferable to increase the amount of a raw material assimilable by yeast (a carbon source and a nitrogen source) other than malt. Examples of the carbon source as the raw material assimilable by yeast include monosaccharides, disaccharides, trisaccharides, and sugar solutions thereof, examples of the nitrogen source as the raw materials assimilable by yeast include yeast extract, soybean protein, malt, soybeans, yeast extract, peas, wheat malt, ungerminated grains, and decomposition products thereof. Examples of the ungerminated grains include ungerminated barley, ungerminated wheat, ungerminated rye, ungerminated wild oats, ungerminated oats, ungerminated adlay, ungerminated common oats, ungerminated rice (such as white rice and brown rice), ungerminated corn, ungerminated kaoliang, ungerminated potato, ungerminated legumes (such as soybeans and peas), ungerminated buckwheat, ungerminated sorghum, ungerminated foxtail millet, and ungerminated Japanese millet. In addition, starch obtained from these grains and extract thereof (extract) may be used.

Examples of the form of the hops used in one aspect of the present invention include pellet hops, powdered hops, and hops extract. The hops used may be a processed hop product, such as isomerized hops or reduced hops.

The addition amount of the hops is appropriately adjusted, and is preferably from 0.0001 to 1 mass % with respect to the total amount of the beverage. In addition, the beer-taste beverage using hops as the raw material is a beverage containing iso-α-acid, which is a component derived from hops.

Examples of the sweetener include commercially available saccharified liquid obtained by decomposing grain-derived starch with an acid, an enzyme or the like, saccharides such as sucrose and commercially available starch syrup, natural sweeteners such as saccharides that contains 3 or more monosaccharide units, sugar alcohols, isomerized sugars and stevia, and artificial sweeteners.

These saccharides may be in the form of a liquid, such as a solution, or a solid, such as a powder.

In addition, there are no particular limitations on the type of grains serving as raw materials for starch, a method for purifying starch, and the process conditions such as hydrolysis with an enzyme or an acid. For example, a saccharide having an increased proportion of maltose may be used, by appropriately setting the conditions for the hydrolysis with an enzyme or an acid. In addition, there can also be used sucrose, fructose, glucose, mannose, arabinose, galactose, xylose, rhamnose, ribose, fucose, lactose, maltose, trehalose, maltotriose, maltotetraose, maltopentaose, isomaltose, isomaltotriose, isomaltotetraose, isomaltopentaose, lactosucrose, 4′-galactosyllactose, 1-kestose, nystose, fructofuranosylnystose, raffinose, stachyose, xylobiose, xylotriose, panose, and solutions (sugar solutions) thereof. Examples of the artificial sweeteners include aspartame, acesulfame potassium (acesulfame K), sucralose, and neotame. These sweeteners may be used alone, or in combination of two or more. As a raw material other than malt, a sugar assimilable by yeast (assimilable sugar) can be further added to increase the alcohol strength.

Examples of the water-soluble dietary fiber include indigestible dextrin, polydextrose, a guar gum decomposition product, pectin, glucomannan, alginic acid, laminarin, fucoidan and carrageenan, and indigestible dextrin or polydextrose is preferable from a point of view of versatility such as stability and safety.

These water-soluble dietary fibers may be used alone, or in combination of two or more.

In the beer-taste beverage, the bitterness is preferably imparted by hops or the like, but the bittering agent or the bitterness imparting agent may be further used.

The bittering agent or the bitterness imparting agent is not particularly limited, and there can be used either of those used as a bitterness imparting agent in normal beers or low-malt beers, and examples thereof include rosemary, lychee, amur cork tree, caraway, juniper berry, sage, salvia rosmarimis, lingzhi mushroom, laurel, lingzhi mushroom, quassin, citrus extract, picrasma wood extract, coffee extract, tea extract, bitter melon extract, lotus embryo extract, candelabra aloe extract, rosemary extract, lychee extract, laurel extract, sage extract, caraway extract, wormwood extract, absinthin, alginic acid, and gallic acid.

These bittering agents and bitterness imparting agents may be used alone, or two or more thereof may be used in combination.

The antioxidant is not particularly limited, and there can be used a substance used as an antioxidant in normal beers or low-malt beers, and examples thereof include ascorbic acid, erythorbic acid, and catechin. One of these antioxidants may be used alone, or two or more thereof may be used in combination.

The flavoring agent is not particularly limited, and a typical beer flavoring agent can be used. The beer flavoring agent is used for imparting a beer-like flavor, and contains a brewing component produced by fermentation. Thus, when the production process of the beer-taste beverage involves alcoholic fermentation, it is not necessary to separately add the beer flavoring agent, but the beer flavoring agent may be added as desired.

Examples of the beer flavoring agent include esters and higher alcohols, and specific examples thereof include isoamyl acetate, ethyl acetate, n-propanol (such as 1-propanol), isobutanol, acetaldehyde, ethyl caproate, ethyl caprylate, isoamyl propionate, linalool, geraniol, citral, 4-vinylguaiacol (4-VG), 4-methyl-3-pentenoic acid, 2-methyl-2-pentenoic acid, 1,4-cineole, 1,8-cineole, 2,3-diethyl-5-methylpyrazine, γ-decanolactone, γ-undecalactone, ethyl hexanoate, ethyl 2-methylbutyrate, ethyl n-butyrate, myrcene, citral, limonene, ethyl maltol, phenylacetic acid, furaneol, furfural, methional, 3-methyl-2-butene-1-thiol, 3-methyl-2-butanethiol, diacetyl, ferulic acid, geranic acid, geranyl acetate, ethyl butyrate, octanoic acid, decanoic acid, 9-decenoic acid, nonanoic acid, tetradecanoic acid, propanoic acid, 2-methylpropanoic acid, γ-butyrolactone, 2-aminoacetophenone, ethyl 3-phenylpropionate, 2-ethyl-4-hydroxy-5-methyl-3 (2H)-furanone, dimethylsulfone, 3-methylcyclopentane-1,2-dione, 2-methylbutanal, 3-methylbutanal, 2-methyltetrahydrofuran-3-one, 2-acetylfuran, 2-methyltetrahydrofuran-3-one, hexanal, hexanol, cis-3-hexenal, 1-octene-3-ol, β-eudesmol, 4-mercapto-4-methylpentane-2-one, β-caryophyllene, β-myrcene, furfuryl alcohol, 2-ethylpyrazine, 2,3-dimethylpyrazine, 2-methylbutyl acetate, isoamyl alcohol, 5-hydroxymethylfurfural, phenylacetaldehyde, 1-phenyl-3-butene-1-one, trans-2-hexenal, nonanal, phenethyl alcohol, nerol, citronellol, methyl p-toluate, 1,2,3,5-tetramethylbenzene, triethyl citrate, tributyl citrate, diethyl tartrate, dibutyl malate, perillaldehyde, methylheptenone, lemon myrtle, and cinnamaldehyde.

One of these beer flavoring agents may be used alone, or two or more thereof may be used in combination.

The acidulant is not particularly limited as long as it is a substance having sourness, but in addition to succinic acid, citric acid, phosphoric acid, and acetic acid described above, for example, gluconic acid, tartaric acid, lactic acid, malic acid, phytic acid, glucono-delta-lactone, or salts thereof can be used.

Among these acidulants, gluconic acid, tartaric acid, lactic acid, malic acid, phytic acid, or salts thereof are preferable, malic acid, lactic acid, tartaric acid, or salts thereof are more preferable, and malic acid, lactic acid, or salts thereof are particularly preferable.

One of these acidulants may be used alone, or two or more of these acidulants may be used in combination. Note that, the acidulant is not limited to an acidulant approved as food additives, and there may be used an acidulant derived from a raw material such as malt, an acidulant produced by adjustments of various process conditions, an acidulant produced by yeast, and an acidulant to be externally added as an additive, for example.

The content of the acidulant in the beer-taste beverage according to an aspect of the present invention is preferably from 500 to 10000 ppm by mass, more preferably from 1000 to 9000 ppm by mass, still more preferably from 2000 to 8000 ppm by mass.

Examples of the preservative include: benzoic acid; benzoic acid salts such as sodium benzoate; benzoic acid esters such as propyl parahydroxybenzoate and butyl parahydroxybenzoate; and dimethyl dicarbonate. Also, as the preservative, a commercially available preparation, such as Kyohryoku Sanpurezah (Powerful Sanplezer) (a mixture of sodium benzoate and butyl benzoate, available from San-Ei Gen F.F.I., Inc.) may be used. One of these preservatives may be used alone, or two or more of these preservatives may be used in combination.

The blending amount of the preservative in the beer-taste beverage according to an aspect of the present invention is preferably from 5 to 1200 ppm by mass, more preferably from 10 to 1100 ppm by mass, still more preferably from 15 to 1000 ppm by mass, and even more preferably from 20 to 900 ppm by mass.

Examples of the salts include sodium chloride, potassium acid phosphate, calcium acid phosphate, ammonium phosphate, magnesium sulfate, calcium sulfate, potassium metabisulfite, calcium chloride, magnesium chloride, potassium nitrate, ammonium sulfate, potassium chloride, monosodium citrate, disodium citrate, and trisodium citrate.

One of these salts may be used alone, or two or more of these salts may be used in combination.

### B1.2 Carbon Dioxide Gas

The beer-taste beverage according to an aspect of the present invention may contain, dissolved carbon dioxide gas, or may not contain dissolved carbon dioxide gas.

As the carbon dioxide gas contained in the beer-taste beverage, the carbon dioxide gas contained in the raw material may be used, or carbon dioxide gas may be dissolved, for example, by mixing carbonated water or by addition of carbon dioxide gas.

The beer-taste beverage according to one aspect of the present invention is produced through the alcoholic fermentation, and hence the carbon dioxide gas generated in this fermentation step can be used directly, but the amount of carbon dioxide gas may be prepared by appropriately adding carbonated water.

When the beer-taste beverage according to an aspect of the present invention contains dissolved carbon dioxide gas, the carbon dioxide gas concentration is preferably 0.30 (w/w) % or more, 0.35 (w/w) % or more, 0.40 (w/w) % or more, 0.42 (w/w) % or more, 0.45 (w/w) % or more, 0.47 (w/w) % or more, 0.50 (w/w) % or more, or 0.52 (w/w) % or more, and the carbon dioxide gas concentration may be 0.80 (w/w) % or less, 0.70 (w/w) % or less, 0.60 (w/w) % or less, 0.57 (w/w) or less, 0.55 (w/w) % or less, 0.54 (w/w) % or less, 0.53 (w/w) % or less, 0.52 (w/w) % or less, 0.51 (w/w) % or less, or 0.50 (w/w) % or less.

When the beer-taste beverage according to an aspect of the present invention is a packaged beverage, the carbon dioxide gas pressure of the packaged beverage may be appropriately adjusted such that the carbon dioxide gas concentration is in the range described above, and the carbon dioxide gas pressure is 5.0 kg/cm² or less, 4.5 kg/cm² or less, or 4.0 kg/cm² or less, and 0.20 kg/cm² or more, 0.50 kg/cm² or more, or 1.0 kg/cm² or more. Any of these upper and lower limits may be combined. For example, the carbon dioxide gas pressure may be 0.20 kg/cm² or more and 5.0 kg/cm² or less, 0.50 kg/cm² or more and 4.5 kg/cm² or less, or 1.0 kg/cm² or more and 4.0 kg/cm² or less.

In the present specification, the gas pressure refers to gas pressure in the container except in special cases.

The pressure can be measured by a method well-known to those skilled in the art, for example, using a method in which a sample adjusted to 20 °C is fixed to a gas internal pressure gauge, the stopcock of the gas internal pressure gauge is opened once to release the gas, the stopcock is closed again, the gas internal pressure gauge is shaken, and a value when the pointer reaches a certain position is read; or using a commercially available gas pressure measuring instrument.

### B1.3 Other Additives

In the beer-taste beverage according to an aspect of the present invention, various additives may be added as necessary to the extent that the effects of the present invention are not compromised.

Examples of such additives include a coloring agent, a foaming agent, a fermentation accelerator, yeast extract, a protein-based substance such as a peptide-containing substance, and a seasoning such as an amino acid.

The coloring agent is used to impart beer-like color to the beverage, and for example, a caramel dye can be used. The foaming agent is used to form beer-like foam in the beverage or to retain the foam in the beverage, and there can be appropriately used, for example, a saponin-based substance extracted from a plant, such as soybean saponin or quillaja saponin; a plant protein such as a protein from corn or soybean; and a peptide-containing substance such as a collagen peptide; yeast extract; and an ingredient derived from milk.

The fermentation accelerator is used for promoting fermentation by yeast, and examples thereof include yeast extract, a bran component from, for example, rice or cereal grain, a vitamin, and a mineral agent. A single type of the fermentation accelerator can be used alone or two or more types of the fermentation accelerators may be used in combination.

### <<Aspect C: Corresponding to JP 2023-100227>>

### C1. Beer-Taste Beverage

As used herein, the term “beer-taste beverage” refers to an alcohol-containing carbonated beverage with a beer-like flavor. That is, unless otherwise specified, the beer-taste beverage as used herein encompasses any carbonated beverage with a flavor of beer.

Therefore, the “beer-taste beverage” includes not only beer, which is a malt-fermented beverage obtained by fermenting malt, hops, and water as raw materials with yeast, and fermented beer-taste beverages, but also a carbonated beverage to which a beer flavoring agent including, for example, esters, higher alcohols, and lactones has been added, and other low-malt beer and effervescent liqueurs classified under the names defined in Japanese Liquor Tax Law.

In addition, the beer-taste beverage according to an aspect of the present invention may be a fermented beer-taste beverage that has undergone a fermentation step using yeast or may be a non-fermented beer-taste beverage that has not undergone the fermentation step.

The fermented beer-taste beverage may be an ale beer-taste beverage brewed through the fermentation step using top-fermenting yeast (e.g., Saccharomyces), a lager beer-taste beverage brewed through the fermentation step using bottom-fermenting yeast (e.g., Saccharomyces), or a pilsner beer-taste beverage, or may be a beer-taste beverage produced by blending these beer-taste beverages. The term “fermentation” as used herein may be alcoholic fermentation that produces alcohol, or may be non-alcoholic fermentation that does not produce alcohol.

In addition, the beer-taste beverage according to an aspect of the present invention may be a malt-containing beer-taste beverage using malt (such as barley malt and wheat malt) as a raw material, or may be a malt-free beer-taste beverage without using malt. Examples of the malt-containing beer-taste beverage include barley malt-containing beer-taste beverages.

In addition, the beer-taste beverage according to an aspect of the present invention may be a cereal grain-containing beer-taste beverage using cereal grain (such as barley and wheat) as a raw material, or may be a cereal grain-free beer-taste beverage without using cereal grain. Examples of the cereal grain-containing beer-taste beverage include barley-containing beer-taste beverages.

The beer-taste beverage according to an aspect of the present invention is a beer-taste beverage having an alcohol strength of 10.0 (v/v) % or more, an ethyl acetate content of 50 ppm by mass or more, and an isoamyl acetate content of 3 ppm by mass or more.

In addition, a beer-taste beverage according to another aspect of the present invention is a beer-taste beverage having an alcohol strength of 12.0 (v/v) % or more and an ethyl acetate content of 50 ppm by mass or more.

When a beer-taste beverage was designed to have a high alcohol strength, a sensation of irritation from alcohol was increased, and the beer-taste beverage tended to have low drinkability. As a result of repeated studies conducted by the inventors of the present invention on such a problem, it has been found that even when the alcohol strength is designed to be as high as 10.0 (v/v) % or more or 12.0 (v/v) % or more, a rich aroma can be firmly felt by adjusting an ethyl acetate content and/or an isoamyl acetate content to a predetermined range, and as a result, excessive sensation of irritation caused by the high alcohol strength is less likely to be felt.

The alcohol strength (ethanol content) (v/v) % of the beer-taste beverage according to an aspect of the present invention is 8.0 (v/v) % or more from the viewpoint of producing a beer-taste beverage having moderate sensation of irritation, and the alcohol strength may be 8.5 (v/v) % or more, 9.0 (v/v) % or more, 9.5 (v/v) % or more, 10.0 (v/v) % or more, 10.5 (v/v) % or more, 11.0 (v/v) % or more, 11.5 (v/v) % or more, 12.0 (v/v) % or more, 12.5 (v/v) % or more, 13.0 (v/v) % or more, 13.5 (v/v) % or more, 14.0 (v/v) % or more, 14.5 (v/v) % or more, 15.0 (v/v) % or more, 15.5 (v/v) % or more, 16.0 (v/v) % or more, 16.5 (v/v) % or more, 17.0 (v/v) % or more, 17.5 (v/v) % or more, 18.0 (v/v) % or more, 18.5 (v/v) % or more, 19.0 (v/v) % or more, 19.5 (v/v) % or more, 20.0 (v/v) % or more, 20.5 (v/v) % or more, 21.0 (v/v) % or more, 21.5 (v/v) % or more, 22.0 (v/v) % or more, 22.5 (v/v) % or more, 23.0 (v/v) % or more, 23.5 (v/v) % or more, 24.0 (v/v) % of more, 24.5 (v/v) % or more, or 25.0 (v/v) % or more.

On the other hand, from the viewpoint of producing a beer-taste beverage with less excessive sensation of irritation, the alcohol strength may be 50.0 (v/v) % or less, 45.0 (v/v) % or less, 40.0 (v/v) % or less, 35.0 (v/v) % or less, 30.0 (v/v) % or less, 25.0 (v/v) % or less, 24.5 (v/v) % or less, 24.0 (v/v) % or less, 23.5 (v/v) % or less, 23.0 (v/v) % or less, 22.5 (v/v) % or less, 22.0 (v/v) % or less, 21.5 (v/v) % or less, 21.0 (v/v) % or less, 20.5 (v/v) % or less, or 20.0 (v/v) % or less.

Note that, as used herein, the alcohol strength is indicated as a percentage based on volume/volume ((v/v) %). The alcohol content of the beverage can be measured by any known method, and for example, can be measured according to “8.3 Alcohol” in “Revised BCOJ Beer Analysis Method, revised and enlarged in 2013 (edited by Brewery Convention of Japan, Brewers Association of Japan (Analysis Committee), published by Public Interest Incorporated Foundation, The Brewing Society of Japan).

The adjustment of the alcohol strength can be performed by appropriately setting, for example, the addition of diluent water or carbonated water and the addition amount thereof when added, the type of raw materials (such as cereal grain, malt, corn grits, and sugar solution), the amount of the raw materials, the type of enzyme, the addition amount of the enzyme, the timing for enzyme addition, the amount of time for saccharification in a mashing tank, the amount of time for proteolysis in the mashing tank, the pH in the mashing tank, the pH in a mashing step (wort production step from malt addition to before yeast addition), the addition amount of an acid to be used during the pH adjustment, the timing for the pH adjustment (for example, during mashing, during fermentation, at the time when fermentation is completed, before beverage filtration, and after beverage filtration), the setting temperature and the retention time in each temperature region during wort preparation (including during saccharification), the original extract concentration in a pre-fermentation liquid, the original extract concentration in the fermentation step, fermentation conditions (such as oxygen concentration, aeration conditions, yeast species, the addition amount of yeast, the number of proliferated yeast cells, the timing for yeast removal, the fermentation temperature, the amount of time for fermentation, pressure setting, carbon dioxide concentration, the addition amount of enzyme, the type of enzyme, the timing for enzyme addition), the addition of ethanol, and the addition of ethanol composition (for example, alcohol for raw materials, spirits (distilled liquor) such as shochu, Awamori, whiskey, brandy, vodka, ram, tequila, and gin, and brewed alcohol).

The beer-taste beverage according to an aspect of the present invention may contain, or may not contain, as an alcohol component, spirits (distilled liquor) derived from grains such that the alcohol strength is adjusted to be within the range described above. The beer-taste beverage according to an aspect of the present invention is preferably a beverage containing no spirits from the viewpoint of producing a beer-like, beer-taste beverage having a high-quality taste. That is, it is preferable that the beer-taste beverage according to an aspect of the present invention contains no ethanol solution or ethanol-containing composition as a raw material.

In the beer-taste beverage according to an aspect of the present invention, the ethyl acetate content is 1 ppm by mass or more, 5 ppm by mass or more, 10 ppm by mass or more, 11 ppm by mass or more, 12 ppm by mass or more, 13 ppm by mass or more, 14 ppm by mass or more, 15 ppm by mass or more, 16 ppm by mass or more, 17 ppm by mass or more, 18 ppm by mass or more, 19 ppm by mass or more, 20 ppm by mass or more, 21 ppm by mass or more, 22 ppm by mass or more, 23 ppm by mass or more, 24 ppm by mass or more, 25 ppm by mass or more, 26 ppm by mass or more, 27 ppm by mass or more, 28 ppm by mass or more, 29 ppm by mass or more, 30 ppm by mass or more, 35 ppm by mass or more, 40 ppm by mass or more, 45 ppm by mass or more, 50 ppm by mass or more, 55 ppm by mass or more, 60 ppm by mass or more, 65 ppm by mass or more, 70 ppm by mass or more, 75 ppm by mass or more, 80 ppm by mass or more, 85 ppm by mass or more, 90 ppm by mass or more, 95 ppm by mass or more, or 100 ppm by mass or more, from the viewpoint of improving the rich aroma of the beer-taste beverage.

On the other hand, the ethyl acetate content may be 200 ppm by mass or less, 195 ppm by mass or less, 190 ppm by mass or less, 185 ppm by mass or less, 180 ppm by mass or less, 175 ppm by mass or less, 170 ppm by mass or less, 165 ppm by mass or less, 160 ppm by mass of less, 155 ppm by mass or less, 150 ppm by mass or less, 145 ppm by mass or less, 140 ppm by mass or less, 135 ppm by mass or less, 130 ppm by mass or less, 125 ppm by mass or less, 120 ppm by mass or less, 115 ppm by mass or less, 110 ppm by mass or less, 105 ppm by mass or less, 100 ppm by mass or less, 95 ppm by mass or less, 90 ppm by mass or less, 85 ppm by mass or less, 80 ppm by mass or less, 75 ppm by mass or less, 70 ppm by mass or less, or 65 ppm by mass or less, from the viewpoint of suppressing prominence of an odor unsuitable for richness.

Ethyl acetate may be contained in the raw material of the beer-taste beverage, may be produced during fermentation based on the substrate contained in the raw material, or may be separately added in the production process (for example, purified ethyl acetate).

The adjustment of the ethyl acetate content can be performed by appropriately setting, for example, the addition of diluent water or carbonated water and the addition amount thereof when added, the addition of purified ethyl acetate, the type of ethyl acetate-containing raw materials (such as cereal grain, malt, corn grits, sugar solution, yeast extract, soybean, or pea), the type of raw materials serving as the origin of ethyl acetate (such as cereal grain, malt, corn grits, sugar solution, yeast extract, soybean, or pea), the amount of the raw materials, the amount of time for enzyme reaction in the mashing step (wort production step from charging raw materials such as malt to before yeast addition), the pH in the mashing step, the addition amount of an acid used in the pH adjustment, the timing for the pH adjustment (for example, during mashing, during fermentation, at the time when fermentation is completed, prior to beverage filtration, and after beverage filtration), the setting temperature and the retention time in each temperature region during wort preparation (including during saccharification), the original extract concentration in a pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, fermentation temperature, the amount of time for fermentation, pressure setting, and carbon dioxide concentration), and the addition of spirits or brewed alcohol.

The ethyl acetate content can be measured by a known method using an apparatus such as GC-MS.

In the beer-taste beverage according to an aspect of the present invention, the isoamyl acetate content is 0.1 ppm by mass or more, 0.5 ppm by mass or more, 1.0 ppm by mass or more, 1.1 ppm by mass or more, 1.2 ppm by mass or more, 1.3 ppm by mass or more, 1.4 ppm by mass or more, 1.5 ppm by mass or more, 1.6 ppm by mass or more, 1.7 ppm by mass or more, 1.8 ppm by mass or more, 1.9 ppm by mass or more, 2.0 ppm by mass or more, 2.1 ppm by mass or more, 2.2 ppm by mass or more, 2.3 ppm by mass or more, 2.4 ppm by mass or more, 2.5 ppm by mass or more, 2.6 ppm by mass or more, 2.7 ppm by mass or more, 2.8 ppm by mass or more, 2.9 ppm by mass or more, 3.0 ppm by mass or more, 3.5 ppm by mass or more, 4.0 ppm by mass or more, 4.5 ppm by mass or more, 5.0 ppm by mass or more, 5.5 ppm by mass or more, 6.0 ppm by mass or more, 6.5 ppm by mass or more, 7.0 ppm by mass or more, 7.5 ppm by mass or more, 8.0 ppm by mass or more, 8.5 ppm by mass or more, 9.0 ppm by mass or more, 9.5 ppm by mass or more, or 10 ppm by mass or more, from the viewpoint of improving the rich aroma of the beer-taste beverage.

On the other hand, the isoamyl acetate content may be 20 ppm by mass or less, 19 ppm by mass or less, 18 ppm by mass or less, 17 ppm by mass or less, 16 ppm by mass or less, 15 ppm by mass or less, 14.5 ppm by mass or less, 14 ppm by mass or less, 13.5 ppm by mass or less, 13 ppm by mass or less, 12.5 ppm by mass or less, 12 ppm by mass or less, 11.5 ppm by mass or less, 11 ppm by mass or less, 10.5 ppm by mass or less, 10 ppm by mass or less, 9.5 ppm by mass or less, 9.0 ppm by mass or less, 8.5 ppm by mass or less, 8.0 ppm by mass or less, 7.5 ppm by mass or less, 7.0 ppm by mass or less, 6.5 ppm by mass or less, or 6.0 ppm by mass or less, from the viewpoint of suppressing prominence of an odor unsuitable for richness.

Isoamyl acetate may be contained in the raw material of the beer-taste beverage, may be produced during fermentation based on the substrate contained in the raw material, or may be separately added in the production process (for example, purified isoamyl acetate).

The adjustment of the isoamyl acetate content can be performed by appropriately setting, for example, the addition of diluent water or carbonated water and the addition amount thereof when added, the addition of purified isoamyl acetate, the type of isoamyl acetate-containing raw materials (such as cereal grain, malt, corn grits, sugar solution, yeast extract, soybean, or pea), the type of raw materials serving as the origin of isoamyl acetate (such as cereal grain, malt, corn grits, sugar solution, yeast extract, soybean, or pea), the amount of the raw materials, the amount of time for enzyme reaction in the mashing step (wort production step from charging raw materials such as malt to before yeast addition), the pH in the mashing step, the addition amount of an acid used in the pH adjustment, the timing for the pH adjustment (for example, during mashing, during fermentation, at the time when fermentation is completed, prior to beverage filtration, after beverage filtration), the setting temperature and the retention time in each temperature region during wort preparation (including during saccharification), the original extract concentration in a pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, fermentation temperature, the amount of time for fermentation, pressure setting, and carbon dioxide concentration), and the addition of spirits or brewed alcohol. The isoamyl acetate content can be measured by a known method using an apparatus such as GC-MS.

In the beer-taste beverage according to an aspect of the present invention, the isoamyl alcohol content is 110 ppm by mass or more from the viewpoint of improving the rich aroma of the beer-taste beverage. The isoamyl alcohol content is also preferably 120 ppm by mass or more, 130 ppm by mass or more, 140 ppm by mass or more, 150 ppm by mass or more, 155 ppm by mass or more, 160 ppm by mass or more, 170 ppm by mass or more, 180 ppm by mass or more, 190 ppm by mass or more, 200 ppm by mass or more, 210 ppm by mass or more, 220 ppm by mass or more, 230 ppm by mass or more, 240 ppm by mass or more, 250 ppm by mass of more, 260 ppm by mass or more, 270 ppm by mass or more, 280 ppm by mass or more, 285 ppm by mass or more, 290 ppm by mass or more, 300 ppm by mass or more, 310 ppm by mass or more, 320 ppm by mass or more, 330 ppm by mass or more, 340 ppm by mass or more, 350 ppm by mass or more, 360 ppm by mass or more, 370 ppm by mass or more, 380 ppm by mass or more, 390 ppm by mass or more, 400 ppm by mass or more, 410 ppm by mass or more, 420 ppm by mass or more, 430 ppm by mass or more, 440 ppm by mass or more, 450 ppm by mass of more, 460 ppm by mass or more, 470 ppm by mass or more, 480 ppm by mass or more, 490 ppm by mass or more, or 500 ppm by mass or more.

On the other hand, the isoamyl alcohol content may be 1000 ppm by mass or less, 950 ppm by mass or less, 900 ppm by mass or less, 850 ppm by mass or less, 800 ppm by mass of less, 750 ppm by mass or less, 700 ppm by mass or less, 650 ppm by mass or less, 600 ppm by mass or less, 590 ppm by mass or less, 580 ppm by mass or less, 570 ppm by mass or less, 560 ppm by mass or less, 550 ppm by mass or less, 540 ppm by mass or less, 530 ppm by mass or less, 520 ppm by mass or less, 510 ppm by mass or less, 500 ppm by mass or less, 490 ppm by mass or less, 480 ppm by mass or less, 470 ppm by mass or less, 460 ppm by mass or less, 450 ppm by mass or less, 440 ppm by mass or less, 430 ppm by mass or less, 420 ppm by mass or less, 410 ppm by mass or less, 400 ppm by mass or less, 390 ppm by mass or less, 380 ppm by mass or less, 370 ppm by mass or less, 360 ppm by mass or less, 350 ppm by mass or less, 340 ppm by mass or less, 330 ppm by mass or less, 320 ppm by mass or less, 310 ppm by mass or less, or 300 ppm by mass or less, from the viewpoint of producing a beer-taste beverage having less excessive sensation of irritation from alcohol.

Isoamyl alcohol may be contained in the raw material of the beer-taste beverage, may be produced during fermentation based on a substrate contained in the raw material, or may be separately added in the production process (for example, purified isoamyl alcohol).

The adjustment of the isoamyl alcohol content can be performed by appropriately setting, for example, the addition of diluent water or carbonated water and the addition amount thereof when added, the addition of purified isoamyl alcohol, the type of isoamyl alcohol-containing raw materials (such as cereal grain, malt, corn grits, sugar solution, yeast extract, soybean, or pea), the type of raw materials serving as the origin of isoamyl alcohol (such as cereal grain, malt, corn grits, sugar solution, yeast extract, soybean, or pea), the amount of the raw materials, the amount of time for enzyme reaction in the mashing step (wort production step from charging raw materials such as malt to before yeast addition), the pH in the mashing step, the addition amount of an acid used in the pH adjustment, the timing for the pH adjustment (for example, during mashing, during fermentation, at the time when fermentation is completed, prior to beverage filtration, and after beverage filtration), the setting temperature and the retention time in each temperature region during wort preparation (including during saccharification), the original extract concentration in a pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, the fermentation temperature, the amount of time for fermentation, pressure setting, and carbon dioxide concentration), and the addition of spirits or brewed alcohol.

Furthermore, the content of isoamyl alcohol can be measured by headspace gas chromatography equipped with an FID detector in accordance with a method described in the item” 8.22 Low Boiling Point Aroma Components” of Revised BCOJ Beer Analysis Method (Enlarged and Revised Edition of 2013), which is an analysis method defined by Brewery Convention of Japan (BCOJ), Brewers Association of Japan.

In the beer-taste beverage according to an aspect of the present invention, the n-propanol content is preferably 10 ppm by mass or more, 20 ppm by mass or more, 30 ppm by mass or more, 40 ppm by mass or more, 50 ppm by mass or more, 55 ppm by mass or more, 60 ppm by mass or more, 65 ppm by mass or more, 70 ppm by mass or more, 75 ppm by mass or more, 80 ppm by mass or more, 85 ppm by mass or more, 90 ppm by mass or more, 95 ppm by mass of more, 100 ppm by mass or more, 110 ppm by mass or more, 120 ppm by mass or more, 130 ppm by mass or more, 140 ppm by mass or more, 150 ppm by mass or more, 160 ppm by mass or more, 170 ppm by mass or more, 180 ppm by mass or more, 190 ppm by mass or more, 200 ppm by mass or more, 250 ppm by mass or more, or 300 ppm by mass or more, from the viewpoint of improving the rich aroma of the beer-taste beverage.

On the other hand, the n-propanol content may be 500 ppm by mass or less, 450 ppm by mass or less, 400 ppm by mass or less, 390 ppm by mass or less, 380 ppm by mass or less, 370 ppm by mass or less, 360 ppm by mass or less, 350 ppm by mass or less, 340 ppm by mass or less, 330 ppm by mass or less, 320 ppm by mass or less, 310 ppm by mass or less, 300 ppm by mass or less, 290 ppm by mass or less, 280 ppm by mass or less, 270 ppm by mass or less, 260 ppm by mass or less, 250 ppm by mass or less, 240 ppm by mass or less, 230 ppm by mass or less, 220 ppm by mass or less, 210 ppm by mass or less, 200 ppm by mass or less, 190 ppm by mass or less, 180 ppm by mass or less, 170 ppm by mass or less, 160 ppm by mass or less, or 150 ppm by mass or less, from the viewpoint of producing a beer-taste beverage having less excessive sensation of irritation from alcohol.

n-propanol may be contained in the raw material of the beer-taste beverage, may be produced during fermentation based on the substrate contained in the raw material, or may be separately added in the production process (for example, purified n-propanol).

The adjustment of the n-propanol content can be performed by appropriately setting, for example, the addition of diluent water or carbonated water and the addition amount thereof when added, the addition of purified n-propanol, the type of n-propanol-containing raw material (such as cereal grain, malt, corn grits, sugar solution, yeast extract, soybean, or pea), the type of raw materials serving as the origin of n-propanol (such as cereal grain, malt, corn grits, sugar solution, yeast extract, soybean, or pea), the amount of the raw materials, the amount of time for enzyme reaction in the mashing step (wort production step from charging raw materials such as malt to before yeast addition), the pH in the mashing step, the addition amount of an acid used in the pH adjustment, the timing for the pH adjustment (for example, during mashing, during fermentation, at the time when fermentation is completed, prior to beverage filtration, and after beverage filtration), the setting temperature and the retention time in each temperature region during wort preparation (including during saccharification), the original extract concentration in a pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, the fermentation temperature, the amount of time for fermentation, pressure setting, and carbon dioxide concentration), and the addition of spirits or brewed alcohol

Furthermore, the n-propanol content can be measured by headspace gas chromatography equipped with an FID detector in accordance with a method described in the item “8.22 Low Boiling Point Aroma Components” of Revised BCOJ Beer Analysis Method (Enlarged and Revised Edition of 2013), which is an analysis method defined by Brewery Convention of Japan (BCOJ), Brewers Association of Japan.

The beer-taste beverage according to an aspect of the present invention may include a compound of Group X and a compound of Group Y as described below.

Group X: one or more selected from the group consisting of isoamyl alcohol, n-propanol, isobutanol, and phenethyl alcohol.

Group Y: one or more selected from the group consisting of ethyl acetate, isoamyl acetate, ethyl caproate, and ethyl octanoate.

The beer-taste beverage according to an aspect of the present invention is a beer-taste beverage satisfying Formula (1) shown below.

X/Y>3.00 :Formula (1)

[In Formula (1), X represents the total content (unit: ppm by mass) of the compound of Group X, and Y represents the total content (unit: ppm by mass) of the compound of Group Y.]

In the beer-taste beverage according to an aspect of the present invention, the ratio (X/Y) of the total content of the compound of Group X and the total content of the compound of Group Y in Formula (1) is preferably 3.10 or more, more than 3.11, 3.15 or more, 3.30 or more, 3.50 or more, 4.00 or more, 4.25 or more, 4.50 or more, 4.55 or more, 5.00 or more, 5.50 or more, 6.00 or more, 6.50 or more, 7.00 or more, more than 7.30, 7.50 or more, 8.00 or more, 8.50 or more, 9.00 or more, 9.50 or more, 10.0 or more, 11.0 or more, 12.0 or more, 13.0 or more, 13.5 or more, 14.0 or more, 15.0 or more, 16.0 or more, 17.0 or more, 17.5 or more, 18.0 or more, 19.0 or more, 20.0 or more, 21.0 or more, 22.0 or more 23.0 or more, 24.0 or more, 25.0 or more, 26.0 or more, 27.0 or more, 28.0 or more, 29.0 or more, or 30.0 or more by mass ratio, from the viewpoint of improving the rich aroma of the beer-taste beverage.

Furthermore, the upper limit value of the ratio (X/Y) of the total content of the compound of Group X and the total content of the compound of Group Y in Formula (1) is not particularly limited, but the upper limit value may be, for example, 30.0 or less, 28.0 or less, 26.0 or less, 24.0 or less, 22.0 or less, 20.0 or less, 19.0 or less, 18.0 or less, 17.0 or less, 16.0 or less, 15.0 or less, 14.0 or less, 13.0 or less, 12.0 or less, 11.0 or less, 10.0 or less, or 9.0 or less by mass ratio.

The beer-taste beverage according to the present invention is a beer-taste beverage satisfying Formula (2) shown below.

X1/Y1≥2.00 :Formula (2)

[In Formula (2), X1 represents the isoamyl alcohol content (unit: ppm by mass), and Y1 represents the ethyl acetate content (unit: ppm by mass).]

In the beer-taste beverage according to an aspect of the present invention, the ratio (X1/Y1) between the isoamyl alcohol content and the ethyl acetate content in Formula (2) may be 2.10 or more, 2.20 or more, 2.30 or more, 2.40 or more, 2.50 or more, 2.60 or more, 2.65 or more, 2.70 or more, 2.80 or more, 2.90 or more, 3.00 or more, 3.10 or more, 3.20 or more, 3.25 or more, 3.30 or more, 3.40 or more, 3.50 or more, 4.00 or more, 4.10 or more, 4.20 or more, 4.30 or more, 4.40 or more, 4.50 or more, 4.60 or more, 4.70 or more, 4.80 or more, or more, or more, 6.50 or more, 7.00 or more, 7.50 or more, 8.00 or more, 8.50 or more, 9.00 or more, 9.50 or more, or 10.0 or more by mass ratio, from the viewpoint of improving the rich aroma of the beer-taste beverage.

Furthermore, the upper limit value of the content ratio between isoamyl alcohol and ethyl acetate (X1/Y1) is not particularly limited, but it may be, for example, 30.0 or less, 29.0 or less, 28.0 or less, 27.0 or less, 26.0 or less, 25.0 or less, 24.0 or less, 23.0 or less, 22.0 or less, 21.0 or less, or 20.0 or less by mass ratio.

The beer-taste beverage according to an aspect of the present invention is a beer-taste beverage satisfying Formula (3) shown below.

X2/Y1>0.65 :Formula (3)

[In Formula (3), X2 represents an n-propanol content (unit: ppm by mass), and Y1 represents the ethyl acetate content (unit: ppm by mass).]

In the beer-taste beverage according to an aspect of the present invention, the ratio (X2/Y1) between the n-propanol content and the ethyl acetate content in Formula (3) is preferably 0.70 or more, 0.75 or more, 0.80 or more, 0.85 or more, 0.90 or more, 0.95 or more, 1.00 or more, 1.05 or more, 1.10 or more, 1.15 or more, 1.20 or more, 1.25 or more, 1.30 of more, 1.35 or more, 1.40 or more, 1.45 or more, 1.50 or more, 1.60 or more, 1.70 or more, 1.80 or more, 1.90 or more, 2.00 or more, 2.10 or more, 2.20 or more, 2.30 or more, 2.40 or more, 2.50 or more, 2.60 or more, 2.70 or more, 2.80 or more, 2.90 or more, 3.00 or more, 3.50 or more, 4.00 or more, 4.50 or more, or 5.00 or more by mass ratio, from the viewpoint of improving the rich aroma of the beer-taste beverage.

Furthermore, the upper limit value of the ratio (X2/Y1) between the n-propanol content and the ethyl acetate content in Formula (3) is not particularly limited, but it may be, for example, 10.0 or less, 9.00 or less, 8.00 or less, 7.00 or less, 6.00 or less, or 5.00 or less by mass ratio.

The beer-taste beverage according to an aspect of the present invention is a beer-taste beverage satisfying Formula (4) shown below.

X3/Y1>0.65 :Formula (4)

[In Formula (4), X3 represents an isobutanol content (unit: ppm by mass), and Y1 represents the ethyl acetate content (unit: ppm by mass).]

In the beer-taste beverage according to an aspect of the present invention, the ratio (X3/Y1) between the isobutanol content and the ethyl acetate content in Formula (4) is preferably 0.70 or more, 0.75 or more, 0.80 or more, 0.85 or more, 0.90 or more, 0.95 or more, 1.00 or more, 1.05 or more, 1.10 or more, 1.15 or more, 1.20 or more, 1.25 or more, 1.30 or more, 1.35 or more, 1.40 or more, 1.45 or more, 1.50 or more, 1.60 or more, 1.70 or more, 1.80 or more, 1.90 or more, 2.00 or more, 2.10 or more, 2.20 or more, 2.30 or more, 2.40 or more, 2.50 or more, 2.60 or more, 2.70 or more, 2.80 or more, 2.90 or more, 3.00 or more, 3.50 or more, 4.00 or more, 4.50 or more, or 5.00 or more by mass ratio, from the viewpoint of improving the rich aroma of the beer-taste beverage.

Furthermore, the upper limit value of the ratio (X3/Y1) between the isobutanol content and the ethyl acetate content in Formula (4) is not particularly limited, but it may be, for example, 10.0 or less, 9.00 or less, 8.00 or less, 7.00 or less, 6.00 or less, or 5.00 or less by mass ratio.

The beer-taste beverage according to an aspect of the present invention is a beer-taste beverage satisfying Formula (5) shown below.

X4/Y1>0.30 :Formula (5)

[In Formula (5), X4 represents a phenethyl alcohol content (unit: ppm by mass), and Y1 represents the ethyl acetate content (unit: ppm by mass).]

In the beer-taste beverage according to an aspect of the present invention, the ratio (X4/Y1) between the phenethyl alcohol content and the ethyl acetate content in Formula (5) is preferably more than 0.35, 0.40 or more, 0.45 or more, 0.50 or more, 0.55 or more, 0.60 or more, 0.70 or more, 0.75 or more, 0.80 or more, 0.85 or more, 0.90 or more, 0.95 or more, 1.00 or more, 1.05 or more, 1.10 or more 1.15 or more. 1.20 or more, 1.25 or more, 1.30 or more, 1.35 or more, 1.40 or more, 1.45 or more, 1.50 or more, 1.60 or more, 1.70 or more, 1.80 or more, 1.90 or more, 2.00 or more, 2.10 or more, 2.20 or more, 2.30 or more, 2.40 or more, 2.50 or more, 2.60 or more, 2.70 or more, 2.80 or more, 2.90 or more, 3.00 or more, 3.50 or more, 4.00 or more, 4.50 or more, or 5.00 or more by mass ratio, from the viewpoint of improving the rich aroma of the beer-taste beverage.

Furthermore, the upper limit value of the ratio (X4/Y1) between the phenethyl alcohol content and the ethyl acetate content in Formula (5) is not particularly limited, but it may be, for example, 10.0 or less, 9.00 or less, 8.00 or less, 7.00 or less, 6.00 or less, or 5.00 or less by mass ratio.

In the beer-taste beverage according to an aspect of the present invention, the isobutanol content is preferably 10 ppm by mass or more, 20 ppm by mass or more, 30 ppm by mass or more, 40 ppm by mass or more, 50 ppm by mass or more, 55 ppm by mass or more, 60 ppm by mass or more, 65 ppm by mass or more, 70 ppm by mass or more, 75 ppm by mass or more, 80 ppm by mass or more, 85 ppm by mass or more, 90 ppm by mass or more, 95 ppm by mass or more, 100 ppm by mass or more, 110 ppm by mass or more, 120 ppm by mass or more, 130 ppm by mass or more, 140 ppm by mass or more, 150 ppm by mass or more, 160 ppm by mass or more, 170 ppm by mass or more, 180 ppm by mass or more, 190 ppm by mass or more, 200 ppm by mass or more, 250 ppm by mass or more, or 300 ppm by mass or more, from the viewpoint of improving the rich aroma of the beer-taste beverage.

On the other hand, the isobutanol content may be 500 ppm by mass or less, 450 ppm by mass or less, 400 ppm by mass or less, 390 ppm by mass or less, 380 ppm by mass or less, 370 ppm by mass or less, 360 ppm by mass or less, 350 ppm by mass or less, 340 ppm by mass or less, 330 ppm by mass or less, 320 ppm by mass or less, 310 ppm by mass or less, 300 ppm by mass or less, 290 ppm by mass or less, 280 ppm by mass or less, 270 ppm by mass or less, 260 ppm by mass or less, 250 ppm by mass or less, 240 ppm by mass or less, 230 ppm by mass or less, 220 ppm by mass or less, 210 ppm by mass or less, 200 ppm by mass or less, 190 ppm by mass or less, 180 ppm by mass or less, 170 ppm by mass or less, 160 ppm by mass or less, or 150 ppm by mass or less, from the viewpoint of producing a beer-taste beverage having less excessive sensation of irritation from alcohol.

Isobutanol may be contained in the raw material of the beer-taste beverage, may be produced during fermentation based on the substrate contained in the raw material, or may be separately added in the production process (for example, purified isobutanol).

The adjustment of the isobutanol content can be performed by appropriately setting, for example, the addition of diluent water or carbonated water and the addition amount thereof when added, the addition of purified isobutanol, the type of isobutanol-containing raw materials (such as cereal grain, malt, corn grits, sugar solution, yeast extract, soybean, or pea), the type of raw materials serving as the origin of isobutanol (such as cereal grain, malt, corn grits, sugar solution, yeast extract, soybean, or pea), the amount of the raw materials, the amount of time for enzyme reaction in the mashing step (wort production step from charging raw materials such as malt to before yeast addition), the pH in the mashing step, the addition amount of an acid used in the pH adjustment, the timing for the pH adjustment (for example, during mashing, during fermentation, at the time when fermentation is completed, prior to beverage filtration, after beverage filtration), the setting temperature and the retention time in each temperature region during wort preparation (including during saccharification), the original extract concentration in a pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, fermentation temperature, the amount of time for fermentation, pressure setting, and carbon dioxide concentration), and the addition of spirits or brewed alcohol.

Furthermore, the isobutanol content can be measured by headspace gas chromatography equipped with an FID detector in accordance with a method described in the item “8.22 Low Boiling Point Aroma Components” of Revised BCOJ Beer Analysis Method (Enlarged and Revised Edition of 2013), which is an analysis method defined by Brewery Convention of Japan (BCOJ), Brewers Association of Japan.

In the beer-taste beverage according to an aspect of the present invention, the phenethyl alcohol content is preferably 10 ppm by mass or more, 15 ppm by mass or more, 20 ppm by mass or more, 25 ppm by mass or more, 30 ppm by mass or more, 35 ppm by mass or more, 40 ppm by mass or more, 45 ppm by mass or more, 50 ppm by mass or more, 55 ppm by mass of more, 60 ppm by mass or more, 65 ppm by mass or more, 70 ppm by mass or more, 75 ppm by mass or more, 80 ppm by mass or more, 85 ppm by mass or more, 90 ppm by mass or more, 95 ppm by mass or more, 100 ppm by mass or more, 110 ppm by mass or more, 120 ppm by mass or more, 130 ppm by mass or more, 140 ppm by mass or more, 150 ppm by mass or more, 160 ppm by mass or more, 170 ppm by mass or more, 180 ppm by mass or more, 190 ppm by mass or more, 200 ppm by mass or more, 250 ppm by mass or more, or 300 ppm by mass or more, from the viewpoint of improving the rich aroma of the beer-taste beverage.

On the other hand, the phenethyl alcohol content is preferably 500 ppm by mass or less, 450 ppm by mass or less, 400 ppm by mass or less, 350 ppm by mass or less, 300 ppm by mass or less, 290 ppm by mass or less, 280 ppm by mass or less, 270 ppm by mass or less, 260 ppm by mass or less, 250 ppm by mass or less, 240 ppm by mass or less, 230 ppm by mass or less, 220 ppm by mass or less, 210 ppm by mass or less, 200 ppm by mass or less, 190 ppm by mass or less, 180 ppm by mass or less, 170 ppm by mass or less, 160 ppm by mass or less, 150 ppm by mass or less, 140 ppm by mass or less, 130 ppm by mass or less, 120 ppm by mass or less, 110 ppm by mass or less, or 100 ppm by mass or less from the viewpoint of producing a beer-taste beverage with less excessive sensation of irritation from alcohol.

Phenethyl alcohol may be contained in the raw material of the beer-taste beverage, may be produced during fermentation based on the substrate contained in the raw material, or may be separately added in the production process (for example, purified phenethyl alcohol).

The adjustment of the phenethyl alcohol content can be performed by appropriately setting, for example, the addition of diluent water or carbonated water and the addition amount thereof when added, the addition of purified phenethyl alcohol, the type of phenethyl alcohol-containing raw material (such as cereal grain, malt, corn grits, sugar solution, yeast extract, soybean, or pea), the type of raw materials serving as the origin of phenethyl alcohol (such as cereal grain, malt, corn grits, sugar solution, yeast extract, soybean, or pea), the amount of the raw materials, the amount of time for enzyme reaction in the mashing step (wort production step from charging raw materials such as malt to before yeast addition), the pH in the mashing step, the addition amount of an acid used in the pH adjustment, the timing for the pH adjustment (for example, during mashing, during fermentation, at the time when fermentation is completed, prior to beverage filtration, after beverage filtration), the setting temperature and the retention time in each temperature region during wort preparation (including during saccharification), the original extract concentration in a pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, fermentation temperature, the amount of time for fermentation, pressure setting, and carbon dioxide concentration), and the addition of spirits or brewed alcohol.

Furthermore, the phenethyl alcohol content can be measured by headspace gas chromatography equipped with an FID detector in accordance with a method described in the item “8.22 Low Boiling Point Aroma Components” of Revised BCOJ Beer Analysis Method (Enlarged and Revised Edition of 2013), which is an analysis method defined by Brewery Convention of Japan (BCOJ), Brewers Association of Japan.

In the beer-taste beverage according to an aspect of the present invention, the ethyl caproate content is preferably 100 ppb by mass or more, 110 ppb by mass or more, 120 ppb by mass or more, 130 ppb by mass or more, 140 ppb by mass or more, 150 ppb by mass or more, 160 ppb by mass or more, 170 ppb by mass or more, 180 ppb by mass or more, 190 ppb by mass or more, 200 ppb by mass or more, 210 ppb by mass or more, 220 ppb by mass or more, 230 ppb by mass or more, 240 ppb by mass or more, 250 ppb by mass or more, 260 ppb by mass or more, 270 ppb by mass or more, 280 ppb by mass or more, 290 ppb by mass or more, 300 ppb by mass or more, 310 ppb by mass or more, 320 ppb by mass or more, 330 ppb by mass or more, 340 ppb by mass or more, 350 ppb by mass or more, 360 ppb by mass or more, 370 ppb by mass or more, 380 ppb by mass or more, 390 ppb by mass or more, or 400 ppb by mass or more, from the viewpoint of improving the rich aroma of the beer-taste beverage.

On the other hand, the ethyl caproate content may be 1000 ppb by mass or less, 950 ppb by mass or less, 900 ppb by mass or less, 850 ppb by mass or less, 800 ppb by mass or less, 750 ppb by mass or less, 700 ppb by mass or less, 650 ppb by mass or less, 600 ppb by mass or less, 550 ppb by mass or less, 500 ppb by mass or less, 450 ppb by mass or less, 400 ppb by mass or less, 390 ppb by mass or less, 380 ppb by mass or less, 370 ppb by mass or less, 360 ppb by mass or less, 350 ppb by mass or less, 340 ppb by mass or less, 330 ppb by mass or less, 320 ppb by mass or less, 310 ppb by mass or less, 300 ppb by mass or less, 290 ppb by mass or less, 280 ppb by mass or less, 270 ppb by mass or less, 260 ppb by mass or less, 250 ppb by mass or less, 240 ppb by mass or less, 230 ppb by mass or less, 220 ppb by mass or less, 210 ppb by mass or less, or 200 ppb by mass or less, from the viewpoint of suppressing prominence of an odor unsuitable for richness.

Ethyl caproate may be contained in the raw material of the beer-taste beverage, may be produced during fermentation based on the substrate contained in the raw material, or may be separately added in the production process (for example, purified ethyl caproate).

The adjustment of the ethyl caproate content can be performed by appropriately setting, for example, the addition of diluent water or carbonated water and the addition amount thereof when added, the addition of purified ethyl caproate, the type of ethyl caproate-containing raw material (such as cereal grain, malt, corn grits, sugar solution, yeast extract, soybean, or pea), the type of raw materials serving as the origin of ethyl caproate (such as cereal grain, malt, corn grits, sugar solution, yeast extract, soybean, or pea), the amount of the raw materials, the amount of time for enzyme reaction in the mashing step (wort production step from charging raw materials such as malt to before yeast addition), the pH in the mashing step, the addition amount of an acid used in the pH adjustment, the timing for the pH adjustment (for example, during mashing, during fermentation, at the time when fermentation is completed, prior to beverage filtration, and after beverage filtration), the setting temperature and the retention time in each temperature region during wort preparation (including during saccharification), the original extract concentration in a pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, fermentation temperature, the amount of time for fermentation, pressure setting, and carbon dioxide concentration), and the addition of spirits or brewed alcohol.

The ethyl caproate content can be measured by a known method using an apparatus such as GC-MS.

In the beer-taste beverage according to an aspect of the present invention, the ethyl octanoate content is preferably 100 ppb by mass or more, 150 ppb by mass or more, 200 ppb by mass or more, 210 ppb by mass or more, 220 ppb by mass or more, 230 ppb by mass or more, 240 ppb by mass or more, 250 ppb by mass or more, 260 ppb by mass or more, 270 ppb by mass or more, 280 ppb by mass or more, 290 ppb by mass or more, 300 ppb by mass or more, 310 ppb by mass or more, 320 ppb by mass or more, 330 ppb by mass or more, 340 ppb by mass or more, 350 ppb by mass or more, 360 ppb by mass or more, 370 ppb by mass or more, 380 ppb by mass or more, 390 ppb by mass or more, 400 ppb by mass or more, 410 ppb by mass or more, 420 ppb by mass or more, 430 ppb by mass or more, 440 ppb by mass or more, 450 ppb by mass or more, 460 ppb by mass or more, 470 ppb by mass or more, 480 ppb by mass or more, 490 ppb by mass or more, or 500 ppb by mass or more, from the viewpoint of improving the rich aroma of the beer-taste beverage.

On the other hand, the ethyl octanoate content may be 1000 ppb by mass or less, 950 ppb by mass or less, 900 ppb by mass or less, 850 ppb by mass or less, 800 ppb by mass or less, 750 ppb by mass or less, 700 ppb by mass or less, 650 ppb by mass or less, 600 ppb by mass or less, 590 ppb by mass or less, 580 ppb by mass or less, 570 ppb by mass or less, 560 ppb by mass or less, 550 ppb by mass or less, 540 ppb by mass or less, 530 ppb by mass or less, 520 ppb by mass or less, 510 ppb by mass or less, 500 ppb by mass or less, 490 ppb by mass or less, 480 ppb by mass or less, 470 ppb by mass or less, 460 ppb by mass or less, 450 ppb by mass or less, 440 ppb by mass or less, 430 ppb by mass or less, 420 ppb by mass or less, 410 ppb by mass or less, 400 ppb by mass or less, 390 ppb by mass or less, 380 ppb by mass or less, 370 ppb by mass or less, 360 ppb by mass or less. 350 ppb by mass or less, 340 ppb by mass or less, 330 ppb by mass or less, 320 ppb by mass or less, 310 ppb by mass or less, or 300 ppb by mass or less, from the viewpoint of suppressing prominence of an odor unsuitable for richness.

Ethyl octanoate may be contained in the raw material of the beer-taste beverage, may be produced during fermentation based on the substrate contained in the raw material, or may be separately added in the production process (for example, purified ethyl octanoate).

The adjustment of the ethyl octanoate content can be performed by appropriately setting, for example, the addition of diluent water or carbonated water and the addition amount thereof when added, the addition of purified ethyl octanoate, the type of ethyl octanoate-containing raw material (such as cereal grain, malt, corn grits, sugar solution, yeast extract, soybean, or pea), the type of raw materials serving as the origin of ethyl octanoate (such as cereal grain, malt, corn grits, sugar solution, yeast extract, soybean, or pea), the amount of the raw materials, the amount of time for enzyme reaction in the mashing step (wort production step from charging raw materials such as malt to before yeast addition), the pH in the mashing step, the addition amount of an acid used in the pH adjustment, the timing for the pH adjustment (for example, during mashing, during fermentation, at the time when fermentation is completed, prior to beverage filtration, and after beverage filtration), the setting temperature and the retention time in each temperature region during wort preparation (including during saccharification), the original extract concentration in a pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, fermentation temperature, the amount of time for fermentation, pressure setting, and carbon dioxide concentration), and the addition of spirits or brewed alcohol.

The ethyl octanoate content can be measured by a known method using an apparatus such as GC-MS.

In the beer-taste beverage according to an aspect of the present invention, the ratio (isoamyl alcohol/alcohol strength) between the alcohol strength (unit: (v/v) %) and the isoamyl alcohol content (unit: ppm by mass) is preferably 5.00 or more, 5.25 or more, 5.50 or more, 6.00 or more, 6.25 or more, 6.50 or more, 7.00 or more, 7.50 or more, 8.00 or more, 8.25 or more, 8.50 or more, 9.00 or more, 10.0 or more, 11.0 or more, 12.0 or more, 13.0 or more, 14.0 or more, 15.0 or more, 16.0 or more, 17.0 or more, 18.0 or more, 19.0 or more, 20.0 or more, 25.0 or more, 30.0 or more, 40.0 or more, or 50.0 or more by mass ratio, from the viewpoint of improving the rich aroma and producing a beer-taste beverage in which excessive sensation of irritation from alcohol is unlikely to be felt.

In addition, the upper limit value of the ratio is not particularly limited, but the upper limit value may be, for example, 100 or less, 90.0 or less, 80.0 or less, 70.0 or less, 60.0 or less, or 50.0 or less.

In the beer-taste beverage according to an aspect of the present invention, the ratio (ethyl acetate/alcohol strength) between the alcohol strength (unit: (v/v) %) and the ethyl acetate content (unit: ppm by mass) is preferably 1.00 or more, 1.15 or more, 1.25 or more, 1.50 or more, 1.75 or more, 2.00 or more, 2.25 or more, 2.50 or more, 2.75 or more, 3.00 or more, 3.25 or more, 3.50 or more, 3.75 or more, 4.00 or more, 4.25 or more, 4.50 or more, 4.75 or more, 5.00 or more, 5.50 or more, 6.00 or more, 6.50 or more, 7.00 or more, 7.50 or more, 8.00 or more, 8.50 or more, 9.00 or more, 9.50 or more, or 10.0 or more by mass ratio, from the viewpoint of improving the rich aroma and producing a beer-taste beverage in which excessive sensation of irritation from alcohol is unlikely to be felt.

The upper limit value of the ratio is not particularly limited, but the upper limit value may be, for example, 50.0 or less, 40.0 or less, 30.0 or less, 25.0 or less, 20.0 or less, 15.0 or less, or 10.0 or less.

The pH of the beer-taste beverage according to an aspect of the present invention is preferably 2.00 or more, 2.20 or more, 2.40 or more, 2.60 or more, 2.80 or more, 3.00 or more, 3.10 or more, 3.20 or more, 3.30 or more, 3.40 or more, 3.50 or more, 3.60 or more, 3.70 or more, 3.80 or more, 3.90 or more, or 4.00 or more, and is preferably 5.40 or less, 5.20 or less, 5.00 or less, 4.95 or less, 4.90 or less, 4.85 or less, 4.80 or less, 4.75 or less, 4.70 or less, 4.65 or less, 4.60 or less, 4.55 or less, 4.50 or less, 4.45 or less, 4.40 or less, 4.35 or less, or 4.30 or less, and can also be 4.00 or less, or less than 4.00, from the viewpoint of improving the flavor.

The adjustment of the pH can be performed by appropriately setting, for example, the addition of diluent water or carbonated water and the addition amount thereof when added, the type of the raw materials (such as cereal grain, malt, corn grits, and sugar solution), the amounts of the raw materials, the type of enzyme, the addition amount of the enzyme, the timing for enzyme addition, the amount of time for saccharification in a mashing tank, the amount of time for proteolysis in the mashing tank, the pH in the mashing tank, the pH in the mashing step (wort production step from charging malt to before yeast addition), the type of the acid (such as lactic acid, phosphoric acid, malic acid, tartaric acid, or citric acid) used in pH adjustment, the addition amount of the acid used in pH adjustment, the timing for the pH adjustment (for example, during mashing, during fermentation, at the time when fermentation is completed, prior to beverage filtration, and after beverage filtration), the setting temperature and the retention time in each temperature region during wort preparation (including during saccharification), the original extract concentration in a pre-fermentation liquid, the original extract concentration in the fermentation step, the fermentation conditions (such as oxygen concentration, aeration conditions, yeast species, the addition amount of yeast, the number of proliferated yeast cells, the timing for yeast removal, fermentation temperature, the amount of time for fermentation, pressure setting, and carbon dioxide concentration), the timing for cooling, the cooling temperature, and the amount of time for cooling.

The beer-taste beverage of an aspect of the present invention is suitable for an aspect of packaging in a container. Examples of the container include bottles, plastic bottles, cans (including bottle cans) or barrels. Examples of the container of a preferred aspect include a reclosable container. Specific examples thereof include reclosable bottles, reclosable plastic bottles, and reclosable cans (e.g., reclosable bottle cans).

### C1.1 Raw Material

In the beer-taste beverage according to an aspect of the present invention, grain is used as a raw material. Examples of the grain used as the raw material include cereal grain, rice (such as white rice and brown rice), corn, kaoliang, potato, legumes (such as soybeans and peas), buckwheat, sorghum, foxtail millet, and Japanese millet.

In the beer-taste beverage according to an aspect of the present invention, cereal grain (including ungerminated cereal grain, malt, and the like) is used as a raw material. The cereal grain used as the raw material refers to cereal grains such as barley, wheat, rye, wild oats, oats, adlay, and common oats, and there is no limitation on the production area and the variety. In the case of producing the beer-taste beverage using malt, malt obtained by germinating and drying the seeds of these cereal grains and removing the roots can be used. In the case of producing the beer-taste beverage substantially free of malt, cereal grain extract obtained by extracting these cereal grains can be used.

In an aspect of the present invention, it is preferable to use barley (including extract from barley such as barley extract) or barley malt. Barley is one of the most commonly used cereal grains as a raw material for Japanese beer-taste beverages. Examples of the barley include two-rowed barley and six-rowed barley, and any of them may be used. The cereal grain or malt (including cereal grain extract and malt extract) may be used alone or in combination of two or more thereof. When colored malt is used, different types of colored malts may be appropriately used in combination, or one colored malt may be used.

The beer-taste beverage according to an aspect of the present invention may be a beverage using hops as a raw material, or may be a beverage not using hops. In addition, a sweetener, a water-soluble dietary fiber, a bittering agent or a bitterness imparting agent, an antioxidant, a flavoring agent, an acidulant, salts may be used.

The malt proportion (proportion of all malt used) of the beer-taste beverage according to an aspect of the present invention may be preferably more than 30 mass %, 35 mass % or more, 40 mass % or more, 45 mass % or more, 50 mass % or more, 51 mass % or more, 52 mass % or more, 54 mass % or more, 55 mass % or more, 56 mass % or more, 57 mass % or more, 58 mass % or more, 59 mass % or more, 60 mass % or more, 61 mass % or more, 62 mass % or more, 63 mass % or more, 64 mass % or more, 65 mass % or more, 66 mass % or more, more than 66 mass %, 66.6 mass % or more, 67 mass % or more, 68 mass % or more, 69 mass % or more, 70 mass % or more, 71 mass % or more, 72 mass % or more, 73 mass % or more, 74 mass % or more, 75 mass % or more, 76 mass % or more, 77 mass % or more, 78 mass % or more, 79 mass % or more, 80 mass % or more, 81 mass % or more, 82 mass % or more, 83 mass % or more, 84 mass % or more, 85 mass % or more, 86 mass % or more, 87 mass % or more, 88 mass % or more, 89 mass % or more, 90 mass % or more, 91 mass % or more, 92 mass % or more, 93 mass % or more, 94 mass % or more, 95 mass % or more, 96 mass % or more, 97 mass % or more, 98 mass % or more, 99 mass % or more, or 100 mass %. By improving the malt proportion, the beer-taste beverage in which a rich taste derived from malt and umami of cereal grain can be more strongly felt can be produced.

On the other hand, the malt proportion of the beer-taste beverage according to an aspect according to the present invention may be less than 100 mass %, 99 mass % or less, 98 mass % or less, 97 mass % or less, 96 mass % or less, 95 mass % or less, 94 mass % or less, 93 mass % or less, 92 mass % or less, 91 mass % or less, 90 mass % or less, 89 mass % or less, 88 mass % or less, 87 mass % or less, 86 mass % or less, 85 mass % or less, 84 mass % or less, 83 mass % or less, 82 mass % or less, 81 mass % or less, 80 mass % or less, 79 mass % or less, 78 mass % or less, 77 mass % or less, 76 mass % or less, 75 mass % or less, 74 mass % or less, 73 mass % or less, 72 mass % or less, 71 mass % or less, 70 mass % or less, 69 mass % or less, 68 mass % or less, 67 mass % or less, less than 67 mass %, 66.6 mass % or less, 66 mass % or less, 65 mass % or less, 64 mass % or less, 63 mass % or less, 62 mass % or less, 61 mass % or less, 60 mass % or less, 59 mass % or less, 58 mass % or less, 57 mass % or less, 56 mass % or less, 55 mass % or less, 54 mass % or less, 53 mass % or less, 52 mass % or less, 51 mass % or less, 50 mass % or less, or less than 50 mass % from the viewpoint of producing a beer-taste beverage less likely to impart an unsuitable sensation of satiety.

As used herein, the term “malt proportion” refers to a value calculated according to the Interpretation Notice on the Liquor Tax Law and the Administrative Ordinance Related to Alcoholic Beverages and the like enforced on Apr. 1, 2018.

When suppressing the malt proportion, it is preferable to increase the amount of a raw material assimilable by yeast (a carbon source and a nitrogen source) other than malt. Examples of the carbon source as the raw material assimilable by yeast include monosaccharides, disaccharides, trisaccharides, and sugar solutions thereof; examples of the nitrogen source as the raw materials assimilable by yeast include yeast extract, soybean protein, malt, soybeans, yeast extract, peas, wheat malt, ungerminated grains, and decomposition products thereof. Examples of the ungerminated grains include ungerminated barley, ungenminated wheat, ungerminated rye, ungerminated wild oats, ungerminated oats, ungerminated adlay, ungerminated common oats, ungerminated rice (such as white rice and brown rice), ungerminated corn, ungerminated kaoliang, ungerminated potato, ungerminated legumes (such as soybeans and peas), ungerminated, buckwheat, ungerminated sorghum, ungerminated foxtail millet, and ungerminated Japanese millet. In addition, starch obtained from these grains and extract thereof (extract) may be used.

Examples of the form of the hops used in one aspect of the present invention include pellet hops, powdered hops, and hops extract. The hops used may be a processed hop product, such as isomerized hops or reduced hops.

The addition amount of the hops is appropriately adjusted, and is preferably from 0.0001 to 1 mass % with respect to the total amount of the beverage. In addition, the beer-taste beverage using hops as the raw material is a beverage containing iso-α-acid, which is a component derived from hops.

Examples of the sweetener include commercially available saccharified liquid obtained by decomposing grain-derived starch with an acid, an enzyme or the like, saccharides such as sucrose and commercially available starch syrup, natural sweeteners such as saccharides that contains 3 or more monosaccharide units, sugar alcohols, isomerized sugars and stevia, and artificial sweeteners.

These saccharides may be in the form of a liquid, such as a solution, or a solid, such as a powder.

In addition, there are no particular limitations on the type of grains serving as raw materials for starch, a method for purifying starch, and the process conditions such as hydrolysis with an enzyme or an acid. For example, a saccharide having an increased proportion of maltose may be used, by appropriately setting the conditions for the hydrolysis with an enzyme or an acid. In addition, there can also be used sucrose, fructose, glucose, mannose, arabinose, galactose, xylose, rhamnose, ribose, fucose, lactose, maltose, trehalose, maltotriose, maltotetraose, maltopentaose, isomaltose, isomaltotriose, isomaltotetraose, isomaltopentaose, lactosucrose, 4′-galactosyllactose, 1-kestose, nystose, fructofuranosylnystose, raffinose, stachyose, xylobiose, xylotriose, panose, and solutions (sugar solutions) thereof. Examples of the artificial sweeteners include aspartame, acesulfame potassium (acesulfame K), sucralose, and neotame. These sweeteners may be used alone, or in combination of two or more. As a raw material other than malt, a sugar assimilable by yeast (assimilable sugar) can be further added to increase the alcohol strength.

Examples of the water-soluble dietary fiber include indigestible dextrin, polydextrose, a guar gum decomposition product, pectin, glucomannan, alginic acid, laminarin, fucoidan and carrageenan, and indigestible dextrin or polydextrose is preferable from a point of view of versatility such as stability and safety.

These water-soluble dietary fibers may be used alone, or in combination of two or more.

In the beer-taste beverage, the bitterness is preferably imparted by hops or the like, but the bittering agent or the bitterness imparting agent may be further used.

The bittering agent or the bitterness imparting agent is not particularly limited, and there can be used either of those used as a bitterness imparting agent in normal beers or low-malt beers, and examples thereof include rosemary, lychee, amur cork tree, caraway, juniper berry, sage, Salvia rosmarinus, lingzhi mushroom, laurel, lingzhi mushroom, quassin, citrus extract, picrasma wood extract, coffee extract, tea extract, bitter melon extract, lotus embryo extract, candelabra aloe extract, rosemary extract, lychee extract, laurel extract, sage extract, caraway extract, wormwood extract, absinthin, alginic acid, and gallic acid.

These bittering agents or bitterness imparting agents may be used alone, or two or more thereof may be used in combination.

The antioxidant is not particularly limited, and there can be used a substance used as an antioxidant in normal beers or low-malt beers, and examples thereof include ascorbic acid, erythorbic acid, and catechin.

One of these antioxidants may be used alone, or two or more thereof may be used in combination.

The flavoring agent is not particularly limited, and a typical beer flavoring agent can be used. The beer flavoring agent is used for imparting a beer-like flavor, and contains a brewing component produced by fermentation. Thus, when the production process of the beer-taste beverage involves alcoholic fermentation, it is not necessary to separately add the beer flavoring agent, but the beer flavoring agent may be added as desired.

Examples of the beer flavoring agent include esters and higher alcohols, and specific examples thereof include isoamyl acetate, ethyl acetate, n-propanol (such as 1-propanol), isobutanol, acetaldehyde, ethyl caproate, ethyl caprylate, isoamyl propionate, linalool, geraniol, citral, 4-vinylguaiacol (4-VG), 4-methyl-3-pentenoic acid, 2-methyl-2-pentenoic acid, 1,4-cineole, 1,8-cineole, 2,3-diethyl-5-methylpyrazine, γ-decanolactone, γ-undecalactone, ethyl hexanoate, ethyl 2-methylbutyrate, ethyl n-butyrate, myrcene, citral, limonene, ethyl maltol, phenylacetic acid, furaneol, furfural, methional, 3-methyl-2-butene-1-thiol, 3-methyl-2-butanethiol, diacetyl, ferulic acid, geranic acid, geranyl acetate, ethyl butyrate, octanoic acid, decanoic acid, 9-decenoic acid, nonanoic acid, tetradecanoic acid, propanoic acid, 2-methylpropanoic acid, γ-butyrolactone, 2-aminoacetophenone, ethyl 3-phenylpropionate, 2-ethyl-4-hydroxy-5-methyl-3 (2H)-furanone, dimethylsulfone, 3-methylcyclopentane-1,2-dione, 2-methylbutanal, 3-methylbutanal, 2-methyltetrahydrofuran-3-one, 2-acetylfuran, 2-methyltetrahydrofuran-3-one, hexanal, hexanol, cis-3-hexenal, 1-octene-3-ol, p-eudesmol, 4-mercapto-4-methylpentane-2-one, β-caryophyllene, β-myrcene, furfuryl alcohol, 2-ethylpyrazine, 2,3-dimethylpyrazine, 2-methylbutyl acetate, isoamyl alcohol, 5-hydroxymethylfurfural, phenylacetaldehyde, 1-phenyl-3-butene-1-one, trans-2-hexenal, nonanal, phenethyl alcohol, nerol, citronellol, methyl p-toluate, 1,2,3,5-tetramethylbenzene, triethyl citrate, tributyl citrate, diethyl tartrate, dibutyl malate, perillaldehyde, methylheptenone, lemon myrtle, and cinnamaldehyde.

One of these beer flavoring agents may be used alone, or two or more thereof may be used in combination.

The acidulant is not particularly limited as long as it is a substance having sourness, and for example, phosphoric acid, citric acid, gluconic acid, tartaric acid, lactic acid, malic acid, phytic acid, acetic acid, succinic acid, glucono-delta-lactone, or salts thereof can be used.

Among these acidulants, phosphoric acid, citric acid, gluconic acid, tartaric acid, lactic acid, malic acid, phytic acid, acetic acid, succinic acid or salts thereof are preferable, phosphoric acid, malic acid, citric acid, lactic acid, tartaric acid, acetic acid, or salts thereof are more preferable, and phosphoric acid, malic acid, citric acid, lactic acid, or salts thereof are particularly preferable.

One of these acidulants may be used alone, or two or more of these acidulants may be used in combination. Note that, the acidulant is not limited to an acidulant approved as food additives, and there may be used an acidulant derived from a raw material such as malt, an acidulant produced by adjustments of various process conditions, an acidulant produced by yeast, and an acidulant to be externally added as an additive, for example.

The content of the acidulant in the beer-taste beverage according to an aspect of the present invention is preferably from 500 to 10000 ppm by mass, more preferably from 1000 to 9000 ppm by mass, still more preferably from 2000 to 8000 ppm by mass.

Examples of the preservative include: benzoic acid; benzoic acid salts such as sodium benzoate; benzoic acid esters such as propyl parahydroxybenzoate and butyl parahydroxybenzoate; and dimethyl dicarbonate. Also, as the preservative, a commercially available preparation, such as Kyohryoku Sanpurezah (Powerful Sanplezer) (a mixture of sodium benzoate and butyl benzoate, available from San-Ei Gen F.F.L., Inc.) may be used. One of these preservatives may be used alone, or two or more of these preservatives may be used in combination.

The blending amount of the preservative in the beer-taste beverage according to an aspect of the present invention is preferably from 5 to 1200 ppm by mass, more preferably from 10 to 1100 ppm by mass, still more preferably from 15 to 1000 ppm by mass, and even more preferably from 20 to 900 ppm by mass.

Examples of the salts include sodium chloride, potassium acid phosphate, calcium acid phosphate, ammonium phosphate, magnesium sulfate, calcium sulfate, potassium metabisulfite, calcium chloride, magnesium chloride, potassium nitrate, ammonium sulfate, potassium chloride, monosodium citrate, disodium citrate, and trisodium citrate.

One of these salts may be used alone, or two or more of these salts may be used in, combination.

### C1.2 Carbon Dioxide Gas

The beer-taste beverage according to an aspect of the present invention may contain dissolved carbon dioxide gas, or may not contain dissolved carbon dioxide gas.

As the carbon dioxide gas contained in the beer-taste beverage, the carbon dioxide gas contained in the raw material may be used, or carbon dioxide gas may be dissolved, for example, by mixing carbonated water or by addition of carbon dioxide gas.

The beer-taste beverage according to one aspect of the present invention is produced through the alcoholic fermentation, and hence the carbon dioxide gas generated in this fermentation step can be used directly, but the amount of carbon dioxide gas may be prepared by appropriately adding carbonated water.

When the beer-taste beverage according to an aspect of the present invention contains dissolved carbon dioxide gas, the carbon dioxide gas concentration is preferably 0.30 (w/w) % or more, 0.35 (w/w) % or more, 0.40 (w/w) % or more, 0.42 (w/w) % or more, 0.45 (w/w) % or more, 0.47 (w/w) % or more, 0.50 (w/w) % or more, or 0.52 (w/w) % or more, and the carbon dioxide gas concentration may be 0.80 (w/w) % or less, 0.70 (w/w) % or less, 0.60 (w/w) % or less, 0.57 (w/w) or less, 0.55 (w/w) % or less, 0.54 (w/w) % or less, 0.53 (w/w) % or less, 0.52 (w/w) % or less, 0.51 (w/w) % or less, or 0.50 (w/w) % or less.

When the beer-taste beverage according to an aspect of the present invention is a packaged beverage, the carbon dioxide gas pressure of the packaged beverage may be appropriately adjusted such that the carbon dioxide gas concentration is in the range described above, and the carbon dioxide gas pressure is 5.0 kg/cm² or less, 4.5 kg/cm² or less, or 4.0 kg/cm² or less, and 0.20 kg/cm² or more, 0.50 kg/cm² or more, or 1.0 kg/cm² or more. Any of these upper and lower limits may be combined. For example, the carbon dioxide gas pressure may be 0.20 kg/cm² or more and 5.0 kg/cm² or less, 0.50 kg/cm² or more and 4.5 kg/cm² or less, or 1.0 kg/cm² or more and 4.0 kg/cm² or less.

In the present specification, the gas pressure refers to gas pressure in the container except in special cases.

The pressure can be measured by a method well-known to those skilled in the art, for example, using a method in which a sample adjusted to 20 °C is fixed to a gas internal pressure gauge, the stopcock of the gas internal pressure gauge is opened once to release the gas, the stopcock is closed again, the gas internal pressure gauge is shaken, and a value when the pointer reaches a certain position is read; or using a commercially available gas pressure measuring instrument.

### C1.3 Other Additives

In the beer-taste beverage according to an aspect of the present invention, various additives may be added as necessary to the extent that the effects of the present invention are not compromised.

Examples of such additives include a coloring agent, a foaming agent, a fermentation accelerator, yeast extract, a protein-based substance such as a peptide-containing substance, and a seasoning such as an amino acid.

The coloring agent is used to impart beer-like color to the beverage, and for example, a caramel dye can be used. The foaming agent is used to form beer-like foam in the beverage or to retain the foam in the beverage, and there can be appropriately used, for example, a saponin-based substance extracted from a plant, such as soybean saponin or quillaja saponin; a plant protein such as a protein from corn or soybean; and a peptide-containing substance such as a collagen peptide; yeast extract; and an ingredient derived from milk.

The fermentation accelerator is used for promoting fermentation by yeast, and examples thereof include yeast extract, a bran component from, for example, rice or cereal grain, a vitamin, and a mineral agent. A single type of the fermentation accelerator can be used alone or two or more types of the fermentation accelerators may be used in combination.

### 2. Method for Producing Beer-Taste Beverage

The present invention discloses a method for producing a beer-taste beverage having an alcohol strength of 8.00 (v/v) % or more. Specific aspects of the method of the present invention will be described in detail in the following aspects A to C.

### <<Aspect A: Corresponding to JP 2023-100223>>

### A2. Method for Producing Beer-Taste Beverage

The method for producing a beer-taste beverage according to an aspect of the present invention is not particularly limited, and the beer-taste beverage can be produced in the same manner as a typical beer-taste beverage, but examples thereof include a method having at least the following step (I) and step (II).
step (I): a step of adjusting an alcohol strength to 8.0 (v/v) %
step (II): a step of checking and/or adjusting an isoamyl alcohol content and a content ratio between isoamyl alcohol and ethyl acetate such that the isoamyl alcohol content is 110 ppm by mass or more, and Formula (1) shown below is satisfied.

X1/Y1≥2.00 :Formula (1)

[wherein, X1 represents the isoamyl alcohol content (unit: ppm by mass), and Y1 represents an ethyl acetate content (unit: ppm by mass).]

Furthermore, the order of the step (I) and the step (II) is not particularly limited, and the step (I) and the step (II) may be performed simultaneously.

The method for producing a beer-taste beverage according to an aspect of the present invention is not particularly limited, and may be a method for producing a beer-taste beverage through a fermentation step or may be a method for producing a beer-taste beverage without the fermentation step.

The method for producing a beer-taste beverage according to an aspect of the present invention is not particularly limited, and the method may be a method for producing a beer-taste beverage through an aging step or may be a method for producing a beer-taste beverage without the aging step.

Hereinafter, a method for producing a fermented beer-taste beverage through the fermentation step and a method for producing a non-fermented beer-taste beverage without the fermentation step will be described.

### A2.1 Method for Producing Fermented Beer-Taste Beverage

Examples of the method for producing a fermented beer-taste beverage according to an aspect of the present invention include a method including a fermentation step with yeast. For example, the method may include the following step (1) and step (2).
step (1): a step of, to a raw material, performing at least one treatment from the group consisting of a saccharification treatment, a boiling treatment, and a solid content removal treatment and thus, yielding a pre-fermentation liquid.
step (2): a step of adding yeast to the pre-fermentation liquid and subjecting the pre-fermentation liquid to fermentation.

In the method for producing a fermented beer-taste beverage according to an aspect of the present invention, the step (I) and the step (II) can be performed at one or more timings of the following (i) to (iii):
(i): At the same time as at least one of the step (1) and/or the step (2)
(ii): Between the step (1) and the step (2)
(iii): After the step (2)

Hereinafter, each step of the method for producing a fermented beer-taste beverage according to an aspect of the present invention will be described.

### A2.1.1 Step (1)

The step (1) is a step of performing at least one treatment of the group consisting of a saccharification treatment, a boiling treatment, and a solid content removal treatment, using various raw materials and thus, yielding a pre-fermentation liquid.

For example, when malt is used as one of the various raw materials, the various raw materials including water and malt are fed into a mashing kettle or a mashing tank, and an enzyme preparation such as a polysaccharide degrading enzyme or a proteolytic enzyme, which promotes a change of a component derived from the raw materials, may be added as necessary. This makes it possible to promote the production of an assimilable sugar, for example.

Examples of the enzyme preparation include amylase, protease, purine nucleosidase, deaminase, polyphenol oxidase, glucanase, xylase, pectinase, cellulase, lipase, glucosidase, xanthine oxidase, transglucosidase, glucoamylase, uricase, β-glucosidase, and α-glucosidase. These enzyme preparations may be thermostable or non-thermostable. In addition, the type of the enzyme preparation can be selected depending on the addition timing or the addition step. Note that, for these enzyme preparations, a single type of the enzyme preparation may be used alone, or two or more types of the enzyme preparations may be used in combination. Examples of the enzyme preparation also include an enzyme preparation classified in “(3) Following Enzyme Preparations Added during Brewing Step for Purpose of Rationalization of Brewing and the like” in Article 3 “7. Articles not Handled as Raw Materials for Alcoholic Beverages” of the Notice on the Liquor Tax Act and the Administrative Ordinance Related to Alcoholic Beverages (revised on Jun. 27, 2018).

Adding these enzymatic agents can efficiently adjust the component composition of the resulting beer-taste beverage. As the various raw materials other than malt, there may be added various additives such as an assimilable sugar such as glucose, sucrose, and maltose, hops, a preservative, a sweetener, an water-soluble dietary fiber, a bittering agent or a bitterness imparting agent, an antioxidant, a flavor, an acidulant, and a pigment. The enzyme preparation and the various raw materials may be added before the saccharification treatment, may be added during the saccharification treatment, or may be added after the saccharification treatment is completed. Moreover, these enzyme preparation and various raw materials may be added together with yeast before and after the fermentation in the subsequent step, that is, in the step (2), may be added during the fermentation, or may be added after the fermentation is completed.

A mixture of the various raw materials is heated to saccharify a starchy component of the raw materials, and thus, the saccharification treatment is performed.

The temperature and the time of the saccharification treatment is preferably appropriately adjusted in view of the type of the malt used, the malt proportion, the raw materials besides water and malt, the type and the amount of the enzyme used, and the alcohol strength of the finally obtained beverage, for example. In an aspect of the present invention, from the viewpoint of adjusting the alcohol strength of the beer-taste beverage to the above range, the temperature of the saccharification treatment is preferably from 55 to 75 °C, and the time of the saccharification treatment is preferably from 30 to 240 minutes.

Furthermore, the saccharified liquid is preferably subjected to the boiling treatment.

In case where the hops, the bittering agent, and the like are used as the raw materials, they are added preferably at the time when this boiling treatment is carried out. The hops, the bittering agent, and the like may be added between the start of boiling the saccharified liquid and before the end of boiling the saccharified liquid.

After the boiling treatment is completed, preferably, the liquid is transferred to whirlpool and cooled to 0 to 25 °C and a cooled liquid is obtained, and thus, a treatment for removing a solid content such as coagulated protein is carried out. In this way, the pre-fermentation liquid is prepared.

Note that in this step, there may be performed filtration through a filter having a predetermined pore diameter (e.g., a pore diameter less than 30 μm) to perform the treatment for removing a solid content.

In place of the saccharified liquid, malt extract to which hot water has been added may be used, and to the malt extract, hops, the bittering agent and the like may be added, and thus, the resultant mixture may be subjected to the boiling treatment to prepare a pre-fermentation liquid.

When no malt is used or an limited amount of malt is used as one of the various raw materials, a liquid sugar that contains a carbon source, a nitrogen source as an amino acid-containing raw material other than cereal grain or malt, hops, a dietary fiber, a preservative, a sweetener, an antioxidant, a bitterness imparting agent, a flavor, an acidulant, a pigment, and the like are mixed with hot water to prepare a liquid sugar solution, and this liquid sugar solution may be subjected to the boiling treatment to prepare a pre-fermentation liquid.

In the case of using hops, the hops may be added before the boiling treatment or may be added between the start of boiling the liquid sugar solution and before the end of boiling the liquid sugar solution.

### A2.1.2 Step (2)

The step (2) is a step of adding yeast to the pre-fermentation liquid obtained in the step (1) and subjecting the pre-fermentation liquid to fermentation.

The yeast used in this step can be appropriately selected in view of the type of the fermented beverage to be produced, the target flavor, and the fermentation conditions, for example, and top-fermenting yeast may be used, or bottom-fermenting yeast may be used.

The yeast in the form of a yeast suspension may be directly added to the raw materials, or a slurry produced by concentrating the yeast by centrifugation or sedimentation may be added to the pre-fermentation liquid. Alternatively, a material obtained by completely removing the supernatant after the centrifugation may be added. The amount of the yeast to be added to the beverage can be appropriately set, and is, for example, in a range from about 5×10⁶ cells/mL to 1×10⁸ cells/mL.

Although the fermentation conditions in the fermentation can be set as appropriate, the fermentation temperature is for example from 5 to 30 °C, preferably from 5 to 25 °C, from the viewpoint of adjusting the alcohol strength of the beer-taste beverage to the range described above. In addition, the alcohol strength of the beer-taste beverage can be adjusted by appropriately setting the type of enzyme, the addition amount of enzyme, and the timing for enzyme addition listed in the above section “2.2.1 Step (1)”, and the temperature (temperature increase or temperature decrease) or the pressure of the fermentation liquid may be changed during the fermentation step as necessary. Aging may be performed after the fermentation, and the aging conditions at the time of performing the aging can be appropriately set, but from the viewpoint of being adjusted to a desired flavor, the aging temperature is, for example, from 5 to 30 °C, preferably from 5 to 25 °C. A container for the aging may be, for example, a stainless tank or a wooden barrel.

In addition, after the fermentation, a filtration treatment for removing yeast in the beer-taste beverage may be performed, or the filtration treatment may not be performed. In addition, water or the above-described various additives may be added as necessary.

The beer-taste beverage according to an aspect of the present invention thus obtained undergoes a sterilization treatment as necessary, and then is filled in a predetermined container, and distributed to the market as a product.

The method of packaging the beer-taste beverage is not particularly limited, and a packaging method known to those skilled in the art can be used. Through the packaging step, the beer-taste beverage according to the present invention is filled and sealed in the container. In the packaging step, any container of any form/material may be used, and examples of the container are as described above.

### A2.2 Method for Producing Non-Fermented Beer-Taste Beverage

When the beer-taste beverage according to one aspect of the present invention is a non-fermented beer-taste beverage, the beverage can be produced by a typical method for producing a non-fermented beer-taste beverage. Specific examples of the method for producing a non-fermented beer-taste beverage according to one aspect of the present invention include a method including the following steps (a) to (c):
step (a): a step of, to a raw material, performing at least one treatment of the group of a saccharification treatment, a boiling treatment, and a solid content removal treatment and thus, yielding a pre-beverage liquid.
step (b): a step of cooling the pre-beverage liquid obtained in step (a) and adding carbon dioxide gas.

The step (a) is the same as the step of yielding the pre-fermentation liquid of the step (1) in the “method for producing a fermented beer-taste beverage” described above.

As a method for adding carbon dioxide gas in the step (b), carbon dioxide gas may be added by mixing a cooled pre-fermentation liquid obtained by cooling the pre-fermentation liquid obtained in the step (a) with carbonated water, or carbon dioxide gas may be directly added to the cooled, fermented beverage. At the same timing as the step (b), an additive such as a preservative, a sweetener, a flavoring agent, an acidulant, and a pigment may be added as necessary in adding carbon dioxide gas.

When the non-fermented beer-taste beverage is produced as an alcohol-containing non-fermented beer-taste beverage, the following step (c) is included.
step (c): a step of blending an alcohol component at least after the step (a).

The step (c) needs to be performed at least after the step (a), and, for example, can be performed at one or more timings of any of the following (I) to (III).
(I): Between the step (a) and the step (b)
(II): At the same time as the step (b)
(III): After the step (b)

Among these, the step (c) is preferably performed after the pre-fermentation liquid obtained in the step (a) is cooled to adjust a cooled, fermented beverage and before carbon dioxide gas is added.

As the alcohol component blended in the step (c), spirits (a distilled liquor) derived from the above-described grain is preferable.

The non-fermented beer-taste beverage thus produced is filled in a predetermined container and distributed to the market as a product.

The method for packaging a non-fermented beer-taste beverage is not particularly limited, and a packaging method known to those skilled in the art can be used. Through the packaging step, the non-fermented beer-taste beverage is filled and sealed in the container. In the packaging step, any container of any form/material may be used, and examples of the container are as described above.

### <<Aspect B: Corresponding to JP 2023-100225>

### B2. Method for Producing Beer-Taste Beverage

The method for producing a beer-taste beverage according to an aspect of the present invention is not particularly limited, and the beer-taste beverage can be produced in the same manner as a typical beer-taste beverage, but examples thereof include a method having at least the following step (I) and step (II).
step (I): a step of adjusting an alcohol strength to 8.0 (v/v) %
step (II): a step of checking and/or adjusting a succinic acid content and a content ratio between succinic acid and acetic acid such that the succinic acid content is 110 ppm by mass or more and 1100 ppm by mass or less, and the Formula (1A) shown below is satisfied.

X1/Y1>0.25 :Formula (1A)

[In Formula (1A), X1 represents the succinic acid content (unit: ppm by mass), and Y1 represents an acetic acid content (unit: ppm by mass).]

Furthermore, the order of the step (I) and the step (II) is not particularly limited, and the step (I) and the step (II) may be performed simultaneously.

The method for producing a beer-taste beverage according to an aspect of the present invention is not particularly limited, and may be a method for producing a beer-taste beverage through a fermentation step or may be a method for producing a beer-taste beverage without the fermentation step.

The method for producing a beer-taste beverage according to an aspect of the present invention is not particularly limited, and the method may be a method for producing a beer-taste beverage through an aging step or may be a method for producing a beer-taste beverage without the aging step.

Hereinafter, a method for producing a fermented beer-taste beverage through the fermentation step and a method for producing a non-fermented beer-taste beverage without the fermentation step will be described.

### B2.1 Method for Producing Fermented Beer-Taste Beverage

Examples of the method for producing a fermented beer-taste beverage according to an aspect of the present invention include a method including a fermentation step with yeast. For example, the method may include the following step (1) and step (2).
step (1): a step of, to a raw material, performing at least one treatment from the group consisting of a saccharification treatment, a boiling treatment, and a solid content removal treatment and thus, yielding a pre-fermentation liquid.
step (2): a step of adding yeast to the pre-fermentation liquid and subjecting the pre-fermentation liquid to fermentation.

In the method for producing a fermented beer-taste beverage according to an aspect of the present invention, the step (I) and the step (II) can be performed at one or more timings of the following (i) to (iii):
(1): At the same time as at least one of the step (1) and/or the step (2)
(ii): Between the step (1) and the step (2)
(iii): After the step (2)

Hereinafter, each step of the method for producing a fermented beer-taste beverage according to an aspect of the present invention will be described.

### B2.1.1 Step (1)

The step (1) is a step of performing at least one treatment of the group consisting of a saccharification treatment, a boiling treatment, and a solid content removal treatment, using various raw materials and thus, yielding a pre-fermentation liquid.

For example, when malt is used as one of the various raw materials, the various raw materials including water and malt are fed into a mashing kettle or a mashing tank, and an enzyme preparation such as a polysaccharide degrading enzyme or a proteolytic enzyme, which promotes a change of a component derived from the raw materials, may be added as necessary. This makes it possible to promote the production of an assimilable sugar, for example.

Examples of the enzyme preparation include amylase, protease, purine nucleosidase, deaminase, polyphenol oxidase, glucanase, xylase, pectinase, cellulase, lipase, glucosidase, xanthine oxidase, transglucosidase, glucoamylase, uricase,-glucosidase, and α-glucosidase. These enzyme preparations may be thermostable or non-thermostable. In addition, the type of the enzyme preparation can be selected depending on the addition timing or the addition step. Note that, for these enzyme preparations, a single type of the enzyme preparation may be used alone, or two or more types of the enzyme preparations may be used in combination. Examples of the enzyme preparation also include an enzyme preparation classified in “(3) Following Enzyme Preparations Added during Brewing Step for Purpose of Rationalization of Brewing and the like” in Article 3 “7. Articles not Handled as Raw Materials for Alcoholic Beverages” of the Notice on the Liquor Tax Act and the Administrative Ordinance Related to Alcoholic Beverages (revised on Jun. 27, 2018).

Adding these enzymatic agents can efficiently adjust the component composition of the resulting beer-taste beverage. As the various raw materials other than malt, there may be added various additives such as an assimilable sugar such as glucose, sucrose, and maltose, hops, a preservative, a sweetener, an water-soluble dietary fiber, a bittering agent or a bitterness imparting agent, an antioxidant, a flavor, an acidulant, and a pigment. The enzyme preparation and the various raw materials may be added before the saccharification treatment, may be added during the saccharification treatment, or may be added after the saccharification treatment is completed. Moreover, these enzyme preparation and various raw materials may be added together with yeast before and after the fermentation in the subsequent step, that is, in the step (2), may be added during the fermentation, or may be added after the fermentation is completed.

A mixture of the various raw materials is heated to saccharify a starchy component of the raw materials, and thus, the saccharification treatment is performed.

The temperature and the time of the saccharification treatment is preferably appropriately adjusted in view of the type of the malt used, the malt proportion, the raw materials besides water and malt, the type and the amount of the enzyme used, and the alcohol strength of the finally obtained beverage, for example. In an aspect of the present invention, from the viewpoint of adjusting the alcohol strength of the beer-taste beverage to the above range, the temperature of the saccharification treatment is preferably from 55 to 75 °C, and the time of the saccharification treatment is preferably from 30 to 240 minutes.

Furthermore, the saccharified liquid is preferably subjected to the boiling treatment.

In case where the hops, the bittering agent, and the like are used as the raw materials, they are added preferably at the time when this boiling treatment is carried out. The hops, the bittering agent, and the like may be added between the start of boiling the saccharified liquid and before the end of boiling the saccharified liquid.

After the boiling treatment is completed, preferably, the liquid is transferred to whirlpool and cooled to 0 to 25 °C and a cooled liquid is obtained, and thus, a treatment for removing a solid content such as coagulated protein is carried out. In this way, the pre-fermentation liquid is prepared.

Note that in this step, there may be performed filtration through a filter having a predetermined pore diameter (e.g., a pore diameter less than 30 μm) to perform the treatment for removing a solid content.

In place of the saccharified liquid, malt extract to which hot water has been added may be used, and to the malt extract, hops, the bittering agent and the like may be added, and thus, the resultant mixture may be subjected to the boiling treatment to prepare a pre-fermentation liquid.

When no malt is used or an limited amount of malt is used as one of the various raw materials, a liquid sugar that contains a carbon source, a nitrogen source as an amino acid-containing raw material other than cereal grain or malt, hops, a dietary fiber, a preservative, a sweetener, an antioxidant, a bitterness imparting agent, a flavor, an acidulant, a pigment, and the like are mixed with hot water to prepare a liquid sugar solution, and this liquid sugar solution may be subjected to the boiling treatment to prepare a pre-fermentation liquid.

In the case of using hops, the hops may be added before the boiling treatment or may be added between the start of boiling the liquid sugar solution and before the end of boiling the liquid sugar solution.

### B2.1.2 Step (2)

The step (2) is a step of adding yeast to the pre-fermentation liquid obtained in the step (1) and subjecting the pre-fermentation liquid to fermentation.

The yeast used in this step can be appropriately selected in view of the type of the fermented beverage to be produced, the target flavor, and the fermentation conditions, for example, and top-fermenting yeast may be used, or bottom-fermenting yeast may be used.

The yeast in the form of a yeast suspension may be directly added to the raw materials, or a slurry produced by concentrating the yeast by centrifugation or sedimentation may be added to the pre-fermentation liquid. Alternatively, a material obtained by completely removing the supernatant after the centrifugation may be added. The amount of the yeast to be added to the beverage can be appropriately set, and is, for example, in a range from about 5×10⁶ cells/mL to 1×10⁸ cells/mL.

Although the fermentation conditions in the fermentation can be set as appropriate, the fermentation temperature is for example from 5 to 30 °C, preferably from 5 to 25 °C, from the viewpoint of adjusting the alcohol strength of the beer-taste beverage to the range described above. In addition, the alcohol strength of the beer-taste beverage can be adjusted by appropriately setting the type of enzyme, the addition amount of enzyme, and the timing for enzyme addition listed in the above section “2.2.1 Step (1)”, and the temperature (temperature increase or temperature decrease) or the pressure of the fermentation liquid may be changed during the fermentation step as necessary. Aging may be performed after the fermentation, and the aging conditions at the time of performing the aging can be appropriately set, but from the viewpoint of being adjusted to a desired flavor, the aging temperature is, for example, from 5 to 30 °C, preferably from 5 to 25 °C. A container for the aging may be, for example, a stainless tank or a wooden barrel.

In addition, after the fermentation, a filtration treatment for removing yeast in the beer-taste beverage may be performed, or the filtration treatment may not be performed. In addition, water or the above-described various additives may be added as necessary.

The beer-taste beverage according to an aspect of the present invention thus obtained undergoes a sterilization treatment as necessary, and then is filled in a predetermined container, and distributed to the market as a product.

The method of packaging the beer-taste beverage is not particularly limited, and a packaging method known to those skilled in the art can be used. Through the packaging step, the beer-taste beverage according to the present invention is filled and sealed in the container. In the packaging step, any container of any form/material may be used, and examples of the container are as described above.

### B2.2 Method for Producing Non-Fermented Beer-Taste Beverage

When the beer-taste beverage according to one aspect of the present invention is a non-fermented beer-taste beverage, the beverage can be produced by a typical method for producing a non-fermented beer-taste beverage. Specific examples of the method for producing a non-fermented beer-taste beverage according to one aspect of the present invention include a method including the following steps (a) to (c):
step (a): a step of, to a raw material, performing at least one treatment of the group of a saccharification treatment, a boiling treatment, and a solid content removal treatment and thus, yielding a pre-beverage liquid.
step (b): a step of cooling the pre-beverage liquid obtained in step (a) and adding carbon dioxide gas.

The step (a) is the same as the step of yielding the pre-fermentation liquid of the step (1) in the “method for producing a fermented beer-taste beverage” described above.

As a method for adding carbon dioxide gas in the step (b), carbon dioxide gas may be added by mixing a cooled pre-fermentation liquid obtained by cooling the pre-fermentation liquid obtained in the step (a) with carbonated water, or carbon dioxide gas may be directly added to the cooled, fermented beverage. At the same timing as the step (b), an additive such as a preservative, a sweetener, a flavoring agent, an acidulant, and a pigment may be added as necessary in adding carbon dioxide gas.

When the non-fermented beer-taste beverage is produced as an alcohol-containing non-fermented beer-taste beverage, the following step (c) is included.
step (c): a step of blending an alcohol component at least after the step (a).

The step (c) needs to be performed at least after the step (a), and, for example, can be performed at one or more timings of any of the following (I) to (III).
(I): Between the step (a) and the step (b)
(II): At the same time as the step (b)
(III): After the step (b)

Among these, the step (c) is preferably performed after the pre-fermentation liquid obtained in the step (a) is cooled to adjust a cooled, fermented beverage and before carbon dioxide gas is added.

As the alcohol component blended in the step (c), spirits (a distilled liquor) derived from the above-described grain is preferable.

The non-fermented beer-taste beverage thus produced is filled in a predetermined container and distributed to the market as a product.

The method for packaging a non-fermented beer-taste beverage is not particularly limited, and a packaging method known to those skilled in the art can be used. Through the packaging step, the non-fermented beer-taste beverage is filled and sealed in the container. In the packaging step, any container of any form/material may be used, and examples of the container are as described above.

### <<Aspect C: Corresponding to JP 2023-100227>>

### C2. Method for Producing Beer-Taste Beverage

The method for producing a beer-taste beverage according to an aspect of the present invention is not particularly limited, and the beer-taste beverage can be produced in the same manner as a typical beer-taste beverage, but examples thereof include a method having at least the following step (I) and step (II).
step (I): a step of adjusting an alcohol strength to 10.0 (v/v) %
step (II): a step of checking and/or adjusting an ethyl acetate content and an isoamyl acetate content such that the ethyl acetate content is 50 ppm by mass or more and the isoamyl acetate content is 3 ppm by mass or more.

A method for producing a beer-taste beverage according to another aspect of the present invention is not particularly limited, and the beer-taste beverage can be produced in the same manner as a typical beer-taste beverage, but examples thereof include a method having at least the following step (A) and step (B).
step (A): a step of adjusting an alcohol strength to 12.0 (v/v) %
step (B): a step of checking and/or adjusting an ethyl acetate content such that the ethyl acetate content is 50 ppm by mass or more

Furthermore, the order of the step (I) and the step (II) and the order of the step (A) and the step (B) is not particularly limited, and the step (I) and the step (II) may be performed simultaneously, and the step (A) and the step (B) may be performed simultaneously.

The method for producing a beer-taste beverage according to an aspect of the present invention is not particularly limited, and may be a method for producing a beer-taste beverage through a fermentation step or may be a method for producing a beer-taste beverage without the fermentation step.

The method for producing a beer-taste beverage according to an aspect of the present invention is not particularly limited, and the method may be a method for producing a beer-taste beverage through an aging step or may be a method for producing a beer-taste beverage without the aging step.

Hereinafter, a method for producing a fermented beer-taste beverage through the fermentation step and a method for producing a non-fermented beer-taste beverage without the fermentation step will be described.

### C2.1 Method for Producing Fermented Beer-Taste Beverage

Examples of the method for producing a fermented beer-taste beverage according to an aspect of the present invention include a method including a fermentation step with yeast. For example, the method may include the following step (1) and step (2).
step (1): a step of, to a raw material, performing at least one treatment from the group consisting of a saccharification treatment, a boiling treatment, and a solid content removal treatment and thus, yielding a pre-fermentation liquid.
step (2): a step of adding yeast to the pre-fermentation liquid and subjecting the pre-fermentation liquid to fermentation.

In the method for producing a fermented beer-taste beverage according to an aspect of the present invention, the step (I) and the step (II) can be performed at one or more timings of the following (1) to (iii):
(i): At the same time as at least one of the step (1) and/or the step (2)
(ii): Between the step (1) and the step (2)
(iii): After the step (2)

Hereinafter, each step of the method for producing a fermented beer-taste beverage according to an aspect of the present invention will be described.

### C2.1.1 Step (1)

The step (1) is a step of performing at least one treatment of the group consisting of a saccharification treatment, a boiling treatment, and a solid content removal treatment, using various raw materials and thus, yielding a pre-fermentation liquid.

For example, when malt is used as one of the various raw materials, the various raw materials including water and malt are fed into a mashing kettle or a mashing tank, and an enzyme preparation such as a polysaccharide degrading enzyme or a proteolytic enzyme, which promotes a change of a component derived from the raw materials, may be added as necessary. This makes it possible to promote the production of an assimilable sugar, for example.

Examples of the enzyme preparation include amylase, protease, purine nucleosidase, deaminase, polyphenol oxidase, glucanase, xylase, pectinase, cellulase, lipase, glucosidase, xanthine oxidase, transglucosidase, glucoamylase, uricase, β-glucosidase, and α-glucosidase. These enzyme preparations may be thermostable or non-thermostable. In addition, the type of the enzyme preparation can be selected depending on the addition timing or the addition step. Note that, for these enzyme preparations, a single type of the enzyme preparation may be used alone, or two or more types of the enzyme preparations may be used in combination. Examples of the enzyme preparation also include an enzyme preparation classified in “(3) Following Enzyme Preparations Added during Brewing Step for Purpose of Rationalization of Brewing and the like” in Article 3 “7. Articles not Handled as Raw Materials for Alcoholic Beverages” of the Notice on the Liquor Tax Act and the Administrative Ordinance Related to Alcoholic Beverages (revised on Jun. 27, 2018).

Adding these enzymatic agents can efficiently adjust the component composition of the resulting beer-taste beverage. As the various raw materials other than malt, there may be added various additives such as an assimilable sugar such as glucose, sucrose, and maltose, hops, a preservative, a sweetener, an water-soluble dietary fiber, a bittering agent or a bitterness imparting agent, an antioxidant, a flavor, an acidulant, and a pigment. The enzyme preparation and the various raw materials may be added before the saccharification treatment, may be added during the saccharification treatment, or may be added after the saccharification treatment is completed. Moreover, these enzyme preparation and various raw materials may be added together with yeast before and after the fermentation in the subsequent step, that is, in the step (2), may be added during the fermentation, or may be added after the fermentation is completed.

A mixture of the various raw materials is heated to saccharify a starchy component of the raw materials, and thus, the saccharification treatment is performed.

The temperature and the time of the saccharification treatment is preferably appropriately adjusted in view of the type of the malt used, the malt proportion, the raw materials besides water and malt, the type and the amount of the enzyme used, and the alcohol strength of the finally obtained beverage, for example. In an aspect of the present invention, from the viewpoint of adjusting the alcohol strength of the beer-taste beverage to the above range, the temperature of the saccharification treatment is preferably from 55 to 75 °C, and the time of the saccharification, treatment is preferably from 30 to 240 minutes.

Furthermore, the saccharified liquid is preferably subjected to the boiling treatment.

In case where the hops, the bittering agent, and the like are used as the raw materials, they are added preferably at the time when this boiling treatment is carried out. The hops, the bittering agent, and the like may be added between the start of boiling the saccharified liquid and before the end of boiling the saccharified liquid.

After the boiling treatment is completed, preferably, the liquid is transferred to whirlpool and cooled to 0 to 25 °C and a cooled liquid is obtained, and thus, a treatment for removing a solid content such as coagulated protein is carried out. In this way, the pre-fermentation liquid is prepared.

Note that in this step, there may be performed filtration through a filter having a predetermined pore diameter (e.g., a pore diameter less than 30 μm) to perform the treatment for removing a solid content.

In place of the saccharified liquid, malt extract to which hot water has been added may be used, and to the malt extract, hops, the bittering agent and the like may be added, and thus, the resultant mixture may be subjected to the boiling treatment to prepare a pre-fermentation liquid.

When no malt is used or an limited amount of malt is used as one of the various raw materials, a liquid sugar that contains a carbon source, a nitrogen source as an amino acid-containing raw material other than cereal grain or malt, hops, a dietary fiber, a preservative, a sweetener, an antioxidant, a bitterness imparting agent, a flavor, an acidulant, a pigment, and the like are mixed with hot water to prepare a liquid sugar solution, and this liquid sugar solution may be subjected to the boiling treatment to prepare a pre-fermentation liquid.

In the case of using hops, the hops may be added before the boiling treatment or may be added between the start of boiling the liquid sugar solution and before the end of boiling the liquid sugar solution.

### C2.1.2 Step (2)

The step (2) is a step of adding yeast to the pre-fermentation liquid obtained in the step (1) and subjecting the pre-fermentation liquid to fermentation.

The yeast used in this step can be appropriately selected in view of the type of the fermented beverage to be produced, the target flavor, and the fermentation conditions, for example, and top-fermenting yeast may be used, or bottom-fermenting yeast may be used.

The yeast in the form of a yeast suspension may be directly added to the raw materials, or a slurry produced by concentrating the yeast by centrifugation or sedimentation may be added to the pre-fermentation liquid. Alternatively, a material obtained by completely removing the supernatant after the centrifugation may be added. The amount of the yeast to be added to the beverage can be appropriately set, and is, for example, in a range from about 5×10⁶ cells/mL to 1×10⁸ cells/mL.

Although the fermentation conditions in the fermentation can be set as appropriate, the fermentation temperature is for example from 5 to 30 °C, preferably from 5 to 25 °C, from the viewpoint of adjusting the alcohol strength of the beer-taste beverage to the range described above. In addition, the alcohol strength of the beer-taste beverage can be adjusted by appropriately setting the type of enzyme, the addition amount of enzyme, and the timing for enzyme addition listed in the above section “2.2.1 Step (1)”, and the temperature (temperature increase or temperature decrease) or the pressure of the fermentation liquid may be changed during the fermentation step as necessary. Aging may be performed after the fermentation, and the aging conditions at the time of performing the aging can be appropriately set, but from the viewpoint of being adjusted to a desired flavor, the aging temperature is, for example, from 5 to 30 °C, preferably from 5 to 25 °C. A container for the aging may be, for example, a stainless tank or a wooden barrel.

In addition, after the fermentation, a filtration treatment for removing yeast in the beer-taste beverage may be performed, or the filtration treatment may not be performed. In addition, water or the above-described various additives may be added as necessary.

The beer-taste beverage according to an aspect of the present invention thus obtained undergoes a sterilization treatment as necessary, and then is filled in a predetermined container, and distributed to the market as a product.

The method of packaging the beer-taste beverage is not particularly limited, and a packaging method known to those skilled in the art can be used. Through the packaging step, the beer-taste beverage according to the present invention is filled and sealed in the container. In the packaging step, any container of any form/material may be used, and examples of the container are as described above.

### C2.2 Method for Producing Non-Fermented Beer-Taste Beverage

When the beer-taste beverage according to one aspect of the present invention is a non-fermented beer-taste beverage, the beverage can be produced by a typical method for producing a non-fermented beer-taste beverage. Specific examples of the method for producing a non-fermented beer-taste beverage according to one aspect of the present invention include a method including the following steps (a) to (c):
step (a): a step of, to a raw material, performing at least one treatment of the group of a saccharification treatment, a boiling treatment, and a solid content removal treatment and thus, yielding a pre-beverage liquid.
step (b): a step of cooling the pre-beverage liquid obtained in step (a) and adding carbon dioxide gas.

The step (a) is the same as the step of yielding the pre-fermentation liquid of the step (1) in the “method for producing a fermented beer-taste beverage” described above.

As a method for adding carbon dioxide gas in the step (b), carbon dioxide gas may be added by mixing a cooled pre-fermentation liquid obtained by cooling the pre-fermentation liquid obtained in the step (a) with carbonated water, or carbon dioxide gas may be directly added to the cooled, fermented beverage. At the same timing as the step (b), an additive such as a preservative, a sweetener, a flavoring agent, an acidulant, and a pigment may be added as necessary in adding carbon dioxide gas.

When the non-fermented beer-taste beverage is produced as an alcohol-containing non-fermented beer-taste beverage, the following step (c) is included.
step (c): a step of blending an alcohol component at least after the step (a).

The step (c) needs to be performed at least after the step (a), and, for example, can be performed at one or more timings of any of the following (I) to (III).
(I): Between the step (a) and the step (b)
(II): At the same time as the step (b)
(III): After the step (b)

Among these, the step (c) is preferably performed after the pre-fermentation liquid obtained in the step (a) is cooled to adjust a cooled, fermented beverage and before carbon dioxide gas is added.

As the alcohol component blended in the step (c), spirits (a distilled liquor) derived from the above-described grain is preferable.

The non-fermented beer-taste beverage thus produced is filled in a predetermined container and distributed to the market as a product.

The method for packaging a non-fermented beer-taste beverage is not particularly limited, and a packaging method known to those skilled in the art can be used. Through the packaging step, the non-fermented beer-taste beverage is filled and sealed in the container. In the packaging step, any container of any form/material may be used, and examples of the container are as described above.

### 3. Method for Improving Flavor of Beer-Taste Beverage

The present invention also discloses a method for improving a flavor of a beer-taste beverage. Specific aspects of the method for improving a flavor according to the present invention will be described in detail in the following aspects A to C.

### <<Aspect A: Corresponding to JP 2023-100223>>

### A3. Method for Improving Flavor of Beer-Taste Beverage

The method for improving a flavor of a beer-taste beverage according to an aspect of the present invention includes at least the following operation (I) and operation (II).
operation (I): an operation of adjusting an alcohol strength to 8.0 (v/v) % or more
operation (II): an operation of checking and/or adjusting an isoamyl alcohol content and a content ratio between isoamyl alcohol and ethyl acetate such that the isoamyl alcohol content is 110 ppm by mass or more, and Formula (1) shown below is satisfied.

X1/Y1≥2.00 :Formula (1)

[wherein, X1 represents the isoamyl alcohol content (unit: ppm by mass), and Y1 represents an ethyl acetate content (unit: ppm by mass).]

The operation (I) and the operation (II) correspond to the step (I) and the step (II) in the method for producing a beer-taste beverage described above, respectively. For the beer-taste beverage having the alcohol strength adjusted to 8.0 (v/v) % or more through the operation (I), the isoamyl alcohol content and the content ratio between isoamyl alcohol and ethyl acetate are each adjusted to predetermined ranges through the operation (II), and thus, the rich aroma can be improved, and the excessive sensation of irritation from alcohol can be suppressed.

In the method for improving a flavor according to an aspect of the present invention, a beverage serving as a reference for flavor improvement is a beer-taste beverage prepared without performing the operation (II). That is, in the method for improving a flavor according to an aspect of the present invention, it is sufficient that the beer-taste beverage prepared by performing both the operation (I) and the operation (II) is more improved in rich aroma and/or excessive sensation of irritation from alcohol, as compared with the beer-taste beverage prepared without performing the operation (II). In addition, in the method for improving a flavor according to an aspect of the present invention, the beverage serving as a reference for flavor improvement may be a beverage having an isoamyl alcohol content of less than 110 ppb by mass, and in the beverage as a reference, X1/Y1 in Formula (1) may be smaller than 2.00.

Suitable ranges of the alcohol strength, the isoamyl alcohol content, and the content ratio between isoamyl alcohol and ethyl acetate, and the various properties, the various components and the contents thereof, and the like of the beer-taste beverage are as described above in “A1. Beer-taste beverage”.

### <<Aspect B: Corresponding to JP 2023-100225>>

### B3. Method for Improving Flavor of Beer-Taste Beverage

The method for improving a flavor of a beer-taste beverage according to an aspect of the present invention includes at least the following operation (I) and operation (II).
operation (I): an operation of adjusting an alcohol strength to 8.0 (v/v) % or more
Operation (II): an operation of checking and/or adjusting a succinic acid content and a content ratio between succinic acid and acetic acid such that the succinic acid content is 110 ppm by mass or more and 1100 ppm by mass or less, and the Formula (1A) shown below is satisfied.

X1/Y1≥0.25 :Formula (1A)

[In Formula (1A), X1 represents the succinic acid content (unit: ppm by mass), and Y1 represents an acetic acid content (unit: ppm by mass).]

The operation (I) and the operation (II) correspond to the step (I) and the step (II) in the method for producing a beer-taste beverage described above, respectively. For the beer-taste beverage having an alcohol strength adjusted to 8.0 (v/v) % or more through the operation (I), the succinic acid content and the content ratio between succinic acid and acetic acid are each adjusted to predetermined ranges through the operation (II), and thus, a beer-taste beverage having a clean taste and mild sourness can be provided.

In the method for improving a flavor according to an aspect of the present invention, a beverage serving as a reference for flavor improvement is a beer-taste beverage prepared without performing the operation (II). That is, in the method for improving a flavor according to an aspect of the present invention, it is sufficient that the beer-taste beverage prepared by performing both the operation (I) and the operation (II) is more improved in clean taste and/or mild sourness, as compared with the beer-taste beverage prepared without performing the operation (II). In addition, in the method for improving a flavor according to an aspect of the present invention, the beverage serving as a reference for flavor improvement may be a beverage having a succinic acid content of less than 110 ppb by mass or more than 1100 ppb by mass, and in the beverage as a reference, X1/Y1 in Formula (1A) may be smaller than 0.25.

Suitable ranges of the alcohol strength, the succinic acid content, and the content ratio between succinic acid and acetic acid, and the various properties, the various components and the contents thereof, and the like of the beer-taste beverage are as described above in “B1. Beer-taste beverage”.

### <<Aspect C: Corresponding to JP 2023-100227>

### C3. Method for Improving Flavor of Beer-Taste Beverage

The method for improving a flavor of a beer-taste beverage according to an aspect of the present invention includes at least the following operation (I) and operation (II).
operation (I): an operation of adjusting an alcohol strength to 10.0 (v/v) % or more
operation (II): an operation of checking and/or adjusting an ethyl acetate content and an isoamyl acetate content such that the ethyl acetate content is 50 ppm by mass or more and the isoamyl acetate content is 3 ppm by mass or more.

A method for improving a flavor of a beer-taste beverage according to another aspect of the present invention includes at least the following operation (A) and operation (B).
operation (A): an operation of adjusting an alcohol strength to 12.0 (v/v) %
operation (B): an operation of checking and/or adjusting an ethyl acetate content such that the ethyl acetate content is 50 ppm by mass or more.

The operation (I) and the operation (II) correspond to the step (I) and the step (II) in the method for producing a beer-taste beverage described above, respectively. The operation (A) and the operation (B) correspond to the step (A) and the step (B) in the method for producing a beer-taste beverage described above, respectively. For the beer-taste beverage having an alcohol strength adjusted to 10.0 (v/v) % or more or 12.0 (v/v) % or more through the operation (I) or the operation (A), the ethyl acetate content and/or the isoamyl acetate content are each adjusted to predetermined ranges through the operation (II) or the operation (B), and thus, the rich aroma can be improved, and the excessive sensation of irritation from alcohol can be suppressed.

In the method for improving a flavor according to an aspect of the present invention, a beverage serving as a reference for flavor improvement is a beer-taste beverage prepared without performing the operation (II) or the operation (B). That is, in the method for improving a flavor according to an aspect of the present invention, it is sufficient that the beer-taste beverage prepared by performing both the operation (I) and the operation (II) or both the operation (A) and the operation (B) is more improved in aroma richness and/or excessive sensation of irritation from alcohol, as compared with the beer-taste beverage prepared without performing the operation (I) or the operation (B). In the method for improving a flavor according to an aspect of the present invention, the beverage serving as a reference for flavor improvement may be a beverage having an ethyl acetate content of less than 50 ppm by mass and an isoamyl acetate content of less than 3 ppm by mass, or a beverage having an ethyl acetate content of less than 50 ppm by mass.

Suitable ranges of the alcohol strength, the ethyl acetate content, and the isoamyl acetate content, and the various properties, the various components and the contents thereof, and the like of the beer-taste beverage are as described above in “C1. Beer-taste beverage”.

### 4. Beer-Taste Stock Solution

The present invention discloses a beer-taste stock solution having an alcohol strength of 8.00 (v/v) % or more. Specific aspects of the beer-taste stock solution according to the present invention will be described in detail in the following aspects A to C.

### <<Aspect A: Corresponding to JP 2023-100223>

### A4. Beer-Taste Stock Solution

The present invention also provides a beer-taste stock solution having an alcohol strength of 8.00 (v/v) % or more, having an isoamyl alcohol content of 110 ppm by mass or more, and satisfying Formula (1) shown below.

X1/Y1≥2.00 :Formula (1)

[wherein, X1 represents the isoamyl alcohol content (unit: ppm by mass), and Y1 represents an ethyl acetate content (unit: ppm by mass).]

The beer-taste stock solution according to the present invention is a stock solution useful for producing a beer-taste beverage in which excessive sensation of irritation from alcohol is suppressed and a good rich aroma is obtained.

As used herein, the term “beer-taste stock solution” refers to an edible solution for producing a beer-taste beverage by mixing such stock solution with an edible aqueous solution, and is not a solution intended for direct consumption. The beer-taste stock solution is not particularly limited as long as the stock solution is a liquid that can produce the beer-taste beverage by mixing such stock solution with the edible aqueous solution.

As used herein, the term “edible aqueous solution” refers to water or a solution in which one or more edible components are dissolved in water. The edible component is not particularly limited, and may be a solid such as ice or dry ice, a liquid such as vegetable oil, alcoholic liquors containing alcohol, or fruit juice, or a gas such as carbon dioxide gas or nitrogen gas.

The edible aqueous solution used to be mixed with the beer-taste stock solution according to the present invention is not particularly limited, and there can be used, for example, water, a sparkling aqueous solution such as a carbonated soft drink, Ramune, cola, carbonated water, chu-hai, hard seltzer, highball, an alcohol-containing beer-taste beverage, a non-alcoholic beer-taste beverage, cider, and champagne, and a non-sparkling aqueous solution such as a soft drink, tea, black tea, coffee, sake, shochu, wine, fruit liquor, gin, vodka, whiskey, rum, brandy, tequila, and a flavor-containing syrup (including a concentrate). The sparkling aqueous solution is preferable, an aqueous solution that contains carbon dioxide is more preferable, a carbonated beverage is more preferable, and the carbonated water is particularly preferable.

The carbon dioxide gas concentration in the edible aqueous solution according to the present invention is preferably 0.30 (w/w) % or more, more preferably 0.35 (w/w) % or more, still more preferably 0.40 (w/w) % or more, even more preferably 0.42 (w/w) % or more, particularly preferably 0.45 (w/w) % or more, and is preferably 0.90 (w/w) % or less, and may be 0.80 (w/w) % or less, 0.70 (w/w) % or less, 0.6 (w/w) or less, or 0.55 (w/w) % or less.

The beer-taste stock solution according to an aspect of the present invention is preferably a stock solution for two-fold to ten-fold dilution, but the beer-taste stock solution may be diluted to threefold or more, fourfold or more, fivefold or more, sixfold or more, sevenfold or more, eightfold or more, ninefold or more, or tenfold or more, and the beer-taste stock solution may be diluted to ninefold or less, eightfold or less, sevenfold or less, sixfold or less, fivefold or less, fourfold or less, threefold or less, or twofold or less.

An aspect of the present invention is a beer-taste beverage produced by mixing the edible aqueous solution with the beer-taste stock solution according to an aspect of the present invention.

An aspect of the present invention is a method for producing a beer-taste beverage, the method including mixing the edible aqueous solution with the beer-taste stock solution according to an aspect of the present invention.

An aspect of the present invention is a beer-taste stock solution for use in the production of the beer-taste beverage according to an aspect of the present invention.

The beer-taste stock solution according to one aspect of the present invention is suitable for an aspect of packaging in a container. Examples of the container include bottles, plastic bottles, cans (including bottle cans) or barrels. Examples of the container of a preferred aspect include a reclosable container. Specific examples thereof include reclosable bottles, reclosable plastic bottles, reclosable cans (e.g., reclosable bottle cans), and re-stoppable barrels.

Regarding various properties, various components and contents thereof of the beer-taste stock solution, and a method for producing the beer-taste stock solution, a method for improving a flavor of the beer-taste stock solution, and the like, the contents described in the above-described “A1. Beer-taste beverage”, “A2. Method for producing beer-taste beverage”, and “A3. Method for improving flavor of beer-taste beverage” are also applicable to this aspect, and thus, these descriptions can be referred to.

### <<Aspect B: Corresponding to JP 2023-100225>>

### B4. Beer-Taste Stock Solution

The present invention also provides a beer-taste stock solution having an alcohol strength of 8.00 (v/v) % or more and a succinic acid content of 110 ppm by mass or more and 1100 ppm by mass or less, and satisfying Formula (1A) shown below.

X1/Y1≥0.25 :Formula (1A)

[In Formula (1A), X1 represents the succinic acid content (unit: ppm by mass), and Y1 represents an acetic acid content (unit: ppm by mass).]

The beer-taste stock solution according to the present invention is a stock solution useful for producing a beer-taste beverage having a clean taste and mild sourness.

As used herein, the term “beer-taste stock solution” refers to an edible solution for producing a beer-taste beverage by mixing such stock solution with an edible aqueous solution, and is not a solution intended for direct consumption. The beer-taste stock solution is not particularly limited as long as the stock solution is a liquid that can produce the beer-taste beverage by mixing such stock solution with the edible aqueous solution.

As used herein, the term “edible aqueous solution” refers to water or a solution in which one or more edible components are dissolved in water. The edible component is not particularly limited, and may be a solid such as ice or dry ice, a liquid such as vegetable oil, alcoholic liquors containing alcohol, or fruit juice, or a gas such as carbon dioxide gas or nitrogen gas.

The edible aqueous solution used to be mixed with the beer-taste stock solution according to the present invention is not particularly limited, and there can be used, for example, water, a sparkling aqueous solution such as a carbonated soft drink, Ramune, cola, carbonated water, chu-hai, hard seltzer, highball, an alcohol-containing beer-taste beverage, a non-alcoholic beer-taste beverage, cider, and champagne, and a non-sparkling aqueous solution such as a soft drink, tea, black tea, coffee, sake, shochu, wine, fruit liquor, gin, vodka, whiskey, rum, brandy, tequila, and a flavor-containing syrup (including a concentrate). The sparkling aqueous solution is preferable, an aqueous solution that contains carbon dioxide is more preferable, a carbonated beverage is more preferable, and the carbonated water is particularly preferable.

The carbon dioxide gas concentration in the edible aqueous solution according to the present invention is preferably 0.30 (w/w) % or more, more preferably 0.35 (w/w) % or more, still more preferably 0.40 (w/w) % or more, even more preferably 0.42 (w/w) % or more, particularly preferably 0.45 (w/w) % or more, and is preferably 0.90 (w/w) % or less, and may be 0.80 (w/w) % or less, 0.70 (w/w) % or less, 0.6 (w/w) or less, or 0.55 (w/w) % or less.

The beer-taste stock solution according to an aspect of the present invention is preferably a stock solution for two-fold to ten-fold dilution, but the beer-taste stock solution may be diluted to threefold or more, fourfold or more, fivefold or more, sixfold or more, sevenfold or more, eightfold or more, ninefold or more, or tenfold or more, and the beer-taste stock solution may be diluted to ninefold or less, eightfold or less, sevenfold or less, sixfold or less, fivefold or less, fourfold or less, threefold or less, or twofold or less.

An aspect of the present invention is a beer-taste beverage produced by mixing the edible aqueous solution with the beer-taste stock solution according to an aspect of the present invention.

An aspect of the present invention is a method for producing a beer-taste beverage, the method including mixing the edible aqueous solution with the beer-taste stock solution according to an aspect of the present invention.

An aspect of the present invention is a beer-taste stock solution for use in the production of the beer-taste beverage according to an aspect of the present invention.

The beer-taste stock solution according to one aspect of the present invention is suitable for an aspect of packaging in a container. Examples of the container include bottles, plastic bottles, cans (including bottle cans) or barrels. Examples of the container of a preferred aspect include a reclosable container. Specific examples thereof include reclosable bottles, reclosable plastic bottles, reclosable cans (e.g., reclosable bottle cans), and re-stoppable barrels.

Regarding various properties, various components and contents thereof of the beer-taste stock solution, and a method for producing the beer-taste stock solution, a method for improving a flavor of the beer-taste stock solution, and the like, the contents described in the above-described “B1. Beer-taste beverage”, “B2. Method for producing beer-taste beverage”, and “B3. Method for Improving flavor of beer-taste beverage” are also applicable to this aspect, and thus, these descriptions can be referred to.

### <<Aspect C: Corresponding to JP 2023-100227>>

### C4. Beer-Taste Stock Solution

The present invention also provides a beer-taste stock solution having an alcohol strength of 10.00 (v/v) % or more, an ethyl acetate content of 50 ppm by mass or more, and an isoamyl acetate content of 3 ppm by mass or more.

The present invention also provides a beer-taste stock solution having an alcohol strength of 12.0 (v/v) % or more and an ethyl acetate content of 50 ppm by mass or more.

The beer-taste stock solution according to the present invention is a stock solution useful for producing a beer-taste beverage in which excessive sensation of irritation from alcohol is suppressed and a good rich aroma is obtained.

As used herein, the term “beer-taste stock solution” refers to an edible solution for producing a beer-taste beverage by mixing such stock solution with an edible aqueous solution, and is not a solution intended for direct consumption. The beer-taste stock solution is not particularly limited as long as the stock solution is a liquid that can produce the beer-taste beverage by mixing such stock solution with the edible aqueous solution.

As used herein, the term “edible aqueous solution” refers to water or a solution in which one or more edible components are dissolved in water. The edible component is not particularly limited, and may be a solid such as ice or dry ice, a liquid such as vegetable oil, alcoholic liquors containing alcohol, or fruit juice, or a gas such as carbon dioxide gas or nitrogen gas.

The edible aqueous solution used to be mixed with the beer-taste stock solution according to the present invention is not particularly limited, and there can be used, for example, water, a sparkling aqueous solution such as a carbonated soft drink, Ramune, cola, carbonated water, chu-hai, hard seltzer, highball, an alcohol-containing beer-taste beverage, a non-alcoholic beer-taste beverage, cider, and champagne, and a non-sparkling aqueous solution such as a soft drink, tea, black tea, coffee, sake, shochu, wine, fruit liquor, gin, vodka, whiskey, rum, brandy, tequila, and a flavor-containing syrup (including a concentrate). The sparkling aqueous solution is preferable, an aqueous solution that contains carbon dioxide is more preferable, a carbonated beverage is more preferable, and the carbonated water is particularly preferable.

The carbon dioxide gas concentration in the edible aqueous solution according to the present invention is preferably 0.30 (w/w) % or more, more preferably 0.35 (w/w) % or more, still more preferably 0.40 (w/w) % or more, even more preferably 0.42 (w/w) % or more, particularly preferably 0.45 (w/w) % or more, and is preferably 0.90 (w/w) % or less, and may be 0.80 (w/w) % or less, 0.70 (w/w) % or less, 0.6 (w/w) or less, or 0.55 (w/w) % or less.

The beer-taste stock solution according to an aspect of the present invention is preferably a stock solution for two-fold to ten-fold dilution, but the beer-taste stock solution may be diluted to threefold or more, fourfold or more, fivefold or more, sixfold or more, sevenfold or more, eightfold or more, ninefold or more, or tenfold or more, and the beer-taste stock solution may be diluted to ninefold or less, eightfold or less, sevenfold or less, sixfold or less, fivefold or less, fourfold or less, threefold or less, or twofold or less.

An aspect of the present invention is a beer-taste beverage produced by mixing the edible aqueous solution with the beer-taste stock solution according to an aspect of the present invention.

An aspect of the present invention is a method for producing a beer-taste beverage, the method including mixing the edible aqueous solution with the beer-taste stock solution according to an aspect of the present invention.

An aspect of the present invention is a beer-taste stock solution for use in the production of the beer-taste beverage according to an aspect of the present invention.

The beer-taste stock solution according to one aspect of the present invention is suitable for an aspect of packaging in a container. Examples of the container include bottles, plastic bottles, cans (including bottle cans) or barrels. Examples of the container of a preferred aspect include a reclosable container. Specific examples thereof include reclosable bottles, reclosable plastic bottles, reclosable cans (e.g., reclosable bottle cans), and re-stoppable barrels.

Regarding various properties, various components and contents thereof of the beer-taste stock solution, and a method for producing the beer-taste stock solution, a method for improving a flavor of the beer-taste stock solution, and the like, the contents described in the above-described “C1. Beer-taste beverage”, “C2. Method for producing beer-taste beverage”, and “C3. Method for Improving flavor of beer-taste beverage” are also applicable to this aspect, and thus, these descriptions can be referred to.

### EXAMPLES

Hereinafter, the present invention will be described in more detail by Examples and the like, but the present invention is not limited by these Examples.

### Examples A1 to A24 and Comparative Examples A1 to A12

### <Preparation of Beer-Taste Beverage>

Milled barley malt was fed into a mashing tank containing 120 L of hot water, and afterward, the temperature was increased stepwise and maintained, followed by filtration to remove brewer's spent grain and the like, and thus, a saccharified liquid was obtained. After the filtration, the saccharified liquid, a sugar solution, and hops were fed into a boiling pot and the resulting mixture was adjusted to 100 L with hot water, and a hot wort was obtained. The resultant hot wort was cooled, and aeration with oxygen was performed, and thus, 60 L of a pre-fermentation liquid before yeast addition was obtained.

Beer yeast (top-fermenting yeast) was added to the obtained pre-fermentation liquid, and a fermentation temperature and a fermentation time were adjusted, alcoholic fermentation was performed so that the alcohol strength reaches a predetermined alcohol strength, and thus, the yeast was removed by filtration to prepare a beer-taste beverage.

In addition to the adjustment of the above production conditions, in each of Examples and Comparative Examples, the contents of isoamyl alcohol, n-propanol, isobutanol, phenethyl alcohol, ethyl acetate, isoamyl acetate, ethyl caproate, and ethyl octanoate were adjusted respectively to the values shown in Tables 1 to 3, by adding any of these purified products as necessary. In Tables 1 to 3, the description of “A” at the beginning of the Example number and the Comparative Example number is omitted.

### <Sensory Evaluation>

The obtained beer-taste beverages were cooled to about 4 °C, and six panelists who had received daily training tasted the beverages and evaluated for evaluation items of “Aroma richness suitable for beer-taste beverage” and “Excessive sensation of irritation unsuitable for beer-taste beverage” as follows.

That is, based on the following score criteria, the beverages were rated with scores in increments of 0.1 in the range from 1.0 (minimum value) to 3.0 (maximum value), and the respective average values of the scores by the six panelists were calculated.

In the evaluation, samples, each corresponding to each of the evaluation items of the following criteria of “1.0”, “1.5”, “2.0”, “2.5”, and “3.0”, were prepared in advance, and uniformity of standards among the panelists was attempted. Also, in sensory evaluation of all Examples and Comparative Examples, no difference of 0.2 or more in the score values among the panelists was confirmed. Note that, there was no panelist who gave a score less than 2.0 for Examples with overall evaluation of “A” or “B”.

### [Excessive Sensation of Irritation Unsuitable for Beer-Taste Beverage]

“3.0”: Excessive sensation of irritation unsuitable for beer-taste beverages is not felt at all.
“2.5”: Excessive sensation of irritation unsuitable for beer-taste beverages is hardly felt.
“2.0”: Excessive sensation of irritation unsuitable for beer-taste beverages is not felt much.
“1.5”: Excessive sensation of irritation unsuitable for beer-taste beverages is felt.
“1.0”: Excessive sensation of irritation unsuitable for beer-taste beverages is strongly felt.

### [Aroma Richness Suitable for Beer-Taste Beverage]

“3.0”: Aroma richness suitable for beer-taste beverages is very strongly felt.
“2.5”: Aroma richness suitable for beer-taste beverages is strongly felt.
“2.0”: Aroma richness suitable for beer-taste beverages is sufficiently felt.
“1.5”: Aroma richness suitable for beer-taste beverages is hardly felt.
“1.0”: Aroma richness suitable for beer-taste beverages is not felt at all.

### [Overall Evaluation]

“A”: All of the average scores of the two verified sensory evaluation items are 2.5 or more.
“B”: Not corresponding to “A” or “C”.
“C”: At least one of the average scores of the two verified sensory evaluation items is less than 2.0.

TABLE 1

| | | | Comparative | Comparative | Comparative | Comparative | Example | Example | Example | Example | Example | Example | Example | Example |
|---|---|---|---|---|---|---|---|---|---|---|---|---|---|---|
| | | | Example 1 | Example 2 | Example 3 | Example 4 | 1 | 2 | 3 | 4 | 5 | 6 | 7 | 8 |
| Composition | Alcohol strength | v/v % | 19 | 19 | 19 | 19 | 19 | 19 | 19 | 19 | 19 | 19 | 19 | 19 |
| and properties | Ethyl acetate (Y1) | ppm by | 29 | 60 | 90 | 90 | 60 | 29 | 63 | 90 | 29 | 29 | 63 | 90 |
| of beer-taste | | mass | | | | | | | | | | | | |
| beverage | Isoamyl acetate (Y2) | ppm by | 3 | 4 | 4 | 6 | 5 | 3 | 4 | 6 | 3 | 3 | 4 | 6 |
| | | mass | | | | | | | | | | | | |
| | Ethyl caproate (Y3) | ppb by | 199 | 297 | 213 | 401 | 401 | 199 | 308 | 401 | 199 | 199 | 308 | 401 |
| | | mass | | | | | | | | | | | | |
| | Ethyl octanoate (Y4) | ppb by | 259 | 364 | 259 | 490 | 490 | 259 | 376 | 490 | 259 | 259 | 376 | 490 |
| | | mass | | | | | | | | | | | | |
| | Isoamyl alcohol | ppm by | 100 | 100 | 100 | 160 | 160 | 160 | 293 | 293 | 300 | 500 | 500 | 500 |
| | (X1) | mass | | | | | | | | | | | | |
| | n-propanol (X2) | ppm by | 39 | 39 | 39 | 55 | 55 | 55 | 92 | 92 | 93 | 147 | 147 | 147 |
| | | mass | | | | | | | | | | | | |
| | Isobutanol (X3) | ppm by | 85 | 37 | 37 | 55 | 55 | 85 | 97 | 97 | 124 | 93 | 160 | 160 |
| | | mass | | | | | | | | | | | | |
| | Phenethyl alcohol | ppm by | 17 | 17 | 17 | 32 | 32 | 32 | 67 | 67 | 68 | 120 | 120 | 120 |
| | (X4) | mass | | | | | | | | | | | | |
| | X1/Y1 | — | 3.40 | 1.67 | 1.11 | 1.78 | 2.65 | 5.45 | 4.63 | 3.26 | 10.2 | 17.02 | 7.88 | 5.56 |
| | X2/Y1 | — | 1.34 | 0.65 | 0.44 | 0.61 | 0.91 | 1.89 | 1.44 | 1.02 | 3.18 | 5.02 | 2.32 | 1.64 |
| | X3/Y1 | — | 2.91 | 0.62 | 0.42 | 0.61 | 0.91 | 2.91 | 1.53 | 1.08 | 4.21 | 3.16 | 2.53 | 1.78 |
| | X4/Y1 | — | 0.57 | 0.28 | 0.19 | 0.35 | 0.53 | 1.10 | 1.05 | 0.74 | 2.33 | 4.09 | 1.89 | 1.33 |
| | Total content (ppm | — | 7.30 | 3.00 | 2.04 | 3.11 | 4.57 | 10.1 | 8.06 | 5.64 | 17.7 | 26.0 | 13.6 | 9.55 |
| | by mass) of X1 to | | | | | | | | | | | | | |
| | X4/Y1 to Y4 | | | | | | | | | | | | | |
| | (X1/alcohol strength | — | 5.26 | 5.26 | 5.26 | 8.42 | 8.42 | 8.42 | 15.4 | 15.4 | 15.8 | 26.3 | 26.3 | 26.3 |
| | Y1/alcohol strength | — | 1.55 | 3.16 | 4.74 | 4.74 | 3.18 | 1.55 | 3.34 | 4.74 | 1.55 | 1.55 | 3.34 | 4.74 |

| | | | | | | | | | | | | | |
|---|---|---|---|---|---|---|---|---|---|---|---|---|---|
| Sensory | Excessive sensation of | 1.5 | 1.5 | 1.5 | 2.0 | 2.0 | 2.0 | 2.5 | 2.5 | 2.5 | 3.0 | 3.0 | 3.0 |
| evaluation | irritation unsuitable for beer- | | | | | | | | | | | | |
| | taste beverage | | | | | | | | | | | | |
| | Aroma richness suitable for | 2.5 | 1.5 | 1.5 | 1.5 | 2.0 | 3.0 | 3.0 | 2.5 | 3.0 | 3.0 | 3.0 | 3.0 |
| | beer-taste beverage | | | | | | | | | | | | |
| | Overall evaluation | C | C | C | C | B | B | A | A | A | A | A | A |

TABLE 2

| | | | Comparative | Comparative | Comparative | Comparative | Example | Example | Example | Example | Example | Example | Example | Example |
|---|---|---|---|---|---|---|---|---|---|---|---|---|---|---|
| | | | Example 5 | Example 6 | Example 7 | Example 8 | 9 | 10 | 11 | 12 | 13 | 14 | 15 | 16 |
| Composition | Alcohol strength | v/v % | 10 | 10 | 10 | 10 | 10 | 10 | 10 | 10 | 10 | 10 | 10 | 10 |
| and | Ethyl acetate (Y1) | ppm by | 29 | 60 | 90 | 90 | 60 | 29 | 63 | 90 | 29 | 29 | 63 | 90 |
| properties of | | mass | | | | | | | | | | | | |
| beer-taste | Isoamyl acetate (Y2) | ppm by | 3 | 4 | 4 | 6 | 5 | 3 | 4 | 6 | 3 | 3 | 4 | 6 |
| beverage | | mass | | | | | | | | | | | | |
| | Ethyl caproate (Y3) | ppb by | 199 | 297 | 213 | 401 | 401 | 199 | 308 | 401 | 199 | 199 | 308 | 401 |
| | | mass | | | | | | | | | | | | |
| | Ethyl octanoate (Y4) | ppb by | 259 | 364 | 259 | 490 | 490 | 259 | 376 | 490 | 259 | 259 | 376 | 490 |
| | | mass | | | | | | | | | | | | |
| | Isoamyl alcohol | ppm by | 100 | 100 | 100 | 160 | 160 | 160 | 293 | 293 | 300 | 500 | 500 | 500 |
| | (X1) | mass | | | | | | | | | | | | |
| | n-propanol (X2) | ppm by | 39 | 39 | 39 | 55 | 55 | 55 | 92 | 92 | 93 | 147 | 147 | 147 |
| | | mass | | | | | | | | | | | | |
| | Isobutanol (X3) | ppm by | 85 | 37 | 37 | 55 | 55 | 85 | 97 | 97 | 124 | 93 | 160 | 160 |
| | | mass | | | | | | | | | | | | |
| | Phenethyl alcohol | ppm by | 17 | 17 | 17 | 32 | 32 | 32 | 67 | 67 | 68 | 120 | 120 | 120 |
| | (X4) | mass | | | | | | | | | | | | |
| | X1/Y1 | — | 3.40 | 1.67 | 1.11 | 1.78 | 2.65 | 5.45 | 4.63 | 3.26 | 10.21 | 17.02 | 7.88 | 5.56 |
| | X2/Y1 | — | 1.34 | 0.65 | 0.44 | 0.61 | 0.91 | 1.89 | 1.44 | 1.02 | 3.18 | 5.02 | 2.32 | 1.64 |
| | X3/Y1 | — | 2.91 | 0.62 | 0.42 | 0.61 | 0.91 | 2.91 | 1.53 | 1.08 | 4.21 | 3.16 | 2.53 | 1.78 |
| | X4/Y1 | — | 0.57 | 0.28 | 0.19 | 0.35 | 0.53 | 1.10 | 1.05 | 0.74 | 2.33 | 4.09 | 1.89 | 1.33 |
| | Total content (ppm | — | 7.30 | 3.00 | 2.04 | 3.11 | 4.57 | 10.1 | 8.06 | 5.6 | 17.7 | 26.0 | 13.6 | 9.55 |
| | by mass) of X1 to | | | | | | | | | | | | | |
| | X4/Y1 to Y4 | | | | | | | | | | | | | |
| | X1/alcohol strength | — | 10.0 | 10.0 | 10.0 | 16.0 | 16.0 | 16.0 | 29.3 | 29.3 | 30.0 | 50.0 | 50.0 | 50.0 |
| | Y1/alcohol strength | — | 2.94 | 6.00 | 9.00 | 9.00 | 6.04 | 2.94 | 6.34 | 9.00 | 2.94 | 2.94 | 6.34 | 9.00 |

| | | | | | | | | | | | | | |
|---|---|---|---|---|---|---|---|---|---|---|---|---|---|
| Sensory | Excessive sensation of | 1.5 | 1.5 | 1.5 | 2.0 | 2.0 | 2.0 | 2.5 | 2.5 | 2.5 | 3.0 | 3.0 | 3.0 |
| evaluation | irritation unsuitable for beer- | | | | | | | | | | | | |
| | taste beverage | | | | | | | | | | | | |
| | Aroma richness suitable for | 2.5 | 1.5 | 1.5 | 1.5 | 2.0 | 3.0 | 3.0 | 2.5 | 3.0 | 3.0 | 3.0 | 3.0 |
| | beer-taste beverage | | | | | | | | | | | | |
| | Overall evaluation | C | C | C | C | B | B | A | A | A | A | A | A |

TABLE 3

| | | | Comparative | Comparative | Comparative | Comparative | Example | Example | Example | Example | Example | Example | Example | Example |
|---|---|---|---|---|---|---|---|---|---|---|---|---|---|---|
| | | | Example 9 | Example 10 | Example 11 | Example 12 | 17 | 18 | 19 | 20 | 21 | 22 | 23 | 24 |
| Composition | Alcohol strength | v/v % | 25 | 25 | 25 | 25 | 25 | 25 | 25 | 25 | 25 | 25 | 25 | 25 |
| and | Ethyl acetate (Y1) | ppm by | 29 | 60 | 90 | 90 | 60 | 29 | 63 | 90 | 29 | 29 | 63 | 90 |
| properties of | | mass | | | | | | | | | | | | |
| beer-taste | Isoamyl acetate (Y2) | ppm by | 3 | 4 | 4 | 6 | 5 | 3 | 4 | 6 | 3 | 3 | 4 | 6 |
| beverage | | mass | | | | | | | | | | | | |
| | Ethyl caproate (Y3) | ppb by | 199 | 297 | 213 | 401 | 401 | 199 | 308 | 401 | 199 | 199 | 308 | 401 |
| | | mass | | | | | | | | | | | | |
| | Ethyl octanoate (Y4) | ppb by | 259 | 364 | 259 | 490 | 490 | 259 | 376 | 490 | 259 | 259 | 376 | 490 |
| | | mass | | | | | | | | | | | | |
| | Isoamyl alcohol | ppm by | 100 | 100 | 100 | 160 | 160 | 160 | 293 | 293 | 300 | 500 | 500 | 500 |
| | (X1) | mass | | | | | | | | | | | | |
| | n-propanol (X2) | ppm by | 39 | 39 | 39 | 55 | 55 | 55 | 92 | 92 | 93 | 147 | 147 | 147 |
| | | mass | | | | | | | | | | | | |
| | Isobutanol (X3) | ppm by | 85 | 37 | 37 | 55 | $5 | 85 | 97 | 97 | 124 | 93 | 160 | 160 |
| | | mass | | | | | | | | | | | | |
| | Phenethyl alcohol | ppm by | 17 | 17 | 17 | 32 | 32 | 32 | 67 | 67 | 68 | 120 | 120 | 120 |
| | (X4) | mass | | | | | | | | | | | | |
| | X1/Y1 | — | 3.40 | 1.67 | 1.11 | 1.78 | 2.65 | 5.45 | 4.63 | 3.26 | 10.21 | 17.02 | 7.88 | 5.56 |
| | X2/Y1 | — | 1.34 | 0.65 | 0.44 | 0.61 | 0.91 | 1.89 | 1.44 | 1.02 | 3.18 | 5.02 | 2.32 | 1.64 |
| | X3/Y1 | — | 2.91 | 0.62 | 0.42 | 0.61 | 0.91 | 2.9 | 1.53 | 1.08 | 4.21 | 3.16 | 2.53 | 1.78 |
| | X4/Y1 | — | 0.57 | 0.28 | 0.19 | 0.35 | 0.53 | 1.10 | 1.0 | 0.74 | 2.33 | 4.09 | 1.89 | 1.33 |
| | Total content (ppm | — | 7.30 | 3.00 | 2.0 | 3.11 | 4.57 | 10.1 | 8.06 | 5.64 | 17.7 | 26.0 | 13.6 | 9.55 |
| | by mass) of X1 to | | | | | | | | | | | | | |
| | X4/Y1 to Y4 | | | | | | | | | | | | | |
| | X1/alcohol strength | — | 4.00 | 4.00 | 4.00 | 6.40 | 6.40 | 6.40 | 11.7 | 11.7 | 12.0 | 20.0 | 20.0 | 20.0 |
| | Y1/alcohol strength | — | 1.18 | 2.40 | 3.60 | 3.60 | 2.42 | 1.18 | 2.54 | 3.60 | 1.18 | 1.18 | 2.54 | 3.60 |

| | | | | | | | | | | | | | |
|---|---|---|---|---|---|---|---|---|---|---|---|---|---|
| Sensory | Excessive sensation of | 1.5 | 1.5 | 1.5 | 2.5 | 2.0 | 2.5 | 3.0 | 2.5 | 2.5 | 2.5 | 3.0 | 2.5 |
| evaluation | irritation unsuitable for beer- | | | | | | | | | | | | |
| | taste beverage | | | | | | | | | | | | |
| | Aroma richness suitable for | 2.5 | 1.5 | 1.5 | 1.5 | 2.0 | 3.0 | 3.0 | 2.5 | 3.0 | 3.0 | 3.0 | 3.0 |
| | beer-taste beverage | | | | | | | | | | | | |
| | Overall evaluation | C | C | C | C | B | A | A | A | A | A | A | A |

### Examples A25 to A32 and Comparative Examples A13 to A16

### <Preparation of Beer-Taste Beverage>

In these Examples, the beer-taste beverages prepared in Examples A1 to A8 and Comparative Examples A1 to A4 described above were used as beer-taste stock solutions to be diluted. The respective beer-taste stock solutions were diluted fourfold with carbonated water to prepare beer-taste beverages of Examples A25 to A32 and Comparative Examples A13 to A16. The composition and properties of the obtained beer-taste beverages and the results of sensory evaluation are shown in Table 4. The sensory evaluation was performed in the same manner as that in Examples A1 to A24. In Table 4, the description of “A” at the beginning of the Example number and the Comparative Example number is omitted.

TABLE 4

| | | | Comparative | Comparative | Comparative | Comparative | Example | Example | Example | Example | Example | Example | Example | Example |
|---|---|---|---|---|---|---|---|---|---|---|---|---|---|---|
| | | | Example 13 | Example 14 | Example 15 | Example 16 | 25 | 26 | 27 | 28 | 29 | 30 | 31 | 32 |
| Composition | Alcohol strength | v/v % | 4.7 | 4.75 | 4.75 | 4.75 | 4.75 | 4.75 | 4.75 | 4.75 | 4.75 | 4.75 | 4.75 | 4.75 |
| and | Ethyl acetate (Y1) | ppm by | 7.3 | 15.0 | 22.5 | 22.5 | 15.1 | 7.3 | 15.9 | 22.5 | 7.3 | 7.3 | 15.9 | 22.5 |
| properties of | | mass | | | | | | | | | | | | |
| beer-taste | Isoamyl acetate (Y2) | ppm by | 0.8 | 1.0 | 1.1 | 1.6 | 1.2 | 0.8 | 1.0 | 1.6 | 0.8 | 0.8 | 1.0 | 1.6 |
| beverage | | mass | | | | | | | | | | | | |
| | Ethyl caproate (Y3) | ppb by | 50 | 74 | 53 | 100 | 100 | 50 | 77 | 100 | 50 | 50 | 77 | 100 |
| | | mass | | | | | | | | | | | | |
| | Ethyl octanoate (Y4) | ppb by | 65 | 91 | 65 | 123 | 123 | 65 | 94 | 123 | 65 | 65 | 94 | 123 |
| | | mass | | | | | | | | | | | | |
| | Isoamyl alcohol (X1) | ppm by | 25.0 | 25.0 | 25.0 | 40.0 | 40.0 | 40.0 | 73.4 | 73.4 | 75.0 | 125.0 | 125.0 | 125.0 |
| | | mass | | | | | | | | | | | | |
| | a-propanol (X2) | ppm by | 9.8 | 9.8 | 9.8 | 13.7 | 13.7 | 13.9 | 22.9 | 22.9 | 23.3 | 36.8 | 36.8 | 36.8 |
| | | mass | | | | | | | | | | | | |
| | Isobutanol (X3) | ppm by | 21.4 | 9.3 | 9.3 | 13.8 | 13.8 | 21.4 | 24.2 | 24.2 | 30.9 | 23.2 | 40.1 | 40.1 |
| | | mass | | | | | | | | | | | | |
| | Phenethyl alcohol (X4) | ppm by | 4.2 | 4.2 | 4.2 | 7.9 | 7.9 | 8.1 | 16.7 | 16.7 | 17.1 | 30.0 | 30.0 | 30.0 |
| | | mass | | | | | | | | | | | | |
| | X1/Y1 | — | 3.40 | 1.67 | 1.11 | 1.78 | 2.65 | 5.45 | 4.63 | 3.26 | 10.21 | 17.02 | 7.88 | 5.56 |
| | X2/Y1 | — | 1.34 | 0.65 | 0.44 | 0.61 | 0.91 | 1.89 | 1.44 | 1.02 | 3.18 | 5.02 | 2.32 | 1.64 |
| | X3/Y1 | — | 2.91 | 0.62 | 0.42 | 0.61 | 0.91 | 2.91 | 1.53 | 1.08 | 4.21 | 3.16 | 2.53 | 1.78 |
| | X4/Y1 | — | 0.57 | 0.28 | 0.19 | 0.35 | 0.53 | 1.10 | 1.05 | 0.74 | 2.33 | 4.09 | 1.89 | 1.33 |
| | Total content (ppm by | — | 7.30 | 3.00 | 2.04 | 3.11 | 4.57 | 10.1 | 8.06 | 5.64 | 17.7 | 26.0 | 13.6 | 9.55 |
| | mass) of X1 to X4/Y1 | | | | | | | | | | | | | |
| | to Y4 | | | | | | | | | | | | | |
| | X1/alcohol strength | — | 5.26 | 5.26 | 5.26 | 8.42 | 8.42 | 8.42 | 15.4 | 15.4 | 15.8 | 26.3 | 26.3 | 26.3 |
| | Y1/alcohol strength | — | 1.55 | 3.16 | 4.74 | 4.74 | 3.18 | 1.55 | 3.34 | 4.74 | 1.55 | 1.55 | 3.34 | 4.74 |

| | | | | | | | | | | | | | |
|---|---|---|---|---|---|---|---|---|---|---|---|---|---|
| Sensory | Excessive sensation of irritation | 1.5 | 1.5 | 1.5 | 2.0 | 2.0 | 2.0 | 2.5 | 2.5 | 2.5 | 3.0 | 3.0 | 3.0 |
| evaluation | unsuitable for beer-taste | | | | | | | | | | | | |
| | beverage | | | | | | | | | | | | |
| | Aroma richness suitable for | 2.5 | 1.5 | 1.5 | 1.5 | 2.0 | 3.0 | 3.0 | 2.5 | 3.0 | 3.0 | 3.0 | 3.0 |
| | beer-taste beverage | | | | | | | | | | | | |
| | Overall evaluation | C | C | C | C | B | B | A | A | A | A | A | A |

From the results in Tables 1 to 3, in the beer-taste beverage in which the alcohol strength was 8.0 (v/v) % or more, and the isoamyl alcohol content and the content ratio between isoamyl alcohol and ethyl acetate were adjusted such that the isoamyl alcohol content was 110 ppm by mass or more and Formula (1) was satisfied, excessive sensation of irritation from alcohol was suppressed, and a good rich aroma was obtained. Also, from the results in Table 4, in the beer-taste beverage obtained by diluting the beer-taste stock solution in which the alcohol strength was 8.0 (v/v) % or more, and the isoamyl alcohol content and the content ratio between isoamyl alcohol and ethyl acetate were adjusted such that the isoamyl alcohol content was 110 ppm by mass or more and Formula (1) was satisfied, excessive sensation of irritation from alcohol was suppressed, and a good rich aroma was obtained.

### Examples B1 to B9 and Comparative Examples B1 to B9

### <Preparation of Beer-Taste Beverage>

Milled barley malt was fed into a mashing tank containing 120 L of hot water, and afterward, the temperature was increased stepwise and maintained, followed by filtration to remove brewer's spent grain and the like, and thus, a saccharified liquid was obtained. After the filtration, the saccharified liquid, a sugar solution, and hops were fed into a boiling pot and the resulting mixture was adjusted to 100 L with hot water, and a hot wort was obtained. The resultant hot wort was cooled, and aeration with oxygen was performed, and thus, 60 L of a pre-fermentation liquid before yeast addition was obtained.

Beer yeast (top-fermenting yeast) was added to the obtained pre-fermentation liquid, and a fermentation temperature and a fermentation time were adjusted, alcoholic fermentation was performed so that the alcohol strength reaches a predetermined alcohol strength, and thus, the yeast was removed by filtration to prepare a beer-taste beverage.

In addition to the adjustment of the above-described production conditions, in each of Examples and Comparative Examples, the contents of succinic acid, citric acid, phosphoric acid, acetic acid, and isoamyl alcohol were adjusted respectively to the values shown in Tables 5 to 7, by adding these purified products as necessary. In Tables 5 to 7, the description of “B” at the beginning of the Example number and the Comparative Example number is omitted.

### <Sensory Evaluation>

The obtained beer-taste beverages were cooled to about 4 °C, and six panelists who had received daily training tasted the beverages, and evaluated for evaluation items of “Clean taste suitable for beer-taste beverage” and “Mild sourness suitable for beer-taste beverage” as follows.

That is, based on the following score criteria, the beverages were rated with scores in increments of 0.1 in the range from 1.0 (minimum value) to 3.0 (maximum value), and the respective average values of the scores by the six panelists were calculated.

In the evaluation, samples, each corresponding to each of the evaluation items of the following criteria of “1.0”, “1.5”, “2.0”, “2.5”, and “3.0”, were prepared in advance, and uniformity of standards among the panelists was attempted. Also, in sensory evaluation of all Examples and Comparative Examples, no difference of 0.2 or more in the score values among the panelists was confirmed. Note that, there was no panelist who gave a score less than 2.0 for Examples with overall evaluation of “A” or “B”.

### [Clean Taste Suitable for Beer-Taste Beverage]

“3.0”: Clean taste suitable for beer-taste beverages is not felt at all.
“2.5”: Clean taste suitable for beer-taste beverages is very strongly felt.
“2.0”: Clean taste suitable for beer-taste beverages is strongly felt.
“1.5”: Clean taste suitable for beer-taste beverages is sufficiently felt.
“1.0”: Clean taste suitable for beer-taste beverages is hardly felt.

### [Mild Sourness Suitable for Beer-Taste Beverage]

“3.0”: Mild sourness suitable for beer-taste beverages is very strongly felt.
“2.5”: Mild sourness suitable for beer-taste beverages is strongly felt.
“2.0”: Mild sourness suitable for beer-taste beverages is sufficiently felt.
“1.5”: Mild sourness suitable for beer-taste beverages is hardly felt.
“1.0”: Mild sourness suitable for beer-taste beverages is not felt at all.

### [Overall Evaluation]

“A”: All of the average scores of the two verified sensory evaluation items are 2.5 or more.
“B”: Not corresponding to “A” or “C”.
“C”: At least one of the average scores of the two verified sensory evaluation items is less than 2.0.

TABLE 5

| | | | Comparative | Comparative | Example | Example | Example | Comparative |
|---|---|---|---|---|---|---|---|---|
| | | | Example 1 | Example 2 | 1 | 2 | 3 | Example 3 |
| Composition | Alcohol strength | v/v % | 19 | 19 | 19 | 19 | 19 | 19 |
| and | Succinic acid (X1) | ppm by mass | 100 | 250 | 250 | 503 | 1000 | 1200 |
| properties of | Citric acid (X2) | ppm by mass | 324 | 388 | 388 | 494 | 703 | 787 |
| beer-taste | Phosphoric acid (X3) | ppm by mass | 677 | 866 | 866 | 1184 | 1810 | 2061 |
| beverage | Acetic acid (Y1) | ppm by mass | 300 | 1200 | 322 | 328 | 328 | 328 |
| | Isoamyl alcohol (Z) | ppm by mass | 300 | 300 | 300 | 293 | 293 | 293 |
| | Isoamyl | — | 15.8 | 15.8 | 15.8 | 15.4 | 15.4 | 15.4 |
| | alcohol/alcohol | | | | | | | |
| | strength | | | | | | | |
| | X1/Z | — | 0.33 | 0.83 | 0.83 | 1.71 | 3.41 | 4.09 |
| | X2/Z | — | 1.08 | 1.29 | 1.29 | 1.68 | 2.40 | 2.68 |
| | X3/Z | — | 2.26 | 2.89 | 2.89 | 4.03 | 6.17 | 7.03 |
| | Y1/Z | — | 1.00 | 4.00 | 1.07 | 1.12 | 1.12 | 1.12 |
| | X1/Y1 | — | 0.33 | 0.21 | 0.78 | 1.53 | 3.05 | 3.66 |
| | X2/Y1 | — | 1.08 | 0.32 | 1.20 | 1.51 | 2.14 | 2.40 |
| | X3/Y1 | — | 2.26 | 0.72 | 2.69 | 3.61 | 5.52 | 6.28 |
| | (X1 + X2 + X3)/Y1 | — | 3.67 | 1.25 | 4.67 | 6.65 | 10.7 | 12.3 |

| | | | | | | | |
|---|---|---|---|---|---|---|---|
| Sensory | Clean taste suitable for beer-taste | 1.0 | 2.0 | 2.0 | 2.5 | 3.0 | 3.0 |
| evaluation | beverage | | | | | | |
| | Mild sourness suitable for beer-taste | 1.5 | 1.5 | 2.0 | 3.0 | 3.0 | 1.0 |
| | beverage | | | | | | |
| | Overall evaluation | C | C | B | A | A | C |

TABLE 6

| | | | Comparative | Comparative | Example | Example | Example | Comparative |
|---|---|---|---|---|---|---|---|---|
| | | | Example 4 | Example 5 | 4 | 5 | 6 | Example 6 |
| Composition | Alcohol strength | v/v % | 10 | 10 | 10 | 10 | 10 | 10 |
| and | Succinic acid (X1) | ppm by mass | 100 | 250 | 250 | 503 | 1000 | 1200 |
| properties of | Citric acid (X2) | ppm by mass | 324 | 388 | 388 | 494 | 703 | 787 |
| beer-taste | Phosphoric acid (X3) | ppm by mass | 677 | 866 | 866 | 1184 | 1810 | 2061 |
| beverage | Acetic acid (Y1) | ppm by mass | 300 | 1200 | 322 | 328 | 328 | 328 |
| | Isoamyl alcohol (Z) | ppm by mass | 100 | 100 | 100 | 100 | 100 | 100 |
| | Isoamyl | — | 10.0 | 10.0 | 10.0 | 10.0 | 10.0 | 10.0 |
| | alcohol/alcohol | | | | | | | |
| | strength | | | | | | | |
| | X1/Z | — | 1.00 | 2.50 | 2.50 | 5.03 | 10.0 | 12.0 |
| | X2/Z | — | 3.24 | 3.88 | 3.88 | 4.94 | 7.03 | 7.87 |
| | X3/Z | — | 6.77 | 8.66 | 8.66 | 11.8 | 18.1 | 20.6 |
| | Y1/Z | — | 3.00 | 12.0 | 3.22 | 3.28 | 3.28 | 3.28 |
| | X1/Y1 | — | 0.33 | 0.21 | 0.78 | 1.53 | 3.05 | 3.66 |
| | X2/Y1 | — | 1.08 | 0.32 | 1.20 | 1.51 | 2.14 | 2.40 |
| | X3/Y1 | — | 2.26 | 0.72 | 2.69 | 3.61 | 5.52 | 6.28 |
| | (X1 + X2 + X3)/Y1 | — | 3.67 | 1.25 | 4.67 | 6.65 | 10.7 | 12.3 |

| | | | | | | | |
|---|---|---|---|---|---|---|---|
| Sensory | Clean taste suitable for beer-taste | 2.0 | 2.5 | 2.5 | 3.0 | 3.0 | 3.0 |
| evaluation | beverage | | | | | | |
| | Mild sourness suitable for beer-taste | 1.5 | 1.0 | 2.0 | 3.0 | 3.0 | 1.0 |
| | beverage | | | | | | |
| | Overall evaluation | C | C | B | A | A | C |

TABLE 7

| | | | Comparative | Comparative | Example | Example | Example | Comparative |
|---|---|---|---|---|---|---|---|---|
| | | | Example 7 | Example 8 | 7 | 8 | 9 | Example 9 |
| Composition | Alcohol strength | v/v % | 25 | 25 | 25 | 25 | 25 | 25 |
| and | Succinic acid (X1) | ppm by mass | 100 | 250 | 250 | 700 | 1000 | 1200 |
| properties of | Citric acid (X2) | ppm by mass | 324 | 388 | 388 | 577 | 703 | 787 |
| beer-taste | Phosphoric acid (X3) | ppm by mass | 677 | 866 | 866 | 1432 | 1810 | 2061 |
| beverage | Acetic acid (Y1) | ppm by mass | 328 | 1200 | 328 | 328 | 328 | 328 |
| | Isoamyl alcohol (Z) | ppm by mass | 500 | 500 | 500 | 500 | 500 | 500 |
| | Isoamyl | — | 20.0 | 20.0 | 20.0 | 20.0 | 20.0 | 20.0 |
| | alcohol/alcohol | | | | | | | |
| | strength | | | | | | | |
| | X1/Z | — | 0.20 | 0.50 | 0.50 | 1.40 | 2.00 | 2.40 |
| | X2/Z | — | 0.65 | 0.78 | 0.78 | 1.15 | 1.41 | 1.57 |
| | X3/Z | — | 1.35 | 1.73 | 1.73 | 2.86 | 3.62 | 4.12 |
| | Y1/Z | — | 0.66 | 2.40 | 0.66 | 0.66 | 0.66 | 0.66 |
| | X1/Y1 | — | 0.30 | 0.21 | 0.76 | 2.13 | 3.05 | 3.66 |
| | X2/Y1 | — | 0.99 | 0.32 | 1.18 | 1.76 | 2.14 | 2.40 |
| | X3/Y1 | — | 2.06 | 0.72 | 2.64 | 4.37 | 5.52 | 6.28 |
| | (X1 + X2 + X3)/Y1 | — | 3.36 | 1.25 | 4.58 | 8.26 | 10.7 | 12.3 |

| | | | | | | | |
|---|---|---|---|---|---|---|---|
| Sensory | Clean taste suitable for beer-taste | 1.5 | 2.5 | 2.5 | 3.0 | 3.0 | 3.0 |
| evaluation | beverage | | | | | | |
| | Mild sourness suitable for beer-taste | 1.5 | 1.0 | 2.0 | 3.0 | 3.0 | 1.0 |
| | beverage | | | | | | |
| | Overall evaluation | C | C | B | A | A | C |

### Examples B10 to B12 and Comparative Examples B10 to B12

### <Preparation of Beer-Taste Beverage>

In these Examples, the beer-taste beverages prepared in Examples B1 to B3 and Comparative Examples B1 to B3 described above were used as beer-taste stock solutions to be diluted. The beer-taste stock solutions were each diluted fourfold with carbonated water to prepare beer-taste beverages of Examples B10 to B12 and Comparative Examples B10 to B12. The composition and the properties of the obtained beer-taste beverages and the results of sensory evaluation are shown in Table 8. The sensory evaluation was performed in the same manner as that in Examples B1 to B9. In Table 8, the description of “B” at the beginning of the Example number and the Comparative Example number is omitted.

TABLE 8

| | | | Comparative | Comparative | Example | Example | Example | Comparative |
|---|---|---|---|---|---|---|---|---|
| | | | Example 10 | Example 11 | 10 | 11 | 12 | Example 12 |
| Composition | Alcohol strength | v/v % | 4.8 | 4.8 | 4.8 | 4.8 | 4.8 | 4.8 |
| and | Succinic acid (X1) | ppm by mass | 25 | 63 | 63 | 126 | 250 | 300 |
| properties of | Citric acid (X2) | ppm by mass | 81 | 97 | 97 | 123 | 176 | 197 |
| beer-taste | Phosphoric acid (X3) | ppm by mass | 169 | 216 | 216 | 296 | 452 | 515 |
| beverage | Acetic acid (Y1) | ppm by mass | 75 | 300 | 80 | 82 | 82 | 82 |
| | Isoamyl alcohol (Z) | ppm by mass | 75 | 75 | 75 | 73 | 73 | 73 |
| | Isoamyl alcohol/alcohol | — | 15.8 | 15.8 | 15.8 | 15.4 | 15.4 | 15.4 |
| | strength | | | | | | | |
| | X1/Z | — | 0.33 | 0.83 | 0.83 | 1.71 | 3.41 | 4.09 |
| | X2/Z | — | 1.08 | 1.29 | 1.29 | 1.68 | 2.40 | 2.68 |
| | X3/Z | — | 2.26 | 2.89 | 2.89 | 4.03 | 6.17 | 7.03 |
| | Y1/Z | — | 1.00 | 4.00 | 1.07 | 1.12 | 1.12 | 1.12 |
| | X1/Y1 | — | 0.33 | 0.21 | 0.78 | 1.53 | 3.05 | 3.66 |
| | X2/Y1 | — | 1.08 | 0.32 | 1.20 | 1.51 | 2.14 | 2.40 |
| | X3/Y1 | — | 2.26 | 0.72 | 2.69 | 3.61 | 5.52 | 6.28 |
| | (X1 + X2 + X3)/Y1 | — | 3.67 | 1.25 | 4.67 | 6.65 | 10.7 | 12.3 |

| | | | | | | | |
|---|---|---|---|---|---|---|---|
| Sensory | Clean taste suitable for beer-taste | 1.0 | 2.0 | 2.0 | 2.5 | 3.0 | 3.0 |
| evaluation | beverage | | | | | | |
| | Mild sourness suitable for beer-taste | 1.5 | 1.5 | 2.0 | 3.0 | 3.0 | 1.0 |
| | beverage | | | | | | |
| | Overall evaluation | C | C | B | A | A | C |

From the results in Tables 5 to 7, it was found that the beer-taste beverage in which the alcohol strength is 8.0 (v/v) % or more, and the succinic acid content and the content ratio between succinic acid and acetic acid were adjusted such that the succinic acid content is 110 ppm by mass or more and 1100 ppm by mass or less and Formula (1A) was satisfied, had a clean taste and mild sourness. From the results in Table 8, it was found that the beer-taste beverage obtained by diluting the beer-taste stock solution in which the alcohol strength is 8.0 (v/v) % or more, and the succinic acid content and the content ratio between succinic acid and acetic acid were adjusted such that the succinic acid content is 110 ppm by mass or more and 1100 ppm by mass or less and Formula (1A) was satisfied, had a clean taste and mild sourness.

### Examples C1 to C13 and Comparative Examples C1 and C2

### <Preparation of Beer-Taste Beverage>

Milled barley malt was fed into a mashing tank containing 120 L of hot water, and afterward, the temperature was increased stepwise and maintained, followed by filtration to remove brewer's spent grain and the like, and thus, a saccharified liquid was obtained. After the filtration, the saccharified liquid, a sugar solution, and hops were fed into a boiling pot and the resulting mixture was adjusted to 100 L with hot water, and a hot wort was obtained. The resultant hot wort was cooled, and aeration with oxygen was performed, and thus, 60 L of a pre-fermentation liquid before yeast addition was obtained.

Beer yeast (top-fermenting yeast) was added to the obtained pre-fermentation liquid, and a fermentation temperature and a fermentation time were adjusted, alcoholic fermentation was performed so that the alcohol strength reaches a predetermined alcohol strength, and thus, the yeast was removed by filtration to prepare a beer-taste beverage.

In addition to the adjustment of the above production conditions, in each of Examples and Comparative Examples, the contents of isoamyl alcohol, n-propanol, isobutanol, phenethyl alcohol, ethyl acetate, isoamyl acetate, ethyl caproate, and ethyl octanoate were adjusted respectively to the values shown in Tables 9 to 11, by adding these purified products as necessary. In Tables 9 to 11, the description of “C” at the beginning of the Example number and the Comparative Example number is omitted.

### <Sensory Evaluation>

The obtained beer-taste beverages were cooled to about 4 °C, and six panelists who had received daily training tasted the beverages and evaluated for evaluation items of “Aroma richness suitable for beer-taste beverage” and “Excessive sensation of irritation unsuitable for beer-taste beverage” as follows.

That is, based on the following score criteria, the beverages were rated with scores in increments of 0.1 in the range from 1.0 (minimum value) to 3.0 (maximum value), and the respective average values of the scores by the six panelists were calculated.

In the evaluation, samples, each corresponding to each of the evaluation items of the following criteria of “1.0”, “1.5”, “2.0”, “2.5”, and “3.0”, were prepared in advance, and uniformity of standards among the panelists was attempted. Also, in sensory evaluation of all Examples and Comparative Examples, no difference of 0.2 or more in the score values among the panelists was confirmed. Note that, there was no panelist who gave a score less than 2.0 for Examples with overall evaluation of “A” or “B”.

### [Excessive Sensation of Irritation Unsuitable for Beer-Taste Beverage]

“3.0”: Excessive sensation of irritation unsuitable for beer-taste beverages is not felt at all.
“2.5”: Excessive sensation of irritation unsuitable for beer-taste beverages is hardly felt.
“2.0”: Excessive sensation of irritation unsuitable for beer-taste beverages is not felt much.
“1.5”: Excessive sensation of irritation unsuitable for beer-taste beverages is felt.
“1.0”: Excessive sensation of irritation unsuitable for beer-taste beverages is strongly felt.

### [Aroma Richness Suitable for Beer-Taste Beverage]

“3.0”: Aroma richness suitable for beer-taste beverages is very strongly felt.
“2.5”: Aroma richness suitable for beer-taste beverages is strongly felt.
“2.0”: Aroma richness suitable for beer-taste beverages is sufficiently felt.
“1.5”: Aroma richness suitable for beer-taste beverages is hardly felt.
“1.0”: Aroma richness suitable for beer-taste beverages is not felt at all.

### [Overall Evaluation]

“A”: All of the average scores of the two verified sensory evaluation items are 2.5 or more.
“B”: Not corresponding to “A” or “C”.
“C”: At least one of the average scores of the two verified sensory evaluation items is less than 2.0.

TABLE 9

| | | | Comparative | Comparative | Example | Example | Example | Example | Example |
|---|---|---|---|---|---|---|---|---|---|
| | | | Example 1 | Example 2 | 1 | 2 | 3 | 4 | 5 |
| Composition | Alcohol strength | v/v % | 19 | 19 | 19 | 19 | 19 | 19 | 19 |
| and | Ethyl acetate (Y1) | ppm by mass | 40 | 41 | 63 | 90 | 63 | 90 | 63 |
| properties of | Isoamyl acetate (Y2) | ppm by mass | 1.8 | 5.9 | 4 | 6 | 4 | 6 | 4 |
| beer-taste | Ethyl caproate (Y3) | ppb by mass | 308 | 308 | 308 | 401 | 308 | 401 | 308 |
| beverage | Ethyl octanoate (Y4) | ppb by mass | 376 | 376 | 376 | 490 | 376 | 490 | 376 |
| | Isoamyl alcohol (X1) | ppm by mass | 293 | 293 | 293 | 293 | 500 | 500 | 900 |
| | n-propanol (X2) | ppm by mass | 92 | 92 | 92 | 92 | 147 | 147 | 92 |
| | Isobutanol (X3) | ppm by mass | 97 | 97 | 97 | 97 | 160 | 160 | 97 |
| | Phenethyl alcohol (X4) | ppm by mass | 67 | 67 | 67 | 67 | 120 | 120 | 67 |
| | X1/Y1 | — | 7.43 | 7.14 | 4.63 | 3.26 | 7.88 | 5.56 | 14.19 |
| | X2/Y1 | — | 2.32 | 2.23 | 1.44 | 1.02 | 2.32 | 1.64 | 1.44 |
| | X3/Y1 | — | 2.45 | 2.36 | 1.53 | 1.08 | 2.53 | 1.78 | 1.53 |
| | X4/Y1 | — | 1.69 | 1.62 | 1.05 | 0.74 | 1.89 | 1.33 | 1.05 |
| | Total content (ppm by | — | 13.07 | 11.50 | 8.06 | 5.64 | 13.6 | 9.55 | 16.98 |
| | mass) of X1 to X4/Y1 | | | | | | | | |
| | to Y4 | | | | | | | | |
| | X1/alcohol strength | — | 15.4 | 15.4 | 15.4 | 15.4 | 26.3 | 26.3 | 47.4 |
| | Y1/alcohol strength | — | 2.08 | 2.16 | 3.34 | 4.74 | 3.34 | 4.74 | 3.34 |

| | | | | | | | | |
|---|---|---|---|---|---|---|---|---|
| Sensory | Excessive sensation of irritation | 2.5 | 2.5 | 2.5 | 2.5 | 3.0 | 3.0 | 3.0 |
| evaluation | unsuitable for beer-taste beverage | | | | | | | |
| | Aroma richness suitable for beer-taste | 1.5 | 1.8 | 3.0 | 2.5 | 3.0 | 3.0 | 3.0 |
| | beverage | | | | | | | |
| | Overall evaluation | C | C | A | A | A | A | A |

TABLE 10

| | | | Example 6 | Example 7 | Example 8 | Example 9 |
|---|---|---|---|---|---|---|
| Composition | Alcohol strength | v/v % | 10 | 10 | 10 | 10 |
| and properties of | Ethyl acetate (Y1) | ppm by mass | 63 | 90 | 63 | 90 |
| beer-taste beverage | Isoamyl acetate (Y2) | ppm by mass | 1 | 6 | 4 | 6 |
| | Ethyl caproate (Y3) | ppb by mass | 308 | 401 | 308 | 401 |
| | Ethyl octanoate (Y4) | ppb by mass | 376 | 490 | 376 | 490 |
| | Isoamyl alcohol (X1) | ppm by mass | 293 | 293 | 500 | 500 |
| | n-propanol (X2) | ppm by mass | 92 | 92 | 147 | 147 |
| | Isobutanol (X3) | ppm by mass | 97 | 97 | 160 | 160 |
| | Phenethyl alcohol (X4) | ppm by mass | 67 | 67 | 120 | 120 |
| | X1/Y1 | — | 4.63 | 3.26 | 7.88 | 5.56 |
| | X2/Y1 | — | 1.44 | 1.02 | 2.32 | 1.64 |
| | X3/Y1 | — | 1.53 | 1.08 | 2.53 | 1.78 |
| | X4/Y1 | — | 1.05 | 0.74 | 1.89 | 1.33 |
| | Total content (ppm by mass) of X1 | — | 8.06 | 5.64 | 13.6 | 9.55 |
| | to X4/Y1 to Y4 | | | | | |
| | X1/alcohol strength | — | 29.3 | 29.3 | 50.0 | 50.0 |
| | Y1/alcohol strength | — | 6.34 | 9.00 | 6.34 | 9.00 |

| | | | | | |
|---|---|---|---|---|---|
| Sensory | Excessive sensation of irritation unsuitable for | 2.5 | 2.5 | 3.0 | 3.0 |
| evaluation | beer-taste beverage | | | | |
| | Aroma richness suitable for beer-taste beverage | 3.0 | 2.5 | 3.0 | 3.0 |
| | Overall evaluation | A | A | A | A |

TABLE 11

| | | | Example 10 | Example 11 | Example 12 | Example 13 |
|---|---|---|---|---|---|---|
| Composition | Alcohol strength | v/v % | 25 | 25 | 25 | 25 |
| and properties of | Ethyl acetate (Y1) | ppm by mass | 63 | 90 | 63 | 90 |
| beer-taste beverage | Isoamyl acetate (Y2) | ppm by mass | 4 | 6 | 4 | 6 |
| | Ethyl caproate (Y3) | ppb by mass | 308 | 401 | 308 | 401 |
| | Ethyl octanoate (Y4) | ppb by mass | 376 | 490 | 376 | 490 |
| | Isoamyl alcohol (X1) | ppm by mass | 293 | 293 | 500 | 500 |
| | n-propanol (X2) | ppm by mass | 92 | 92 | 147 | 147 |
| | Isobutanol (X3) | ppm by mass | 97 | 97 | 160 | 160 |
| | Phenethyl alcohol (X4) | ppm by mass | 67 | 67 | 120 | 120 |
| | X1/Y1 | — | 4.63 | 3.26 | 7.88 | 5.56 |
| | X2/Y1 | — | 1.44 | 1.02 | 2.32 | 1.64 |
| | X3/Y1 | — | 1.53 | 1.08 | 2.53 | 1.78 |
| | X4/Y1 | — | 1.05 | 0.74 | 1.89 | 1.33 |
| | Total content (ppm by mass) of | — | 8.06 | 5.64 | 13.6 | 9.55 |
| | X1 to X4/Y1 to Y4 | | | | | |
| | X1/alcohol strength | — | 11.7 | 11.7 | 20.0 | 20.0 |
| | Y1/alcohol strength | — | 2.54 | 3.60 | 2.54 | 3.60 |

| | | | | | |
|---|---|---|---|---|---|
| Sensory | Excessive sensation of irritation unsuitable for | 3.0 | 2.5 | 3.0 | 2.5 |
| evaluation | beer-taste beverage | | | | |
| | Aroma richness suitable for beer-taste beverage | 3.0 | 2.5 | 3.0 | 3.0 |
| | Overall evaluation | A | A | A | A |

### Examples C14 to C18 and Comparative Examples C3 and C4

### <Preparation of Beer-Taste Beverage>

In these Examples, the beer-taste beverages prepared in Examples C1 to C5 described above were used as beer-taste stock solutions to be diluted. Each of the beer-taste stock solutions was diluted fourfold with carbonated water to prepare beer-taste beverages of Examples C14 to C18. The composition and properties of the obtained beer-taste beverages and the results of sensory evaluation are shown in Table 12. The sensory evaluation was performed in the same manner as that in Examples C1 to C13. In Table 12, the description of “C” at the beginning of the Example number and the Comparative Example number is omitted.

TABLE 12

| | | | Comparative | Comparative | Example | Example | Example | Example | Example |
|---|---|---|---|---|---|---|---|---|---|
| | | | Example 3 | Example 4 | 14 | 15 | 16 | 17 | 18 |
| Composition | Alcohol strength | v/v % | 4.75 | 4.75 | 4.75 | 4.75 | 4.75 | 4.75 | 4.75 |
| and | Ethyl acetate (Y1) | ppm by mass | 9.9 | 10.3 | 15.9 | 22.5 | 15.9 | 22.5 | 15.9 |
| properties of | Isoamyl acetate (Y2) | ppm by mass | 0.5 | 1.5 | 1.0 | 1.6 | 1.0 | 1.6 | 1.0 |
| beer-taste | Ethyl caproate (Y3) | ppb by mass | 77 | 77 | 77 | 100 | 77 | 100 | 77 |
| beverage | Ethyl octanoate (Y4) | ppb by mass | 94 | 94 | 94 | 123 | 94 | 123 | 94 |
| | Isoamyl alcohol (X1) | ppm by mass | 73.4 | 73.4 | 73.4 | 73.4 | 125.0 | 125.0 | 225.0 |
| | n-propanol (X2) | ppm by mass | 22.9 | 22.9 | 22.9 | 22.9 | 36.8 | 36.8 | 22.9 |
| | Isobutanol (X3) | ppm by mass | 24.2 | 24.2 | 24.2 | 24.2 | 40.1 | 40.1 | 24.2 |
| | Phenethyl alcohol | ppm by mass | 16.7 | 16.7 | 16.7 | 16.7 | 30.0 | 30.0 | 16.7 |
| | (X4) | | | | | | | | |
| | X1/Y1 | — | 7.43 | 7.14 | 4.63 | 3.26 | 7.88 | 5.56 | 14.19 |
| | X2/Y1 | — | 2.32 | 2.23 | 1.44 | 1.02 | 2.32 | 1.64 | 1.44 |
| | X3/Y1 | — | 2.45 | 2.36 | 1.53 | 1.08 | 2.53 | 1.78 | 1.53 |
| | X4/Y1 | — | 1.69 | 1.62 | 1.05 | 0.74 | 1.89 | 1.33 | 1.05 |
| | Total content (ppm | — | 13.07 | 11.50 | 8.06 | 5.64 | 13.6 | 9.55 | 16.98 |
| | by mass) of X1 to | | | | | | | | |
| | X4/Y1 to Y4 | | | | | | | | |
| | X1/alcohol strength | — | 15.4 | 15.4 | 15.4 | 15.4 | 26.3 | 26.3 | 47.4 |
| | Y1/alcohol strength | — | 2.08 | 2.16 | 3.34 | 4.74 | 3.34 | 4.74 | 3.34 |

| | | | | | | | | |
|---|---|---|---|---|---|---|---|---|
| Sensory | Excessive sensation of irritation | 2.5 | 2.5 | 2.5 | 2.5 | 3.0 | 3.0 | 3.0 |
| evaluation | unsuitable for beer-taste beverage | | | | | | | |
| | Aroma richness suitable for beer- | 1.5 | 1.8 | 3.0 | 2.5 | 3.0 | 3.0 | 3.0 |
| | taste beverage | | | | | | | |
| | Overall evaluation | C | C | A | A | A | A | A |

From the results in Tables 9 to 11, in the beer-taste beverage having an alcohol strength of 10.0 (v/v) % or more, an ethyl acetate content of 50 ppm by mass or more, and an isoamyl acetate content of 3 ppm by mass or more, excessive sensation of irritation from alcohol was suppressed, and a good rich aroma was obtained. From the results in Tables 9 and 11, in the beer-taste beverage having an alcohol strength of 12.0 (v/v) % or more and an ethyl acetate content of 50 ppm by mass or more, excessive sensation of irritation from alcohol was suppressed, and a good rich aroma was obtained. From the results in Table 12, in the beer-taste beverage obtained by diluting the beer-taste stock solution according to an aspect of the present invention, excessive sensation of irritation from alcohol was suppressed, and a good rich aroma was obtained.

1. A beer-taste beverage having an alcohol strength of 8.00 (v/v) % or more.

2. The beer-taste beverage according to claim 1, wherein
the alcohol strength is 8.00 (v/v) % or more;
an isoamyl alcohol content is 110 ppm by mass or more; and
the beer-taste beverage satisfies Formula (1):
X1/Y1≥2.00 :Formula (1)
wherein X1 represents the isoamyl alcohol content (unit: ppm by mass), and Y1 represents an ethyl acetate content (unit: ppm by mass).

3. The beer-taste beverage according to claim 1, wherein
the alcohol strength is 8.00 (v/v) % or more;
a succinic acid content is 110 ppm by mass or more and 1100 ppm by mass or less; and
the beer-taste beverage satisfies Formula (1A):
X1/Y1≥0.25 :Formula (1A)
wherein X1 represents the succinic acid content (unit: ppm by mass), and Y1 represents an acetic acid content (unit: ppm by mass).

4. The beer-taste beverage according to claim 1, wherein
the alcohol strength is 10.0 (v/v) % or more;
an ethyl acetate content is 50 ppm by mass or more; and
an isoamyl acetate content is 3 ppm by mass or more.

5. The beer-taste beverage according to claim 1, wherein
the alcohol strength is 12.0 (v/v) % or more; and
an ethyl acetate content is 50 ppm by mass or more.

6. The beer-taste beverage according to claim 2, wherein the isoamyl alcohol content is 1000 ppm by mass or less, or
further comprising one or more compounds selected from the group consisting of n-propanol, isobutanol, and phenethyl alcohol, or
further comprising one or more compounds selected from the group consisting of isoamyl acetate, ethyl caproate, and ethyl octanoate.

7. (canceled)

8. (canceled)

9. The beer-taste beverage according to claim 2, the beer-taste beverage satisfying Formula (2):
X/Y>3.00 :Formula (2)
wherein X represents a total content (unit: ppm by mass) of a compound of Group X, and Y represents a total content (unit: ppm by mass) of a compound of Group Y:
Group X: one or more selected from the group consisting of isoamyl alcohol, n-propanol, isobutanol, and phenethyl alcohol; and
Group Y: one or more selected from the group consisting of ethyl acetate, isoamyl acetate, ethyl caproate, and ethyl octanoate, or
the beer-taste beverage satisfying Formula (3):
X2/Y1>0.65 :Formula (3)
wherein X2 represents an n-propanol content (unit: ppm by mass), and Y1 represents an ethyl acetate content (unit: ppm by mass), or
the beer-taste beverage satisfying Formula (4):
X3/Y1>0.65 :Formula (4)
wherein X3 represents an isobutanol content (unit: pom by mass), and Y1 represents an ethyl acetate content (unit: pom by mass), or
the beer-taste beverage satisfying Formula (5):
X4/Y1>0.30 :Formula (5)
wherein X4 represents a phenethyl alcohol content (unit: ppm by mass), and Y1 represents an ethyl acetate content (unit: ppm by mass).

10. (canceled)

11. (canceled)

12. (canceled)

13. The beer-taste beverage according to claim 3, wherein an isoamyl alcohol content is 10 ppm by mass or more and 1000 ppm by mass or less.

14. The beer-taste beverage according to claim 3, the beer-taste beverage satisfying Formula (1B):
X2/Y1>0.32 :Formula (1B)
wherein X2 represents a citric acid content (unit: ppm by mass), and Y1 represents the acetic acid content (unit: ppm by mass), or
the beer-taste beverage satisfying Formula (2A);
X1/Z>0.50 :Formula (2A)
wherein X1 represents the succinic acid content (unit: pom by mass), and Z represents an isoamyl alcohol content (unit: ppm by mass), or
the beer-taste beverage satisfying Formula (2B):
X2/Z>0.78 :Formula (2B)
wherein X2 represents a citric acid content (unit: pom by mass), and Z represents an isoamyl alcohol content (unit: ppm by mass), or
the beer-taste beverage satisfying Formula (3):
Y1/Z>0.66 :Formula (3)
wherein Y1 represents the acetic acid content (unit: pom by mass), and Z represents an isoamyl alcohol content (unit: pom by mass), or
the beer-taste beverage satisfying Formula (4):
X/Y1>1.25 :Formula (4)
wherein X represents a total content (unit: ppm by mass) of one or more acidulants selected from the group consisting of phosphoric acid, citric acid, and succinic acid, and Y1 represents the acetic acid content (unit: ppm by mass).

15. (canceled)

16. (canceled)

17. (canceled)

18. (canceled)

19. The beer-taste beverage according to claim 4, wherein an n-propanol content is 55 ppm by mass or more, or
wherein the ethyl acetate content is 60 ppm by mass or more, or
wherein an isoamyl alcohol content is from 110 to 1000 ppm by mass.

20. (canceled)

21. (canceled)

22. The beer-taste beverage according to claim 4, the beer-taste beverage satisfying Formula (1):
X/Y>3.00 :Formula (1)
wherein X represents a total content (unit: ppm by mass) of a compound of Group X, and Y represents a total content (unit: ppm by mass) of a compound of Group Y:
Group X: one or more selected from the group consisting of isoamyl alcohol, n-propanol, isobutanol, and phenethyl alcohol; and
Group Y: one or more selected from the group consisting of ethyl acetate, isoamyl acetate, ethyl caproate, and ethyl octanoate; or
wherein the alcohol strength is 50.00 (v/v) % or less, or
wherein a malt proportion is 50 mass % or more, of the beer-taste beverage being a fermented beverage, optionally the fermented beverage is a top-fermented beer-taste beverage.

23. (canceled)

24. (canceled)

25. (canceled)

26. (canceled)

27. The beer-taste beverage according to claim 1, wherein the alcohol strength is 50.00 (v/v) % or less, or
wherein a malt proportion is 50 mass % or more, or
the beer-taste beverage being a fermented beverage, optionally the fermented beverage is a top-fermented beer-taste beverage.

28. (canceled)

29. (canceled)

30. (canceled)

31. A beer-taste stock solution having an alcohol strength of 8.00 (v/v) % or more.

32. The beer-taste stock solution according to claim 31, wherein the alcohol strength is 8.00 (v/v) % or more
an isoamyl alcohol content is 110 ppm by mass or more; and
the beer-taste beverage satisfies Formula (1):
X1/Y1≥2.00 :Formula (1)
wherein X1 represents the isoamyl alcohol content (unit: ppm by mass), and Y1 represents an ethyl acetate content (unit: ppm by mass).

33. The beer-taste stock solution according to claim 31, wherein
the alcohol strength is 8.00 (v/v) % or more
a succinic acid content is 110 ppm by mass or more and 1100 ppm by mass or less; and
the beer-taste beverage satisfies Formula (1A):
X1/Y1≥0.25 :Formula (1A)
wherein X1 represents the succinic acid content (unit: ppm by mass), and Y1 represents an acetic acid content (unit: ppm by mass).

34. The beer-taste stock solution according to claim 31, wherein
the alcohol strength is 10.0 (v/v) % or more;
an ethyl acetate content is 50 ppm by mass or more; and
an isoamyl acetate content is 3 ppm by mass or more.

35. The beer-taste stock solution according to claim 31, wherein
the alcohol strength is 12.0 (v/v) % or more; and
an ethyl acetate content is 50 ppm by mass or more.

36. The beer-taste stock solution according to claim 31, the beer-taste beverage being a stock solution for two-fold to ten-fold dilution.

37. A beer-taste beverage produced by mixing an edible aqueous solution with the beer-taste stock solution described in any one described in claim 31.

38. A method for producing a beer-taste beverage, the method comprising mixing an edible aqueous solution with the beer-taste stock solution described in any one described in claim 31.
